(19) United States
(12) Patent Application Publication
(10) Pub. No.: US 2010/0201800 A1
(43) Pub. Date: Aug. 12, 2010

(54) MICROSCOPY SYSTEM

(75) Inventors: Yoko YAMAMOTO, Tokyo (JP); Hiroyuki FUKUDA, Tokyo (JP)

Correspondence Address: SCULLY SCOTT MURPHY & PRESSER, PC, 400 GARDEN CITY PLAZA, SUITE 300, GARDEN CITY, NY, 11530, US

(73) Assignee: OLYMPUS CORPORATION, Tokyo (JP)

(21) Appl. No.: 12/702,622

(22) Filed: Feb. 9, 2010

(30) Foreign Application Priority Data
Feb. 9, 2009 (JP) 2009-027693
Nov. 2, 2009 (JP) 2009-252236

(51) Int. Cl. H04N 7/18

(52) U.S. Cl. 348/79; 348/E07.085

(57) ABSTRACT

A reproduction apparatus includes an attribute information recording unit that records image attribute information in which the attribute values indicating the attributes of each image are set; a target image selecting unit that selects a target image from images; a search condition setting unit that sets the search conditions that are the attribute values related to the target image in the image attribute information; a reproduction information creating unit that creates information for reproduction by setting image attribute information that satisfies the search conditions in the image attribute information; a search condition selecting unit that selects the search conditions as reproduction search conditions; and a search result reproducing unit that causes a display unit to display an image to be reproduced with respect to the image attribute information set in the information for reproduction when the reproduction search conditions are selected, and reproduces search results related to the target image.

### CROSS-REFERENCE TO RELATED APPLICATIONS

This application is based upon and claims the benefit of priority from Japanese Patent Application No. 2009-027693, filed on Feb. 9, 2009 and Japanese Patent Application No. 2009-252236, filed on Nov. 2, 2009, the entire contents of which are incorporated herein by reference.

### BACKGROUND OF THE INVENTION

1. Field of the Invention

The present invention relates to a microscopy system that includes a microscope.

2. Description of the Related Art

In a pathological diagnosis, for example, a tissue sample obtained by harvesting an organ or by needle biopsy is normally sliced into specimens of a few microns in thickness, and the specimens are magnified and observed with a microscope, so that various findings can be obtained. Particularly, transmission observation with the use of an optical microscope can be easily performed with relatively inexpensive equipment, and has been conducted through ages. For such reasons, transmission observation is one of the most widely-used observation methods. Samples collected from living bodies hardly absorb or disperse light, and are almost clear and colorless. Therefore, specimens are normally stained with dyes.

There are various staining techniques, and the number of those techniques is more than one hundred. For pathological specimens, hematoxylin-eosin stain (hereinafter referred to as the “H/E stain”) using the two dyes of blue-purple hematoxylin (hereinafter referred to as the “dye H”) and red eosin (hereinafter referred to as the “dye E”) as staining dyes is normally used. In H/E-stained specimens (stained specimens), cell nuclei, bone tissue, and the likes are stained with the blue-purple dye, and cell cytoplasm, joining fibrils, red blood cells, and the likes are stained with the red dye, so that those parts can be visually recognized with ease. As a result, an observer such as a pathologist can understand the sizes of the parts forming the target tissue such as cell nuclei and the positional relationships among those parts, and accordingly, can morphologically determine the condition of each specimen.

Stained specimens are not only visually examined but also are observed on a screen of a display device by capturing images of the stained specimens. In the latter case, each stained specimen image is analyzed through image processing. In this manner, efforts have been made to support examinations and diagnoses by medical doctors and the likes. For example, there has been a known technique for quantitatively estimating the dye amounts of the dyes staining the points (the sample points) in each stained specimen, based on stained specimen images obtained by capturing multiband images of the stained specimens. This technique is used for various purposes. For example, a technique for correcting the color information about each stained specimen image based on estimated dye amounts is disclosed in “Color Correction of Pathological Images Based on Dye Amount Quantification, OPTICAL REVIEW, Vol. 12, No. 4 (2005), p.p. 293-300”. Also, a technique for quantitatively evaluating the stained state of each specimen in accordance with estimated dye amounts is disclosed in “Development of support systems for pathology using spectral transmittance—The quantification method of stain conditions, Proceedings of SPIE—Image Processing, Vol. 4684 (2002), p.p. 1516-1523. Further, Japanese Laid-open Patent Publication No. 2005-331394 discloses a technique by which the tissues in each specimen are classified on the basis of estimated dye amounts, and each image is divided into regions by tissue.

Meanwhile, there has been a clinically-used technique by which special staining different from the H/E staining is performed on specimens, and the color of the tissue to be observed is changed so as to be emphasized in a different color from the others. This special staining is performed when tissue that is difficult to visually recognize with the H/E stain is observed, or when the shape of the tissue to be observed is difficult to visually recognize due to progression of cancer or the like. In the case of the special staining, however, the costs and the number of manufacturing procedures are increased in clinical practice. Furthermore, under some stained conditions, the staining might be insufficient, and the visibility is not improved. As a result, it is still difficult to identify the target tissue. Therefore, there has been a suggested technique by which the special staining is not actually performed, but the target tissue is identified through image processing (see Japanese Laid-open Patent Publication No. 2004-286666, for example). According to Japanese Laid-open Patent Publication No. 2004-286666, a multiband image of a pathological specimen observation image formed with a microscope optical system is captured, and, based on the captured multiband image, the spectrum (the spectral transmittance) of the pathological specimen is estimated. The dye amounts in the pathological specimen are then estimated from the estimated spectral transmittance, and the distributions of nuclei and cytoplasm are obtained from the dye amount distribution. Based on the distribution ratio, the site of cancer is estimated.

A stained specimen image (a multiband image) is obtained by capturing an image of a stained specimen with a multiband camera while bands are switched. Here, the settings of the multiband camera need to be changed in accordance with the bands to be switched. For example, Japanese Patent Publication No. 4,112,469 discloses a technique for automatically performing the necessary settings by storing beforehand the parameters necessary for the settings in a multiband camera for each band, and reading the corresponding parameters when bands are switched.

A method of quantitatively estimating dye amounts from a stained specimen image obtained in the above manner is now described through an example of an H/E-stained specimen. First, the spectral transmittance t(x, λ) at each pixel position is calculated according to the following equation (1), in which a multiband image of the background (the illuminating light) is represented by I₀, and a multiband image of the stained specimen to be observed is represented by I. Prior to the estimation of dye amounts, the multiband image I₀ of the background is obtained beforehand by capturing an image of the background without a specimen, while the background is illuminated with illuminating light. In the following equation (1), x represents the position vector representing the pixels in the multiband images, λ represents the wavelengths, I(x, λ) represents the pixel values at the pixel positions (x) in the multiband image I at the wavelengths λ, and I₀(x, λ) represents the pixel values at the pixel positions (x) in the multiband image I₀ at the wavelengths λ.

$$t ( x , λ ) = \frac{I ( x , λ )}{{I}_{0} ( x , λ )} \qquad ( 1 )$$

As for the spectral transmittance t(x, λ), Lambert-Beer's law applies. In a case where a stained specimen is stained with the two staining dyes of the dye H and the dye E, for example, the following equation (2) applies at each wavelength λ according to Lambert-Beer's law.

−log t(x,λ)=k_{H}(λ)d_{H}(x)+k_{E}(λ)d_{E}(x) (2)

In the equation (2), k_{H}(λ) and k_{E}(λ) are the coefficients inherent to the substances depending on the wavelengths λ. Here, k_{H}(λ) is the coefficient corresponding to the dye H, and k_{E}(λ) is the coefficient corresponding to the dye E. For example, the values of k_{H}(λ) and k_{E}(λ) are the spectral property data of the dye H and the dye E staining the stained specimen. Hereinafter, the spectral property data may be referred to as a dye spectral property value. The dye spectral property values of the staining dyes staining a stained specimen are referred to as the “reference spectrums”. Meanwhile, d_{H}(x) and d_{E}(x) are equivalent to the dye amounts of the dye H and the dye E at each of the sample points in the stained specimen corresponding to the pixel points (x) in the multiband images. More specifically, d_{H}(x) is determined as a value relative to the dye amount obtained when the dye amount of the dye H in a specimen stained only with the dye H is “1”. Likewise, d_{E}(x) is determined as a value relative to the dye amount obtained when the dye amount of the dye E in a specimen stained only with the dye E is “1”. Each dye amount is also called concentration.

The above equation (2) applies at each wavelength λ. Also, the equation (2) is a linear equation with d_{H}(x) and d_{E}(x), and the technique for solving such an equation is generally known as multiple regression analysis. For example, d_{H}(x) and d_{E}(x) can be determined by turning the equation (2) into simultaneous equations with respect to two or more different wavelengths.

Simultaneous equations formed with respect to M (M≧2) wavelengths λ₁, λ₂, . . . , λ_{M} can be expressed by the equation (3), for example. In the equations shown below, [ ]^{t} represents a transposed matrix, and [ ]^{-t} is an inverse matrix.

$$[ \begin{matrix}\begin{matrix}- log & t ( x , {λ}_{1} ) \\ - log & t ( x , {λ}_{2} )\end{matrix} \\ ⋮ \\ \begin{matrix}- log & t ( x , {λ}_{M} )\end{matrix}\end{matrix} ] = [ \begin{matrix}{k}_{H} ( {λ}_{1} ) & {k}_{E} ( {λ}_{1} ) \\ {k}_{H} ( {λ}_{2} ) & {k}_{E} ( {λ}_{2} ) \\ ⋮ & ⋮ \\ {k}_{H} ( {λ}_{M} ) & {k}_{E} ( {λ}_{M} )\end{matrix} ] [ \begin{matrix}{d}_{H} ( x ) \\ {d}_{E} ( x )\end{matrix} ] \qquad ( 3 )$$

Where the above equation (3) is solved by least-squares estimation, the following equation (4) is obtained, and the estimated value \hat{d}_{H}(x) of the dye H and the estimated value \hat{d}_{E}(x) of the dye E are determined.

$$[ \begin{matrix}{\hat{d}}_{H} ( x ) \\ {\hat{d}}_{E} ( x )\end{matrix} ] = {{( {[ \begin{matrix}{k}_{H} ( {λ}_{1} ) & {k}_{E} ( {λ}_{1} ) \\ {k}_{H} ( {λ}_{2} ) & {k}_{E} ( {λ}_{2} ) \\ ⋮ & ⋮ \\ {k}_{H} ( {λ}_{M} ) & {k}_{E} ( {λ}_{M} )\end{matrix} ]}^{t} [ \begin{matrix}{k}_{H} ( {λ}_{1} ) & {k}_{E} ( {λ}_{1} ) \\ {k}_{H} ( {λ}_{2} ) & {k}_{E} ( {λ}_{2} ) \\ ⋮ & ⋮ \\ {k}_{H} ( {λ}_{M} ) & {k}_{E} ( {λ}_{M} )\end{matrix} ] )}^{- 1} [ \begin{matrix}{k}_{H} ( {λ}_{1} ) & {k}_{E} ( {λ}_{1} ) \\ {k}_{H} ( {λ}_{2} ) & {k}_{E} ( {λ}_{2} ) \\ ⋮ & ⋮ \\ {k}_{H} ( {λ}_{M} ) & {k}_{E} ( {λ}_{M} )\end{matrix} ]}^{t} [ \begin{matrix}\begin{matrix}- log & t ( x , {λ}_{1} ) \\ - log & t ( x , {λ}_{2} )\end{matrix} \\ ⋮ \\ \begin{matrix}- log & t ( x , {λ}_{M} )\end{matrix}\end{matrix} ] \qquad ( 4 )$$

According to the equation (4), the estimated values of the dye amounts of the dye H and the dye E at arbitrary sample points in the stained specimen are obtained.

### SUMMARY OF THE INVENTION

A microscopy system according to an aspect of the present invention includes an observing unit that observes a specimen with a microscope; an observation system control unit that controls an operation of the observing unit; and a property data storage unit that stores property data that is determined in accordance with attribute values representing attributes of the specimen, the property data being associated with each of the attribute values. The observation system control unit includes a specimen attribute designating unit that designates the attribute values of the specimen to be observed; a property data selecting unit that selects at least one set of property data in accordance with the attribute values designated by the specimen attribute designating unit, from the property data stored in the property data storage unit; and a system environment setting unit that sets system parameters for setting an operating environment of the observing unit at the time of observation of the specimen to be observed, based on the property data selected by the property data selecting unit.

The above and other features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic view for explaining the entire structure of a microscopy system in accordance with a first embodiment;

FIG. 2 is a block diagram showing the functional structure of the microscopy system in accordance with the first embodiment;

FIG. 3 is a diagram for explaining an example data structure of property data;

FIG. 4 is a diagram for explaining another example data structure of the property data;

FIG. 5 is a diagram for explaining yet another example data structure of the property data;

FIG. 6 is a flowchart showing the procedures in a process to be performed by the observation system control unit of the first embodiment;

FIG. 7 shows an example of the stained specimen attribute designating screen in accordance with the first embodiment;

FIG. 8 is a flowchart showing the specific procedures to be carried out in a possible characteristic wavelength determining process;

FIG. 9 is a flowchart showing the specific procedures to be carried out in a characteristic wavelength determining process;

FIG. 10 shows an example of a characteristic wavelength confirming screen;

FIG. 11 is a flowchart showing the specific procedures in the target extracting process;

FIG. 12 shows an example of a combined change-rate spectral image;

FIG. 13 shows an example of a combined change-rate spectral image selecting screen;

FIG. 14 shows an example of an observation target tissue extraction screen;

FIG. 15 shows an example of a virtual special stained image;

FIG. 16 shows an example of a characteristic wavelength change screen;

FIG. 17 is a block diagram showing the functional structure of a microscopy system in accordance with a second embodiment;

FIG. 18 is a flowchart showing the procedures in the process to be performed by the observation system control unit of the second embodiment;

FIG. 19 shows an example of a stained specimen attribute designating screen of the second embodiment;

FIG. 20 is a flowchart showing the specific procedures in the stained specimen image analyzing process;

FIG. 21A shows an example of an all-wavelength combined change-rate spectral image;

FIG. 21B shows another example of an all-wavelength combined change-rate spectral image;

FIG. 21C shows an example of a logical-difference spectral image;

FIG. 22 is a block diagram showing the functional diagram of an image processing device in accordance with a third embodiment;

FIG. 23 shows the reference spectrum graphs of a combination a dye H and a dye E under the same creation conditions;

FIG. 24 illustrates the method of determining the creation condition determining parameters;

FIG. 25 shows partial reference spectrum graphs;

FIG. 26 shows an example of the creation condition determining parameter distribution;

FIG. 27 is a flowchart showing the procedures in the process to be performed by the image processing device of the third embodiment;

FIG. 28 is a flowchart showing the specific procedures in the specimen creation condition estimating process;

FIG. 29 shows an example of an analysis region selecting screen;

FIG. 30 shows an example of an analysis region confirming screen;

FIG. 31 shows an example of an absorbance graph;

FIG. 32 shows an example of the average graph created from the absorbance graph shown in FIG. 31;

FIG. 33 shows a quadratic differential square graph showing the quadratic differential average square;

FIG. 34 shows an example of a flat wavelength interval selecting screen;

FIG. 35 shows an example of a creation condition correcting screen;

FIG. 36 is a flowchart showing the specific procedures in the image displaying process in accordance with the third embodiment;

FIG. 37 shows an example of a display image viewing screen of the third embodiment;

FIG. 38 is a block diagram showing the functional structure of an image processing device in accordance with a fourth embodiment;

FIG. 39 is a flowchart showing the specific procedures in the image displaying process in accordance with the fourth embodiment;

FIG. 40 shows an example of a viewing screen of the fourth embodiment;

FIG. 41 is a block diagram showing the functional structure of a microscopy system in accordance with a fifth embodiment;

FIG. 42 illustrates an example data structure of property data; and

FIG. 43 is a flowchart showing the procedures in the process to be performed by the observation system control unit of the fifth embodiment.

### DETAILED DESCRIPTION

The following is a detailed description of preferred embodiments of the present invention. Those embodiments do not limit the invention. In the drawings, like components are denoted by like reference numerals.

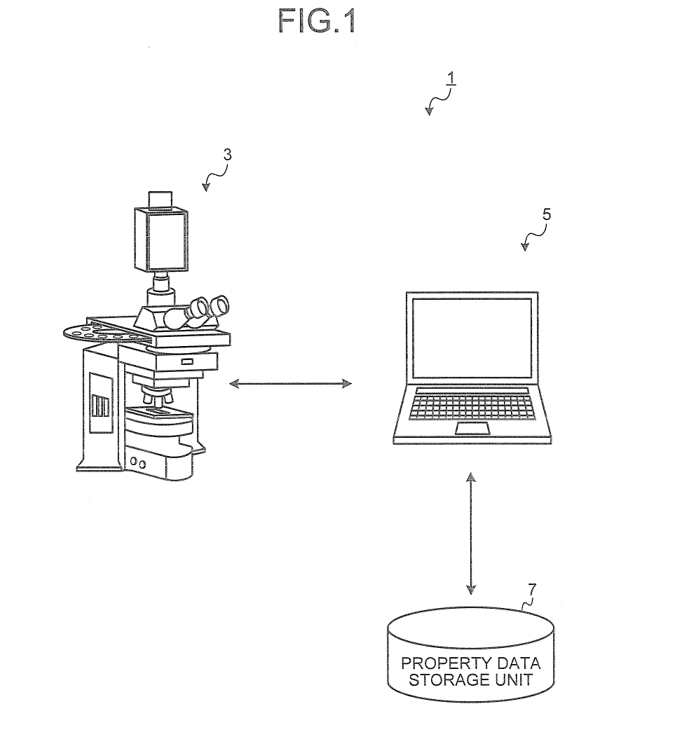

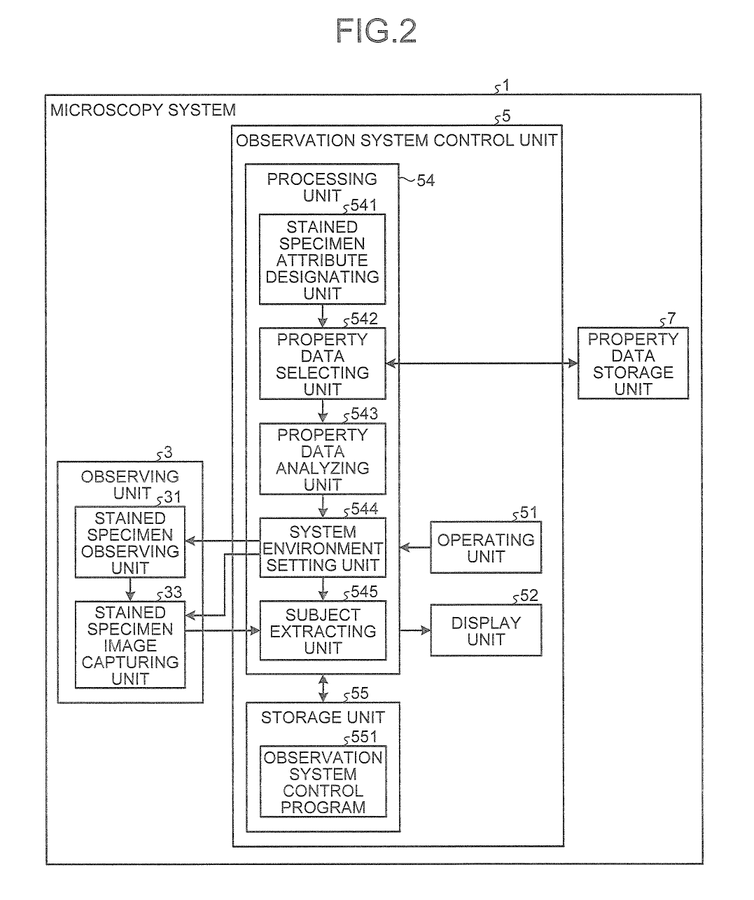

As a first embodiment, a microscopy system that captures multiband images of stained specimens as subjects that are H/E stained pathological specimens (body tissue specimens) for observation is described. FIG. 1 is a schematic view for explaining the entire structure of a microscopy system 1 of the first embodiment. FIG. 2 is a block diagram of the functional structure of the microscopy system 1. The microscopy system 1 of the first embodiment includes an observing unit 3, an observation system control unit 5, and a property data storage unit 7. Those components are connected to one another in a data exchangeable fashion.

The observing unit 3 includes a stained specimen observing unit 31 for observing stained specimens and a stained specimen image capturing unit 33 for capturing images of stained specimens.

The stained specimen observing unit 31 is formed with a microscope that can transparently observe stained specimens, and includes a light source for emitting illuminating light, an objective lens, an electromotive stage, an illuminating light system, and an observation optical system for forming observation images of observed stained specimens, and the likes. The electromotive stage has a stained specimen placed thereon for observation (stained specimens to be observed will be hereinafter referred to as “observation stained specimens”), and moves in the optical axis direction of the objective lens and in a plane perpendicular to the optical axis direction. The illuminating optical system transparently illuminates each observation stained specimen placed on the electromotive stage. The stained specimen observing unit 31 illuminates the observation stained specimens with illuminating light emitted from the light source, and forms observation images of the observation stained specimens in cooperation with the objective lens.

The stained specimen image capturing unit 33 is formed with a multiband camera that captures multiband observation images of observation stained specimens. The multiband camera is configured to create image data consisting of pixel values obtained for each pixel in multiple bands each having different spectral characteristic. More specifically, the stained specimen image capturing unit 33 is formed with a tunable filter, a two-dimensional CCD camera, a filter controller that adjusts wavelengths of light transmitted through the tunable filter, a camera controller that controls the two-dimensional CCD camera, and the likes. The stained specimen image capturing unit 33 projects an observation image of a stained specimen to be observed by the stained specimen observing unit 31 onto the imaging element of the two-dimensional CCD, and captures the observation image as a stained specimen image. The tunable filter is a filter that is capable of electrically adjusting the wavelength of transmitted light. In the first embodiment, a filter that is capable of selecting a bandwidth of an arbitrary width of 1 nm or greater (hereinafter referred to as the “selected wavelength width”) is used. For example, a commercially available filter such as a liquid crystal tunable filter, “VariSpec, manufactured by Cambridge Research & Instrumentation, Inc.), may be used as needed. In this manner, a stained specimen image is obtained as a multiband image by the stained specimen image capturing unit 33. The pixel values of the stained specimen image is equivalent to the intensities of light in the bandwidth arbitrarily selected by the tunable filter, and pixel values within the bandwidth selected for the respective points in the observation stained specimen are obtained. The respective points in the observation stained specimen are the respective points on the observation stained specimen corresponding to the respective projected pixels on the imaging element. Hereinafter, the respective points on each observation stained specimen correspond to the respective pixel positions in the corresponding stained specimen image.

Although the stained specimen image capturing unit 33 includes a tunable filter in the above description, the present invention is not limited to that arrangement, as long as the information about the light intensity at each of the points on each observation stained specimen can be obtained. For example, according to an imaging method disclosed in Japanese Laid-open Patent Publication No. 7-120324, a predetermined number (sixteen, for example) of bandpass filters may be rotated by a filter wheel, and be switched. In doing so, multiband images of observation stained specimens may be captured in a frame sequential method.

The observation system control unit 5 is designed for a physician or the like to examine and gives a diagnose based on a stained specimen image captured by the stained specimen image capturing unit 33 of the observing unit 3, and may be realized by a general-purpose computer such as a workstation or a personal computer. The observation system control unit 5 instructs the stained specimen observing unit 31 and the stained specimen image capturing unit 33 of the observing unit 3 to perform operations. The observation system control unit 5 performs processing on each stained specimen image input from the stained specimen image capturing unit 33, and displays each processed image on its display unit.

The observation system control unit 5 includes an operating unit 51, a display unit 52, a processing unit 54, and a storage unit 55, as shown in FIG. 2.

The operating unit 51 may be realized by a keyboard, a mouse, a touch panel, various kinds of switches, or the like. In accordance with input operations, the operating unit 51 outputs operation signals to the processing unit 54. The display unit 52 may be a display device such as a flat panel display such as a LCD or an EL display, or a CRT display. In accordance with display signals input from the processing unit 54, the display unit 52 displays various kinds of screens.

The processing unit 54 is realized by hardware such as a CPU. Based on operation signals that are input from the operating unit 51, image data about stained specimen images that are input from the stained specimen image capturing unit 33 of the observing unit 3, programs and data that are stored in the storage unit 55, or the like, the processing unit 54 issues instructions or transfers data to the respective components of the observation system control unit 5, or issues various operation instructions to the stained specimen observing unit 31 and the stained specimen image capturing unit 33 of the observing unit 3. In this manner, the processing unit 54 collectively controls the operations of the entire microscopy system 1.

The processing unit 54 includes a stained specimen attribute designating unit 541, a property data selecting unit 542, a property data analyzing unit 543, a system environment setting unit 544, and a target extracting unit 545.

The stained specimen attribute designating unit 541 designates attribute values representing the attributes of observation stained specimens, in accordance with user operations. Here, the attributes of each stained specimen (hereinafter referred to as the “stained specimen attributes”) are formed with the four attribute items: stain type, organ, target tissue, and facility. The stained specimen attribute designating unit 541 designates the attribute values of those four attribute items about each observation stained specimen, in accordance with user operations. In the first embodiment, a user designates the magnification of the microscope (the stained specimen observing unit 31) for observing an observation stained specimen, as well as the stained specimen attributes of the observation stained specimen.

Based on the stained specimen attributes designated by the stained specimen attribute designating unit 541, the property data selecting unit 542 selects one or more sets of property data from the property data stored in the property data storage unit 7.

Based on the one or more sets of property data selected by the property data selecting unit 542, the property data analyzing unit 543 determines a characteristic wavelength that is a wavelength characteristic of the observation stained specimen, more specifically, the target tissue.

The system environment setting unit 544 sets system parameters for setting an operating environment (a system environment) of the observing unit 3, so as to increase the sensitivity with respect to a bandwidth of a predetermined width including the characteristic wavelength determined by the property data analyzing unit 543. For example, the system environment setting unit 544 sets system parameters that include an observation parameter for setting the operating environment of the stained specimen observing unit 31 and an imaging parameter for setting the operating environment of the stained specimen image capturing unit 33.

The target extracting unit 545 performs image processing on the stained specimen image captured by the stained specimen image capturing unit 33 of the observing unit 3, and extracts the region including the target tissue from the stained specimen image.

The storage unit 55 is realized by an IC memory such as a ROM or RAM (a rewritable flash memory, for example), a hard disk that is installed therein or is connected thereto by a data communication terminal, an information storage medium such as a CD-ROM, a reading device for reading the information storage device, and the likes. This storage unit 55 stores a program for causing the observation system control unit 5 to operate to realize the various functions of the observation system control unit 5, the data to be used in execution of the program, and the likes. The storage unit 55 also stores an observation system control program 551. This observation system control program 551 is a program for controlling the operation of the observing unit 3 by setting system parameters based on the stained specimen attributes of observation stained specimens, to realize the processing for obtaining stained specimen images.

The property data storage unit 7 stores therein property data corresponding to attribute values of the attribute items of the stained specimen attributes. The property data storage unit 7 is realized by, for example, a database device connected to the observation system control unit 5 via a network, and is installed in a separate area remote from the observation system control unit 5, where the property data is stored and managed. The storage unit 55 of the observation system control unit 5 may be configured to store property data.

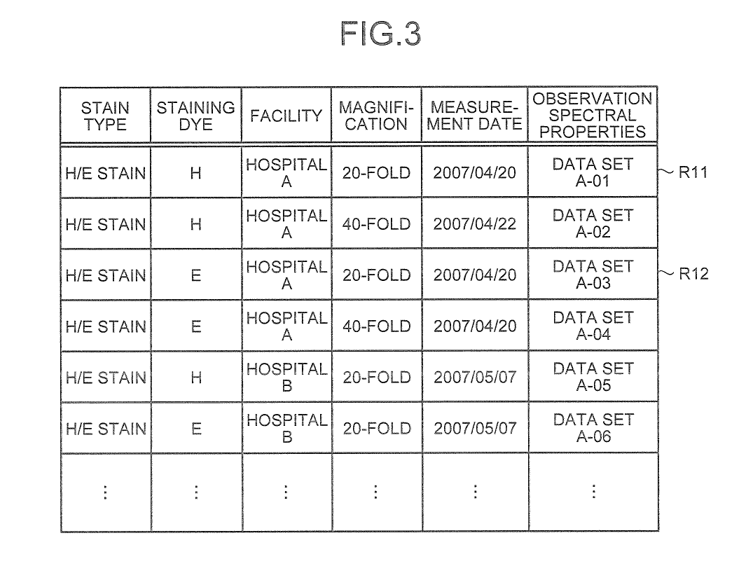

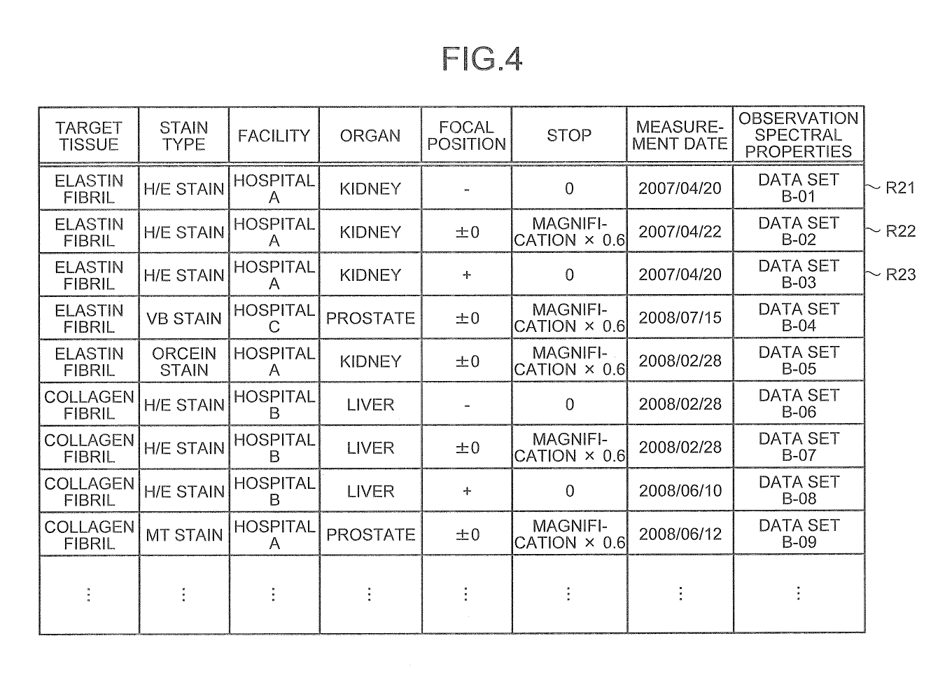

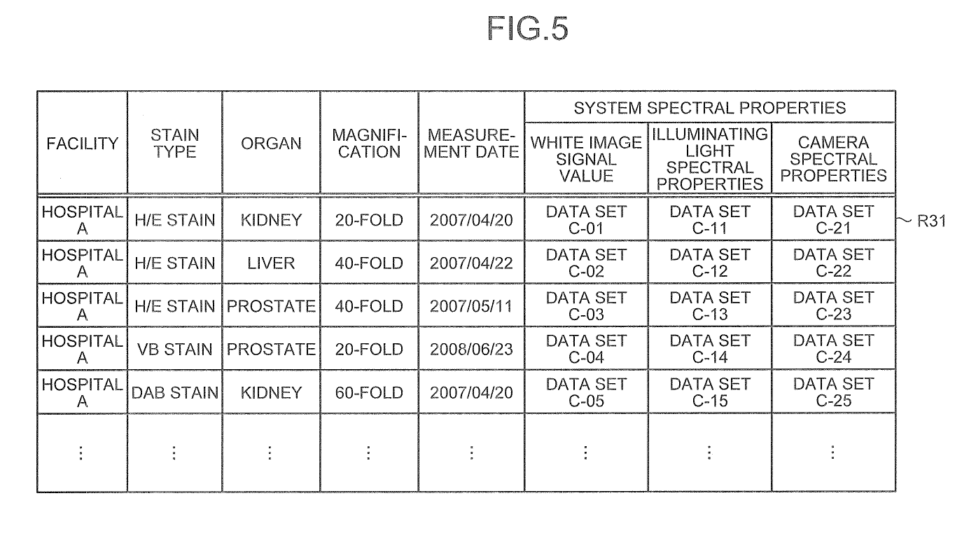

FIGS. 3 to 5 are diagrams for explaining example data structures of the property data stored in the property data storage unit 7. FIG. 3 shows a list of the property data associated with “stain type”, which is one of the attribute items, in the property data storage unit 7. FIG. 4 shows a list of the property data associated with “target tissue”, which is also one of the attribute items, in the property data storage unit 7. FIG. 5 shows a list of the property data associated with “facility”, which is one of the attribute items, in the property data storage unit 7. The associations of the property data with the respective attribute items shown in FIGS. 3 to 5 are managed with a known database management tool, for example. However, the data structures of the property data are not limited to those, and any structure may be employed as long as the property data corresponding to attribute values designated for the respective attribute items can be obtained.

More specifically, the property data storage unit 7 stores property data about each stain type at each attribute value, as shown in FIG. 3. The property data at each attribute value includes a facility as one of the attribute items, a magnification, a measurement date, and observation spectral properties as observation parameters. The observation spectral properties (data sets A-01 to A-06, . . . ) associated with the stained type are the spectral property data (spectral data) that are measured beforehand with respect to the staining dye of the corresponding stain type, and the spectral property data measured at the corresponding magnification at the corresponding medical facility on the corresponding measurement date are stored. Here, the observation spectral properties are the properties of the substance with respect to light, and may be represented by the spectral feature value of the spectral reflectance and absorbance, and spectral reflectance, for example.

The property data storage unit 7 also stores the property data about each target tissue at each attribute value, as shown in FIG. 4. The property data at each attribute value includes a stain type, a facility, and an organ as the attribute items, and a focal position and aperture, the measurement date, and the observation spectral properties as observation parameters, with those items being associated with one another. The observation spectral properties (data sets B-01 to B-09, . . . ) associated with each target tissue are the spectral properties that are measured beforehand with respect to the target tissue of the corresponding organ, and the spectral property data measured at the corresponding focal position and aperture at the corresponding medical facility on the corresponding measurement date are stored. Although “elastin fibril” and “collagen fibril” are shown as examples of target tissues in FIG. 4, the spectral properties about target tissues of interest of physicians at the times of examinations and diagnoses, such as cytoplasm and nuclei, are also measured in advance and are stored in the property data storage unit 7.

The property data storage unit 7 also stores the property data about each facility at each attribute value, as shown in FIG. 5. The property data at each attribute value includes a stain type and an organ as attribute items, the magnification, the measurement date, and the system spectral properties of the white image signal value as a system spectral property value, the illuminating light spectral properties, and the camera spectral properties as the observation parameters, with those items being associated with one another. The system spectral properties associated with each facility are the spectral property data about the system measured at the corresponding facility. More specifically, the white image signal values (data sets C-01 to C-05, . . . ) are the image signal values obtained by capturing images of regions in which tissues do not exist, and the image signals values obtained at each corresponding magnification and each corresponding measurement date are stored. The illuminating light spectral properties (data sets C-11 to C-15, . . . ) are the spectral properties of the illuminating light of the stained specimen observing unit 31 measured with the use of a spectrometer or the like on the corresponding measurement date. The camera spectral properties (data sets C-21 to C-25, . . . ) are the spectral properties of the camera (a two-dimensional CCD camera) of the stained specimen image capturing unit 33 measured at the corresponding magnification on the corresponding measurement date.

To cope with capturing special images such as fibril regions or phase objects, spectral properties may be measured under conditions with different observation parameters such as NA values, defocusing amounts, and light quantities, and the spectral properties associated with the conditions at the time of measurement may be stored in the property data storage unit 7. Also, among the facilities, different staining processes may be employed, and different reagents may be used for staining. In such cases, spectral properties may be measured under the different conditions corresponding to the respective facilities, and the spectral properties associated with the conditions at the time of measurement may be stored in the property data storage unit 7.

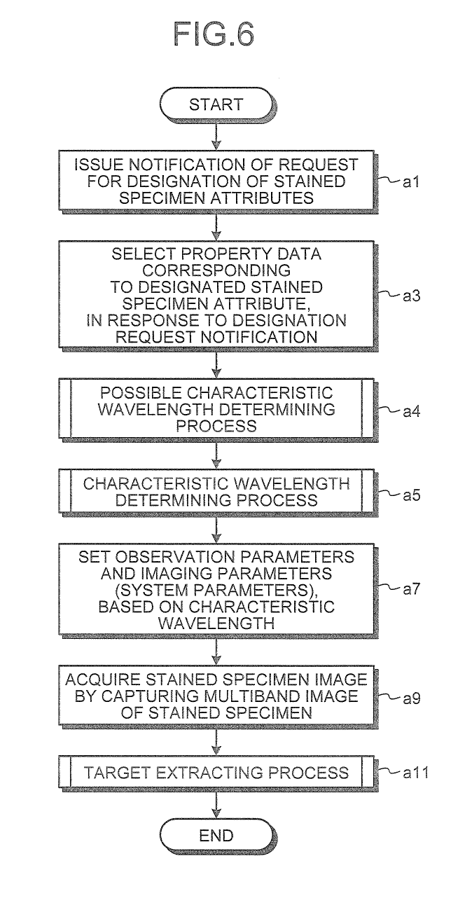

FIG. 6 is a flowchart showing the procedures in the process to be performed by the observation system control unit 5 of the first embodiment. The process to be described in the following is realized by the respective components of the observation system control unit 5 according to the observation system control program 551 stored in the storage unit 55.

First, the stained specimen attribute designating unit 541 performs a process to display a stained specimen attribute designating screen on the display unit 52 and issue a request for designation of stained specimen attributes, and receives an operation performed by a user to designate stained specimen attributes and the magnification through the operating unit 51 (step a1).

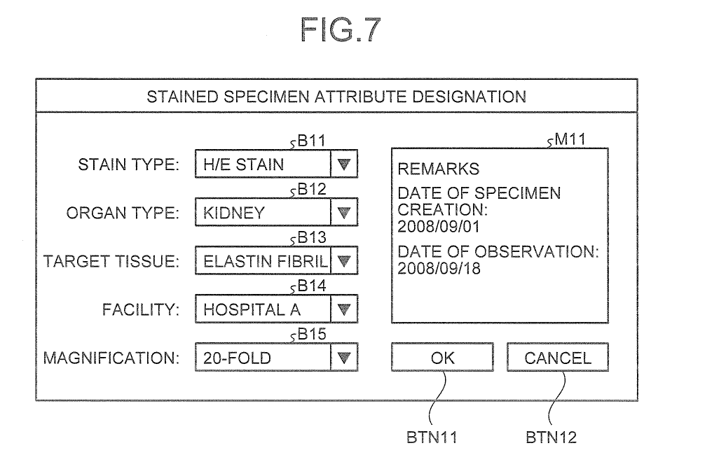

FIG. 7 shows an example of the stained specimen attribute designating screen of the first embodiment. Spin boxes B11 to B14 for designating the attribute values of the four attribute items of a stain type, an organ, a target tissue, and a facility, a spin box B15 for designating a magnification, an OK button BTN11 for entering an operation at each of the spin boxes, and a cancel button BTN12 for canceling an operation are arranged on the stained specimen attribute designating screen shown in FIG. 7. Each of the respective spin boxes B11 to B14 shows a list of the attribute values that can be designated for the corresponding attribute item, and receives a designation input. Here, the attribute values of each of the attribute items stored in the property data storage unit 7 are shown as choices. For example, the spin box B11 for designating a stain type shows the attribute values of stain types such as H/E stain, VB stain, orcein stain, MT stain, and DAB stain as shown in FIGS. 3 to 5, and “others” for designating a value not included in those attribute values. Likewise, the spin boxes B12 to B14 for designating an organ, a target tissue, and a facility also shows the attribute values stored in the property data storage unit 7 and “others”. The spin box B15 shows values that can be designated as the values of the magnification, and prompts the user to select a value. Here, the values of the magnification stored in the property data storage unit 7 are also shown as choices.

On the stained specimen attribute designating screen, the user designates a stain type included in observation stained specimens. The user also designates the organ from which the observation stained specimen is taken. The user also designates the tissue of interest (the target tissue) to be looked at when the observation stained specimen is examined and diagnosed. The user also designates the medical facility at which the observation stained specimen is taken, for example. The user further designates the magnification, as well as those four stained specimen attributes.

A remarks column M11 is also provided on the stained specimen attribute designating screen, and the user can freely put down things such as the date of creation of the stained specimen or the date of examination and diagnosis of the stained specimen.

Once the attribute values of the stained specimen attributes are designated, the property data selecting unit 542 refers to the property data storage unit 7, and selects one or more sets of property data in accordance with the designated attribute values of the stained specimen attributes (step a3), as shown in FIG. 6. Based on the property data selected at step a3, the property data analyzing unit 543 performs a possible characteristic wavelength determining process (step a4), and then performs a characteristic wavelength determining process (step a5) to determine the characteristic wavelength of the target tissue. Based on the characteristic wavelength determined at step a5, the system environment setting unit 544 sets system parameters (observation parameters and imaging parameters) (step a7). The system environment setting unit 544 outputs the system parameters to the stained specimen observing unit 31 and the stained specimen image capturing unit 33, and issues operation instructions. As a result, the observing unit 3 operates in accordance with the system parameters set by the system environment setting unit 544, and acquires a stained specimen image by capturing a multiband image of the observed image of the stained specimen (step a9). The target extracting unit 545 then performs a target tissue extracting process, and performs image processing on the stained specimen image, to extract the region in which the target tissue exists from the stained specimen image (step a11). The extraction method may be a known method.

In the following, the procedures of steps a3 to all are described in detail, with the example case being a case where the user designates the following items through the stained specimen attribute designating screen shown in FIG. 7: “H/E stain” as the stain type, “kidney” as the organ, “elastin fibril” as the target tissue, “hospital A” as the facility, and “20-fold” as the magnification.

First, the procedure of step a3 of FIG. 6 is explained. Under the conditions in the example case, the property data selecting unit 542 refers to the property data storage unit 7, and selects the records R11 and R12 in which the stain type is “H/E stain”, the facility is “hospital A”, and the magnification is “20-fold”, from the property data about stained types shown in FIG. 3, and acquires the data sets A-01 and A-03 of the corresponding observation spectral properties. The property data selecting unit 542 also selects the records R21 to R23 in which the target tissue is “elastin fibril”, the stain type is “H/E stain”, the facility is “hospital A”, and the organ is “kidney”, from the property data about target tissues shown in FIG. 4, and acquires the data sets B-01, B-02, and B-03 of the corresponding observation spectral properties. The property data selecting unit 542 further selects the record R31 in which the facility is “hospital A”, the stain type is “H/E stain”, the organ is “kidney”, and the magnification is “20-fold”, from the property data about facilities shown in FIG. 5, and acquires the data sets C-01, C-11, and C-21 of the corresponding system spectral properties. The acquired data sets A-01, A-03, B-01, B-02, and B-03 of the observation spectral properties and the acquired data sets C-01, C-11, and C-21 of the system spectral properties (the white image signal value, the illumination spectral properties, and camera spectral properties) are stored in the storage unit 55, together with the attribute values and the value of the magnification designated through the stained specimen attribute designating screen.

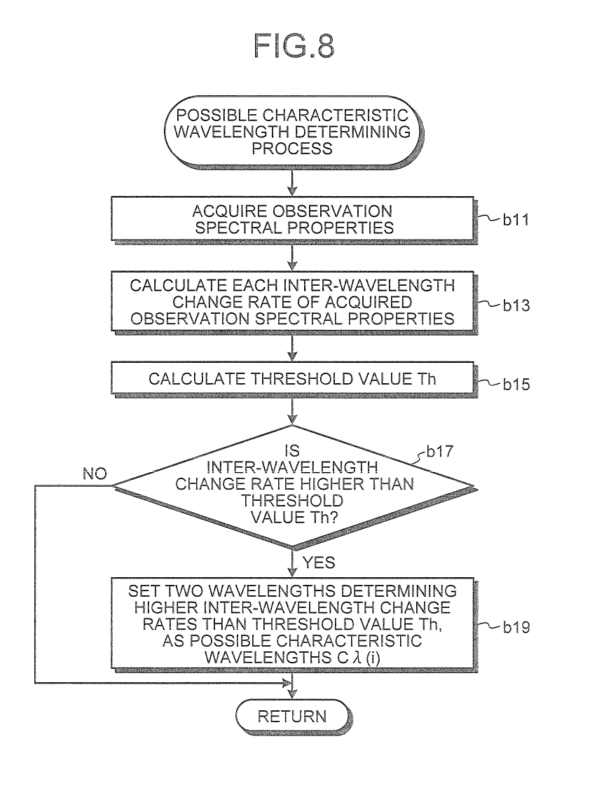

The possible characteristic wavelength determining process of step a4 of FIG. 6 is now explained. In the possible characteristic wavelength determining process, the property data analyzing unit 543 determines possible characteristic wavelengths Cλ(i) (i=1, 2, 3, . . . , n) of the target tissue, based on the observation spectral properties (data sets) obtained as described above. In the first embodiment, based on the rates of change of wavelengths in the observation spectral properties, wavelengths having rates of change exceeding a predetermined threshold value is selected as possible characteristic wavelengths. FIG. 8 is a flowchart showing the specific procedures in the possible characteristic wavelength determining process.

As shown in FIG. 8, the property data analyzing unit 543 reads and acquires the observation spectral properties (data of the property data selected at step a3 of FIG. 6 (step b11). The property data analyzing unit 543 then calculates each inter-wavelength change rate r(λ) of the acquired observation spectral properties (step b13). Each inter-wavelength change rate r(λ) is expressed by the following equation (5), with A(λ) representing the observation spectral properties at the wavelength λ, and α [nm] representing each wavelength interval. Through this process, the inter-wavelength change rates r(λ) of the observation spectral properties of the respective acquired data sets A-01, A-03, B-01, B-02, and B-03 are calculated.

$$r ( λ ) = \vert \frac{A ( λ + α ) - A ( λ )}{α} \vert \qquad ( 5 )$$

The property data analyzing unit 543 then calculates a threshold value Th to determine possible characteristic wavelengths (step b15). First, the property data analyzing unit 543 calculates the average inter-wavelength change rate E and the standard deviation std of the observation spectral properties. Where λ_{MIN} represents the minimum wavelength, Sₙᵤₘ represents the number of wavelengths, and ave represents the average value of the observation spectral properties, the average inter-wavelength change rate E is expressed by the following equation (6), and the standard deviation std of the observation spectral properties is expressed by the following equation (7):

$$\begin{matrix}E = \frac{{\sum }_{n = 0 , λ = {λ}_{MIN} + n}^{n = {S}_{num}} r ( λ )}{{S}_{num}} & ( 6 ) \\ std = \sqrt{\frac{{\sum }_{n = 0 , λ = {λ}_{MIN} + n}^{n = {S}_{num}} {( A ( λ ) - ave )}^{2}}{{S}_{num}}} & ( 7 )\end{matrix}$$

Here, the number of wavelengths Sₙᵤₘ is expressed by the following equation (8), with λ_{MAX} representing the maximum wavelength:

$${S}_{num} = \frac{( {λ}_{MAX} - {λ}_{MIN} )}{α} + 1 \qquad ( 8 )$$

The property data analyzing unit 543 then calculates the threshold value Th according to the following equation (9), with k representing a coefficient that is arbitrarily set:

Th=E+k×std (9)

The property data analyzing unit 543 then sequentially performs threshold processing, using each inter-wavelength change rate r(λ) of the observation spectral properties calculated at step b13 and the threshold value Th calculated at step b15. If the inter-wavelength change rate r(λ) is higher than the threshold value Th (step b17: Yes), the property data analyzing unit 543 sets the two wavelengths (λ+α, λ) determining the inter-wavelength change rates r(λ) higher than the threshold value Th, as the possible characteristic wavelengths Cλ(i) (step b19). After performing the threshold processing on all the inter-wavelength change rates r(λ), the process returns to step a4 of FIG. 6, and then moves on to step a5. Through those procedures, the two wavelengths (λ+α, λ) determining the inter-wavelength change rates r(λ) higher than the threshold value Th are determined as the possible characteristic wavelengths Cλ(i) among the inter-wavelength change rates r(λ) calculated about the observation spectral properties of the respective data sets A-01, A-03, B-01, B-02, and B-03.

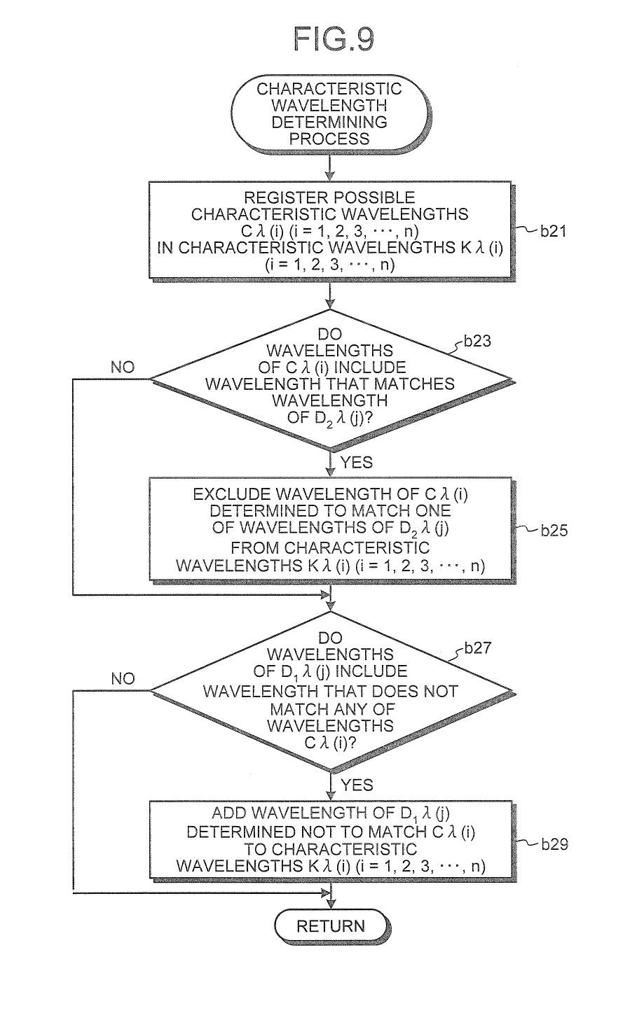

Next, the characteristic wavelength determining process at step a5 of FIG. 6 is explained. In the characteristic wavelength determining process, the property data analyzing unit 543 determines a characteristic wavelength from the possible characteristic wavelengths Cλ(i) determined at step a4. Tissues that are to be preferentially stained with a staining dye (or are to be easily stained) are physicochemically determined. Accordingly, the property data analyzing unit 543 determines the characteristic wavelength Kλ(i)=1, 2, 3, . . . , n), in accordance with the relations between the target tissue and staining dyes (a staining dye that preferentially stains the target tissue and a staining dye that do not stains the target tissue, to be specific). FIG. 9 is a flowchart showing the specific procedures in the characteristic wavelength determining process.

Here, the observation spectral properties about the stain type (the data sets A-01 and A-03) indicate the properties of the corresponding staining dyes (dyes H and E in this case). In the first embodiment, possible characteristic wavelengths obtained from the observation spectral properties about the staining dyes that preferentially stain the target tissue are represented by D₁λ(k) (k=1, 2, 3, . . . , m₁). Also, possible characteristic wavelengths obtained from the staining dyes that do not stain the target tissue are represented by D₂λ(j) (j=1, 2, 3, . . . , m₂). For example, the elastin fibril that is the target tissue in the first embodiment is preferentially dyed with the dye E. Accordingly, the possible characteristic wavelengths obtained from the observation spectral properties corresponding to the dye E (the data set A-03) are set as D₁λ(k). Since the dye H is a staining dye that does not stain elastic fibrils, the possible characteristic wavelengths obtained from the observation spectral properties corresponding to the dye H (the data set A-01) are set as D₂λ(k).

As shown in FIG. 9, the property data analyzing unit 543 first registers the possible characteristic wavelengths Cλ(i) (i=1, 2, 3, . . . , n) in the characteristic wavelengths Kλ(i) (i=1, 2, 3, . . . , n) (step b21). The property data analyzing unit 543 then compares Cλ(i) (i=1, 2, 3, . . . , n) with D₂λ(j) (j=1, 2, 3, . . . , m₂), and determines which wavelength of Cλ(i) matches which wavelength of D₂λ(j). If the wavelengths of Cλ(i) include a wavelength that matches one of the wavelengths of D₂λ(j) (step b23: Yes), the property data analyzing unit 543 excludes the matched wavelength Cλ(i) from the characteristic wavelengths Kλ(i) (i=1, 2, 3, . . . , n) (step b25).

The property data analyzing unit 543 compares Cλ(i) (i=1, 2, 3, . . . , n) with D₁λ(k) (k=1, 2, 3, . . . , m₁), and determines whether any of the wavelengths of D₁λ(k) matches any of the wavelengths of Cλ(i). If the wavelengths of D₁λ(k) includes a wavelength that does not match any of the wavelengths of Cλ(i) (step S27: Yes), the property data analyzing unit 543 adds the wavelength of D₁λ(k) determines not to match with any of the wavelengths of Cλ(i) to the characteristic wavelengths Kλ(i) (i=1, 2, 3, . . . , n) (step b29). The property data analyzing unit 543 lastly determines the wavelengths registered in Kλ(i) (i=1, 2, 3, . . . , n) to be the characteristic wavelengths. After that, the property data analyzing unit 543 returns to step a5 of FIG. 6, and moves on to step a7.

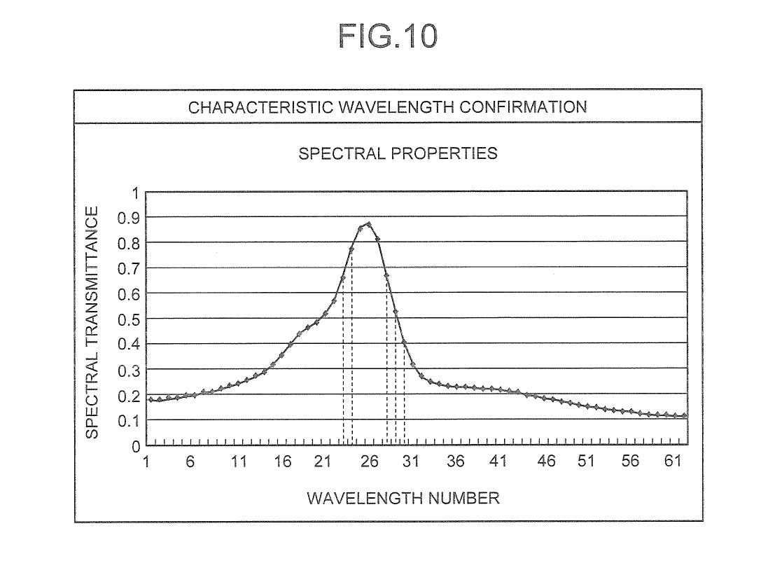

After the characteristic wavelengths are determined, a characteristic wavelength confirming screen may be displayed on the display unit 52, to show the user the determined characteristic wavelengths. FIG. 10 shows an example of the characteristic wavelength confirming screen. As shown in FIG. 10, the observation spectral properties of the property data selected in accordance with the stained specimen attributes of the observation stained specimen are displayed in the form of a graph on the characteristic wavelength confirming screen, and the determined characteristic wavelengths are distinguished by the broken lines. FIG. 10 is a graph showing the observation spectral properties (the data set B-02, for example) of the property data having “elastin fibril” selected as the target tissue, and indicates an example case where the spectral transmittance is used as the observation spectral properties.

The characteristic wavelength determining method described here is merely an example, and the present invention is not limited to that. For example, the threshold processing with the use of the threshold value Th may not be performed, and the wavelength having the highest inter-wavelength change rate may be set as a characteristic wavelength. Alternatively, the principal component analysis may be carried out on the observation spectral properties of each data set, and, based on the results of the principal component analysis, the wavelengths having high contribution rates may be set as characteristic wavelengths.

Alternatively, the data sets of the observation spectral properties acquired by the property data selecting unit 542 may be compared with one another, to determine the characteristic wavelengths. In a case where the data sets B-01, B-02, and B-03 having different observation parameters such as the focal position and aperture of the microscope (the observing unit 3) are acquired as the data sets of the observation spectral properties as described above, for example, the data sets B-01, B-02, and B-03 may be compared with one another, to determine the characteristic wavelengths. The following processing is performed on each of the combinations of the acquired data sets (the three combinations of B-01 and B-02, B-01 and B-03, B-02 and B-03 in this case). The difference in observation spectral properties between the wavelengths of each combination is calculated. The wavelengths having a difference greater than a predetermined threshold value are determined to be the characteristic wavelengths.

Next, the procedure of step a7 of FIG. 6 is described. The system environment setting unit 544 first sets the observation parameters and the imaging parameters (the system parameters), based on the above determined characteristic wavelengths.

Here, the imaging parameters are the values related to the operations of the multiband camera, and the system environment setting unit 544 notifies the stained specimen image capturing unit 33 of the set values of the imaging parameters, and issues an operation instruction to the stained specimen image capturing unit 33. In response to the operation instructions from the system environment setting unit 544, the stained specimen image capturing unit 33 performs the settings of the gain, the exposure time, the bandwidth to be selected by the tunable filter (the selected wavelength width), and the likes, in accordance with the supplied imaging parameters. In this manner, the stained specimen image capturing unit 33 drives the multiband camera.

In the first embodiment, the system environment setting unit 544 sets the bandwidth to be selected by the tunable filter (the selected wavelength width) as one of the imaging parameters. For example, the system environment setting unit 544 sets the selected wavelength width in the bandwidth within the ±5 nm range of the characteristic wavelength, to 1 nm, which is the smallest wavelength width that can be selected by the tunable filter. The system environment setting unit 544 also sets the selected wavelength width in the bandwidths other than the bandwidth within the ±5-nm of the characteristic wavelength is set at the initial value (25 nm, for example). In accordance with the selected wavelength width of each of the set bandwidths, the stained specimen image capturing unit 33 sequentially selects the bandwidths to be selected by the tunable filter, and captures an image of the stained specimen image in each of the selected bandwidths.

The system environment setting unit 544 also sets the exposure time, as the second one of the imaging parameters. For example, the system environment setting unit 544 uses the data set of the white image signal values (the data set C-01 in this case) selected by the property data selecting unit 542, and adjusts the exposure time so that the largest value of the white image signal values has a predetermined luminance value. The system environment setting unit 544 then sets the adjusted exposure time as the exposure time in the bandwidths outside the ±5 nm range of the characteristic wavelength. As for the exposure time in the bandwidth within the ±5 nm range of the characteristic wavelength, the system environment setting unit 544 first issues operation instructions to the stained specimen observing unit 31 and the stained specimen image capturing unit 33, and acquires white image signal values at the designated magnification. Using the acquired white image signal values, the system environment setting unit 544 calculates the exposure time at each of the measured wavelengths. By doing so, the system environment setting unit 544 can set the exposure time in accordance with the environment at the time of observation (at the time of capturing a stained specimen image) in the vicinity of the characteristic wavelength.

In the above example, the two imaging parameters of the bandwidth to be selected by the tunable filter (the selected wavelength width) and the exposure time are set. However, imaging parameters concerning the values other than those settings may be set as needed.

Meanwhile, the observation parameters are the values related to operations of the microscope. The system environment setting unit 544 notifies the stained specimen observing unit 31 of the set values of the observation parameters, and issues an operation instruction to the stained specimen observing unit 31. In response to the operation instruction from the system environment setting unit 544, the stained specimen observing unit 31 adjusts the components of the microscope when observing an observation stained specimen, by performing switching of the magnification of the objective lens, control of the modulated light of the light source depending on the switched magnification, switching of optical elements, moving of the electromotive stage, and the likes, in accordance with the supplied observation parameters.

In the first embodiment, the system environment setting unit 544 sets the values of the magnification, the focal position, and the aperture of the microscope, as the observation parameters.

As for the magnification, a designated magnification is set. As for the focal position and the aperture, the values corresponding to the observation spectral properties (the data set) used to acquire the determined characteristic wavelength (the wavelength of Kλ(i)) are loaded from the property data storage unit 7, and are set. For example, if the characteristic wavelength Kλ(i) is determined based on the inter-wavelength change rate calculated from the observation spectral properties of the data set B-02, the focal position “±0” and the aperture “magnification×0.6” indicated in the record R22 corresponding to the data set B-02 as shown in FIG. 4 are set as the observation parameters. Using the observation parameters set here, the stained specimen observing unit 31 sets the focal position and the aperture value to be used by the stained specimen image capturing unit 33 to capture a stained specimen image in a bandwidth containing the characteristic wavelength Kλ(i).

Where sets of observation spectral properties (data sets) are acquired, the characteristic wavelength Kλ(i) may be set based on the inter-wavelength change rate calculated from the observation spectral properties of another data set. For example, the characteristic wavelength Kλ(j) might be redundantly determined based on the inter-wavelength change rates calculated from the observation spectral properties of the data sets B-01, B-02, and B-03 independently of one another. In such a case, the focal position and the aperture value corresponding to the observation spectral properties (the data set) having the highest inter-wavelength change rate among the inter-wavelength change rates calculated from the respective observation spectral properties at the characteristic wavelength Kλ(i) are set as the observation parameters.

In a case where the wavelength having the highest inter-wavelength change rate is set as the characteristic wavelength as described above as a modification, the focal position and the aperture value corresponding to the data set used to calculate this inter-wavelength change rate are loaded from the property data storage unit 7, and are set. In a case where the results of the principal component analysis carried out on the observation spectral properties of the respective data sets are used, and the wavelength having the highest contribution rate is set as the characteristic wavelength, the focal position and the aperture value corresponding to the data set of the principal component analysis results achieving the wavelength with the highest contribution rate are loaded from the property data storage unit 7, and are set.

In a case where sets of observation spectral properties (data sets) are acquired, the characteristic wavelength might be determined by calculating the difference in the observation spectral properties between each two data sets at each wavelength. In this case, the focal positions and the aperture values corresponding to the respective data sets used to determine the characteristic wavelength are loaded, and two sets of observation parameters in combination with the designated magnification are set. For example, where the wavelength at which the difference in observation spectral properties between the data set B-01 and B-02 is large is determined as the characteristic wavelength, the focal position “− (negative)” and the aperture value “0” are read from the record R21 corresponding to the data set B-01 as shown in FIG. 4, and are set as the first observation parameters. The focal position “±0” and the aperture “magnification×0.6” are read from the record R22 corresponding to the data set B-02 as shown in FIG. 4, and are set as the second observation parameters.

In this description, the three items of the magnification, the focal position, and the aperture of the microscope are set as the observation parameters. However, values related to items other than those three may be arbitrarily set as the observation parameters as needed.

The system parameters (the observation parameters and the imaging parameters) that are set in the above manner are stored as a system setting file associated with the stained specimen attributes in the storage unit 55. Since the system parameters are stored as the system setting file, the system parameters can be set simply by loading the system setting file when the same combination of stained specimen attributes and magnification is designated in the future.

At step a9 of FIG. 6, the system environment setting unit 544 sequentially outputs the selected wavelength width and the exposure time in the corresponding bandwidth to the stained specimen image capturing unit 33. The system environment setting unit 544 also outputs the respective values of the magnification, the focal position, and the aperture that are set as the observation parameters to the stained specimen observing unit 31, and obtains a stained specimen image at each selected wavelength width. The image data about the obtained stained specimen images are stored into the storage unit 55. In a case where the first observation parameters and the second observation parameters are set as the observation parameters as described above as a modification, the system environment setting unit 544 sequentially outputs the first observation parameters and the second observation parameters to the stained specimen observing unit 31, and acquires a stained specimen image twice, with the observation parameters being switched. More specifically, a first stained specimen image is obtained by observing and capturing a multiband image of a stained specimen, with the first parameters being the observation parameters. A second stained specimen image is obtained by observing and capturing a multiband image of the stained specimen, with the second parameters as the observation parameters.

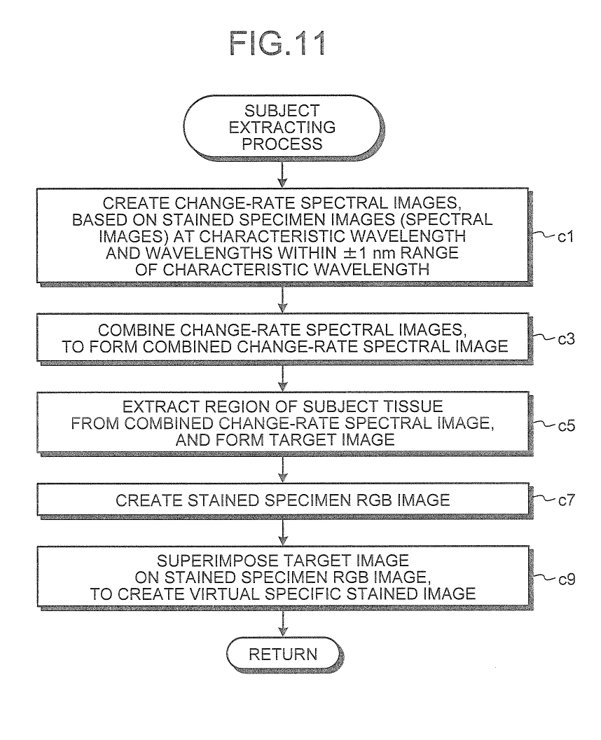

Next, the target extracting process of step all of FIG. 6 is described. FIG. 11 is a flowchart showing the specific procedures in the target extracting process. As shown in FIG. 11, in the target extracting process, the target extracting unit 545 first creates a change-rate spectral image, based on the stained specimen image obtained at the characteristic wavelength and the stained specimen images (the spectral images) captured within the ±1-nanometer range of the characteristic wavelength (step c1). Here, a “spectral image” is a stained specimen image obtained at a certain wavelength among stained specimen images.

The target extracting unit 545 first creates a change-rate spectral image, based on the spectral image at the characteristic wavelength ω [nm] and the spectral image at the wavelength ω−1 [nm]. More specifically, the target extracting unit 545 performs an operation to calculate the spectral transmittance at each of the points corresponding to the pixels in the stained specimen, based on the image signal values and the white image signal values of the spectral images at the characteristic wavelength ω [nm] and the wavelength ω−1 [nm]. Using the spectral transmittance calculated for each pixel, the target extracting unit 545 calculates the inter-wavelength change rate r(λ) in spectral transmittance between the spectral images (or calculates the absolute value of the difference in spectral transmittance between the characteristic wavelength ω [nm] and the wavelength ω−1 [nm]) for each pixel in the same manner as in the calculating process performed by the property data analyzing unit 543 according to the equation (5). The pixel value of the pixel having the highest inter-wavelength change rate r(λ) is “255”, and the pixel value of the pixel having the inter-wavelength change rate r(λ) of zero is “0 (zero)”. The target extracting unit 545 assigns the pixel values to the pixels, in accordance with the respective inter-wavelength change rates r(λ). The target extracting unit 545 then creates a change-rate spectral image as a gray scale image. The target extracting unit 545 also creates another change-rate spectral image in the same manner as above, based on the spectral image at the characteristic wavelength ω [nm] and the spectral image at the wavelength ω+1 [nm].

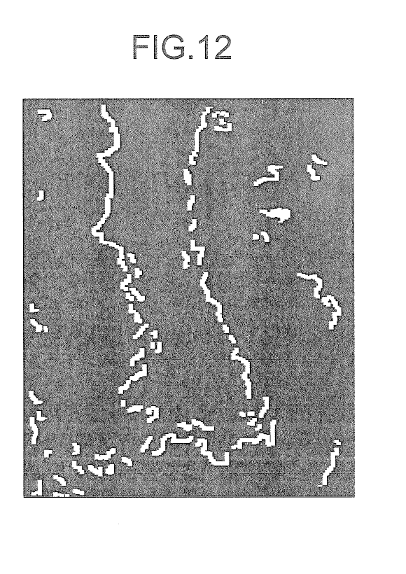

The target extracting unit 545 combines the two change-rate spectral images created as above, to create a combined change-rate spectral image (step c3). FIG. 12 shows an example of the combined change-rate spectral image. This combined change-rate spectral image is obtained as an image in which the pixels with high inter-wavelength change rates r(λ) are emphasized. If there is more than one wavelength determined as characteristic wavelengths through the characteristic wavelength determining process of FIG. 9, the procedures of steps c1 to c3 are carried out for each of the characteristic wavelengths, to create combined change-rate spectral images at the respective characteristic wavelengths. The combined change-rate spectral images created at the respective characteristic wavelengths are further combined to form a combined change-rate spectral image. In a case where two sets of observation parameters are set as described above as a modification, the same process is performed for both the first stained specimen image and the second stained specimen image. The image data about the one or more combined change-rate spectral images is stored into the storage unit 55.

The target extracting unit 545 then extracts the region of the target tissue from the combined change-rate spectral image, and creates a target image (step c5). For example, the target extracting unit 545 arbitrarily performs known image processing in combination, such as smoothing, binarizing, edge extracting, and morphological processing (expanding and contracting), on the combined change-rate spectral image. By doing so, the target extracting unit 545 extracts the region of the target tissue. If the target tissue is a tissue that has particular shapes like nuclei or red blood cells, the target extracting unit 545 may perform particle analysis on the combined change-rate spectral image, to determine parameters such as the area and the circularity. By doing so, the target extracting unit 545 can extract the region of the target tissue with higher precision. The data about the created target image is stored into the storage unit 55.

More specifically, in a case where there is more than one wavelength determined as the characteristic wavelength, the combined change-rate spectral images at the respective characteristic wavelengths are created, and the combined change-rate spectral images at the respective characteristic wavelengths are further combined to form a combined change-rate spectral image. In a case where two sets of observation parameters are set as described above as a modification, two combined change-rate spectral images are created. Accordingly, the target extracting unit 545 causes the display unit 52 to display the combined change-rate spectral images, and one of the combined change-rate spectral images is manually or automatically selected in accordance with a user operation. The target extracting unit 545 then carries out the procedure of step c5 on the selected combined change-rate spectral image, to create a target image.

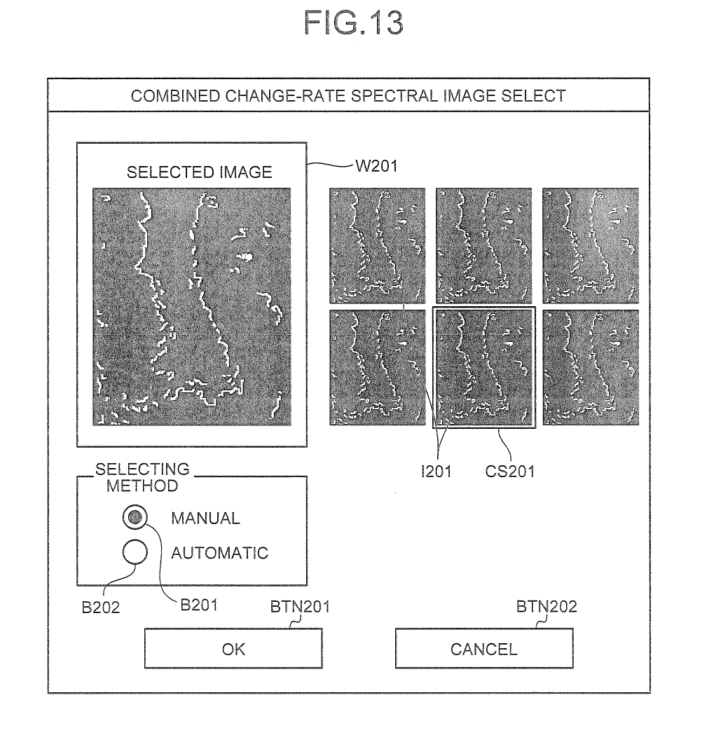

FIG. 13 shows an example of a combined change-rate spectral image selection screen. This combined change-rate spectral image selection screen is displayed on the display unit 52, when two or more combined change-rate spectral images are created. As shown in FIG. 13, combined change-rate spectral images I201 are displayed as thumbnails on the combined change-rate spectral image selection screen. The combined change-rate spectral image selection screen includes an image display portion W201 that displays one of the combined change-rate spectral images as a selected image, and enlarges a combined change-rate spectral image selected manually or automatically through a user operation.

On the combined change-rate spectral image selection screen, the following buttons are also provided: radio buttons B201 and B202 for selecting manual selection or automatic selection of a combined change-rate spectral image from two or more combined change-rate spectral images, an OK button BTN201 for entering an operation, a cancel button BTN202 for canceling an operation, and the likes.

For example, when the radio button B201 is selected in FIG. 13, one of the combined change-rate spectral images is manually selected by moving a cursor CS201 through the operating unit 51, and the combined change-rate spectral image selected with the cursor CS201 is enlarged as the selected image on the image display portion W201: When the radio button B202 is selected, one of the combined change-rate spectral images is automatically selected, and the selected combined change-rate spectral image is enlarged as the selected image on the image display portion W201. In the internal process in this case, the target extracting unit 545 calculates the average pixel value of all the pixels in each of the combined change-rate spectral images. The target extracting unit 545 then selects the combined change-rate spectral image having the largest average pixel value, and causes the image display portion W201 to display the selected combined change-rate spectral image. The user then presses the OK button 201 while the desired combined change-rate spectral image is displayed as the selected image on the image display portion W201.

A process to extract the target tissue may be performed by displaying spectral images, change-rate spectral images, and combined change-rate spectral images on the display unit 52. In such a case, the threshold value to be used in the binarizing process on the combined change-rate spectral images, and image processing to be performed to extract the region of the target tissue, such as smoothing, binarizing, edge extracting, morphological processing (expanding and contracting), and the likes may be conducted through the display unit 52.

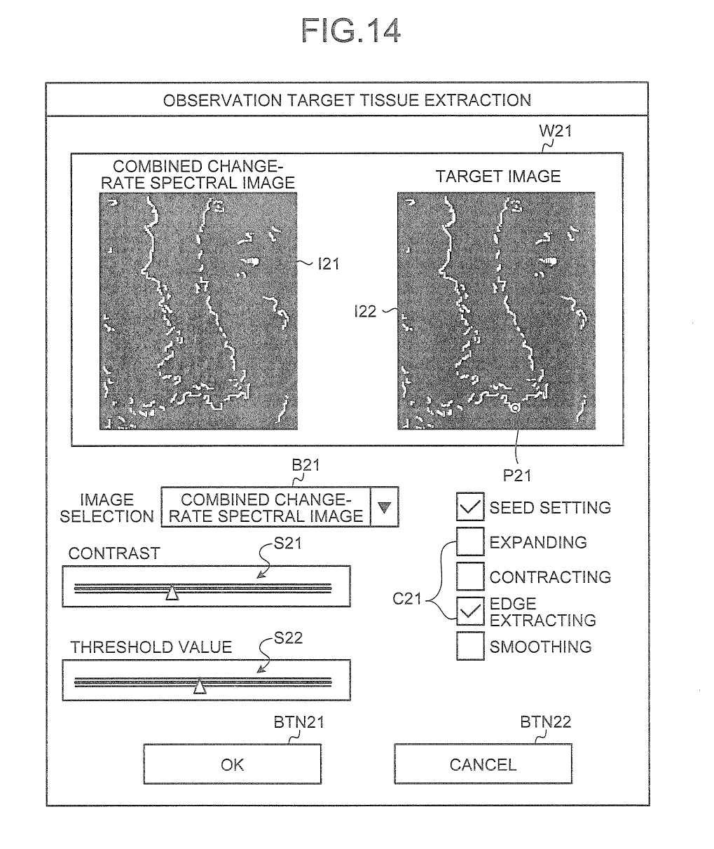

FIG. 14 shows an example of an observation target tissue extraction screen. As shown in FIG. 14, the observation target tissue extraction screen includes an image display portion W21 that displays a spectral image, a change-rate spectral image, or a combined change-rate spectral image, and a target image obtained by performing image processing on a combined change-rate image. A spectral image, a change-rate spectral image, or a combined change-rate spectral image to be displayed in the left side of the image display portion W21 can be selected through a list box B21. In FIG. 14, a combined change-rate spectral image is selected through the list box B21. The combined change-rate spectral image I21 created at step c1 is displayed in the left side of the image display portion W21, and a target image I22 subjected to the image processing is displayed in the right side of the image display portion W21.

On the observation target tissue extraction screen, the following items are also provided: a slider bar S21, a slider bar S22, check boxes C21, an OK button BTN21 for entering an operation, a cancel button BTN22 for canceling an operation, and the likes. The slider bar S21 is designed to adjust the contrast. The slider bar S22 is designed to designate the threshold value to be used in the binarizing process. The check boxes C21 are designed to select the image processing to be performed on the combined change-rate spectral image. In FIG. 14, five check boxes for selecting seed setting, expanding, contracting, edge extracting, and smoothing independently of one another are provided as the check boxes C21. When the check box for seed setting is selected, a pointer P21 is displayed on the target image I22 on the image display portion W21. For example, the user operates the operating unit 51 to move the pointer P21 onto the position of the target tissue in the combined change-rate spectral image, and presses the OK button BTN21. In this case, the position of the pointer P21 is set as the starting point, and the spectral image is searched for the pixel values similar to the pixel value of the starting point. In this manner, the region of the target tissue is extracted.

With this arrangement, the user can set the threshold value and designate the image processing to be performed on the combined change-rate spectral image, while looking at a spectral image, a change-rate spectral image, or a combined change-rate spectral image.

Referring back to FIG. 11, the target extracting unit 545 converts the value of the spectral transmittance determined with respect to each pixel in the stained specimen images into a RGB value, and creates a RGB image (a stained specimen RGB image) to be displayed (step c7). Where T(x) represents the spectral transmittance at a point (a pixel) x in a stained specimen image, the RGB value G_{RGB}(x) is expressed by the following equation (10):

G_{RGB}(x)=HT(x) (10)

Here, H in the equation (10) represents a system matrix, and is expressed by the following equation (11):

H=FSE (11)

Here, “F” represents the spectral transmittance of the tunable filter. Also, “S” represents the spectral sensitivity characteristics of the camera, and the data set of the camera spectral properties corresponding to the property data about the facility selected based on the attribute values of the stained specimen attribute of the observation stained specimen is used (the data set C-21 in this example). Further, “E” represents the spectral emittance characteristics of the illumination per unit time, and the data set of the illuminating light spectral properties corresponding to the property data about the selected facility is used (the data set C-01 in this example). Since the spectral transmittance values with respect to all the pixel positions x in the stained specimen image are calculated, the process to convert T(x) into a RGB value with respect to an image position x is repeated over the entire image, to obtain an RGB image having the same width and height as the captured multiband image. The data about the stained specimen RGB image created in this manner is stored into the storage unit 55.

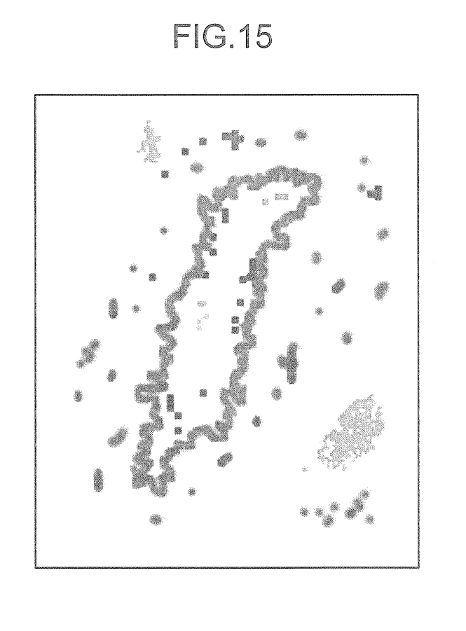

The target extracting unit 545 then superimposes the target image on the stained specimen RGB image, to create a virtual special stained image (step c9). The data about the virtual special stained image created here is stored into the storage unit 55. FIG. 15 shows an example of the virtual special stained image. This virtual special stained image is obtained as an image formed by subjecting a specimen to special staining to stain the target tissue, and the region of the target tissue in the stained specimen image can be discriminated with high visibility.

The technique for extracting the region explained here is merely an example, and the present invention is not limited to that. For example, a discriminator such as a support vector machine (SVM) is used to extract the pixels of the target tissue through a learning discriminating process using the feature value as the observation spectral properties. For example, the inter-wavelength change rate between the wavelengths ω and ω−1, and the inter-wavelength change rate between the wavelengths ω and ω+1 are calculated, based on the observation spectral properties of the target tissue (the data set B-01 or the like in this example). The inter-wavelength change rates are combined to form combined change-rate data. With the combined change-rate data being “teacher data”, a learning discriminating process may be performed on the combined change-rate spectral image created at step c3, to extract the pixels of the target tissue. Here, the learning discriminating process may be performed, with only the characteristic wavelength being the effective wavelength. In this manner, the number of dimensions can be reduced, and the discrimination accuracy can be made higher.

As described above, in accordance with the first embodiment, the property data containing the spectral properties measured beforehand for each attribute value of stained specimen attributes can be stored in the property data storage unit 7. The property data corresponding to the attribute value of a designated observation stained specimen is selected, and the selected property data is analyzed to determine the characteristic wavelength of the target tissue. In this manner, the system parameters for setting the operating environment of the observing unit 3 to observe the observation stained specimen can be set. At this point, the selective bandwidth (the selected wavelength width) of the tunable filter to capture a stained specimen image can be set, based on the determined characteristic wavelength of the target tissue. More specifically, the selected wavelength width is reduced near the characteristic wavelength, and the system parameters can be set in accordance with the actual environment at the time of observation (when a stained specimen image is captured).

Since the spectral characteristics of the target tissue can be obtained with high precision as a result, it is possible to set appropriate system parameters for acquiring a stained specimen image from which the region of the target tissue can be extracted with high accuracy. Accordingly, a system environment optimum for obtaining the characteristics of the specimen to be observed can be automatically set, and it is possible to obtain a stained observation image from which the region of the target tissue can be easily observed and diagnosed.

Also, image processing may be performed on a stained specimen image obtained in accordance with the set system parameters, and the region showing the target tissue can be extracted. A virtual special stained image that shows the region of the target tissue and the other region separated from each other can be formed. Even if the staining performed on the specimen is not sufficient or is uneven, it is possible to discriminate the region of the target tissue from the other tissues with high visibility.

Conventionally, if the region of the target tissue was not easily recognized visually, a stained specimen image was repeatedly obtained while the microscope and the multiband camera was directly operated, until a stained specimen image that could be easily observed was obtained. If the visibility was poor due to insufficient staining of the obtained stained specimen image, a clinical laboratory technologist was requested to re-stain the specimen. Here, the operation to detect a wavelength characteristic of the target tissue requires skill, and places large load on the user.

In the first embodiment, on the other hand, the user (a pathologist) does not need to operate a microscope or a multiband camera, and can observe and diagnose while looking at a virtual special stained image or the like displayed on the display unit 52 at a different place from the place where the observing unit 3 is installed. Also, there is no need to carry out the procedures for requesting a clinical laboratory technologist to re-stain the specimen and having the specimen re-stained. Accordingly, it is possible to spare the user the trouble of operating a microscope or a multiband camera to obtain stained specimen images. Thus, the influence of insufficient staining on the diagnosis accuracy can be reduced. Also, the number of people involved in diagnoses can be reduced, and the diagnosis time can be shortened. Accordingly, a cost reduction can be realized.

In the above described first embodiment, the characteristic wavelength is automatically determined, and the system parameters are set to obtain stained specimen images. However, the determined characteristic wavelength and the coefficient k in the equation (9) to be used to determine the characteristic wavelength may be changed by user operation.

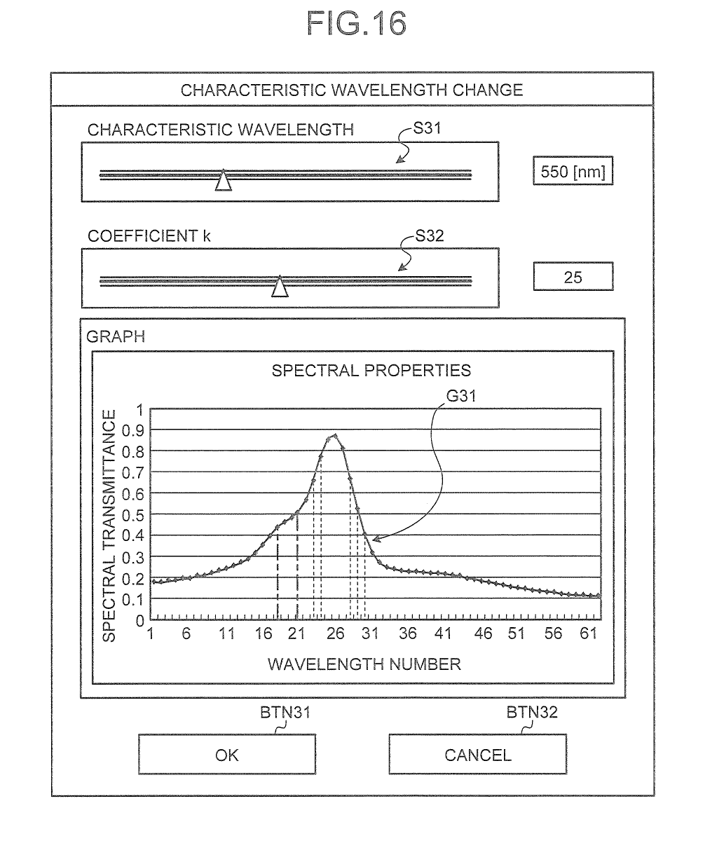

FIG. 16 shows an example of a characteristic wavelength change screen. On the characteristic wavelength change screen shown in FIG. 16, two slider bars S31 and S32, an OK button BTN31 for entering an operation through the slider bar S31 or S32, a cancel button BTN32 for cancelling an operation, and the likes are provided. The slider bar S31 is designed to change characteristic wavelengths. The slider bar S32 is designed to change the coefficient k. The characteristic wavelength change screen also displays a graph G31 that is the same as the graph of FIG. 16 showing the observation spectral properties of the property data selected in accordance with the stained specimen attributes of the observation stained specimen. Together with the graph G31, the current characteristic wavelengths are also shown by dotted lines. In a case where wavelengths not suitable as a selected bandwidth (a selected wavelength width) of the tunable filter set as one of the imaging parameters are determined in advance with respect to the staining dye, the wavelengths that cannot be changed or cannot be selected as a bandwidth are shown together with the graph G31, as indicated by the dot-and-dash lines in FIG. 16.

At this point, the colors of the dotted lines may be varied in accordance with the observation spectral properties (the data sets) used to acquire the determined characteristic wavelengths (the wavelengths of Kλ(i)), and the characteristic wavelengths determined from different observation spectral properties may be displayed in a discriminable manner. Alternatively, the characteristic wavelengths may be displayed with different line types, so that the characteristic wavelengths can be discriminated from one another.

On the characteristic wavelength change screen, the user operates the slider bar S31 to change characteristic wavelengths, or operates the slider bar S32 to change the value of the coefficient k, for example. When the OK button BTN31 is pressed after the slider bar S31 is operated, the value entered by pressing the OK button BTN31 is set as a characteristic wavelength, and the dotted lines indicating the characteristic wavelengths in the graph G31 are updated in accordance with the changed characteristic wavelengths. When the slider bar S32 is operated, the value set by operating the slider bar S32 is set as the value of the coefficient k, and the threshold value Th is changed. The above described process is then performed with the use of the threshold value Th, and possible characteristic wavelengths are again obtained. The characteristic wavelengths are then re-determined. In this case, the dotted lines indicating the characteristic wavelengths in the graph G31 are also updated in accordance with the changed characteristic wavelengths.

In accordance with this modification, the user can directly adjust the characteristic wavelengths or can adjust the characteristic wavelengths by correcting the value of the coefficient k, while checking the graph indicating the observation spectral properties. In this manner, the user can set a more appropriate system environment.

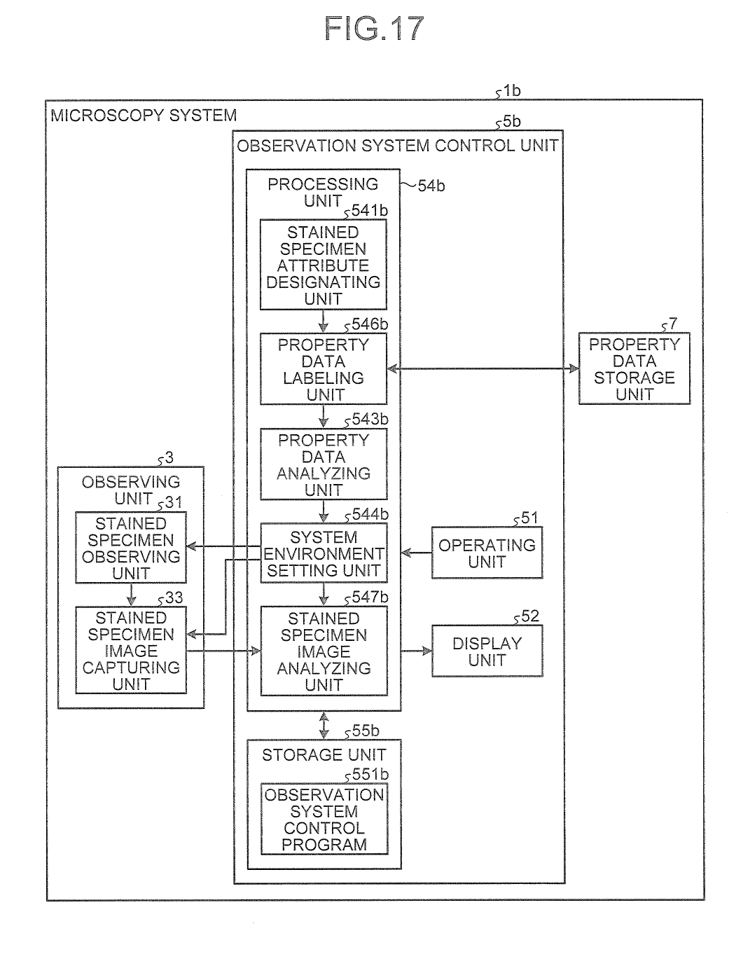

Next, a second embodiment of the present invention is described. FIG. 17 is a block diagram showing the functional structure of a microscopy system 1b of the second embodiment. In FIG. 17, the same components as those of the microscopy system 1 of the first embodiment are denoted by the same reference numerals as those used in the first embodiment.

As shown in FIG. 17, an observation system control unit 5b of the second embodiment includes the operating unit 51, the display unit 52, a processing unit 54b, and a storage unit 55b.

The processing unit 54b includes a stained specimen attribute designating unit 541b, a property data labeling unit 546b, a property data analyzing unit 543b, a system environment setting unit 544b, and a stained specimen image analyzing unit 547b.

The stained specimen attribute designating unit 541b designates the attribute values of the stained specimen attributes and the magnification for the observation stained specimen in accordance with a user operation. In the second embodiment, a plurality of target tissues can be designated as the target tissues that are one of the attribute items. An example case where one tissue is selected as the target tissue has been described in the first embodiment. In the following, a case where two or more tissues are designated as target tissues is described.

Based on the designated stained specimen attributes, the property data labeling unit 546b selects one or more sets of property data from the property data stored in the property data storage unit 7, and labels the selected property data in accordance with the designated two or more target tissues.

Based on the one or more sets of property data selected by the property data labeling unit 546b, the property data analyzing unit 543b determines the characteristic wavelength of each of the target tissues.

The system environment setting unit 544b compares the characteristic wavelengths of the respective target tissues determined by the property data analyzing unit 543b with one another, and sets the system parameters so that the sensitivity becomes higher with respect to a predetermined bandwidth including the characteristic wavelengths.

The stained specimen image analyzing unit 547b performs image processing on a stained specimen image captured by the stained specimen image capturing unit 33, and extracts the regions showing the respective designated target tissues from the stained specimen image.

The storage unit 55b stores an observation system control program 551b for realizing a process to control the operation of the observing unit 3 by setting the system parameters based on the stained specimen attributes of each observation stained specimen, and acquire stained specimen images.

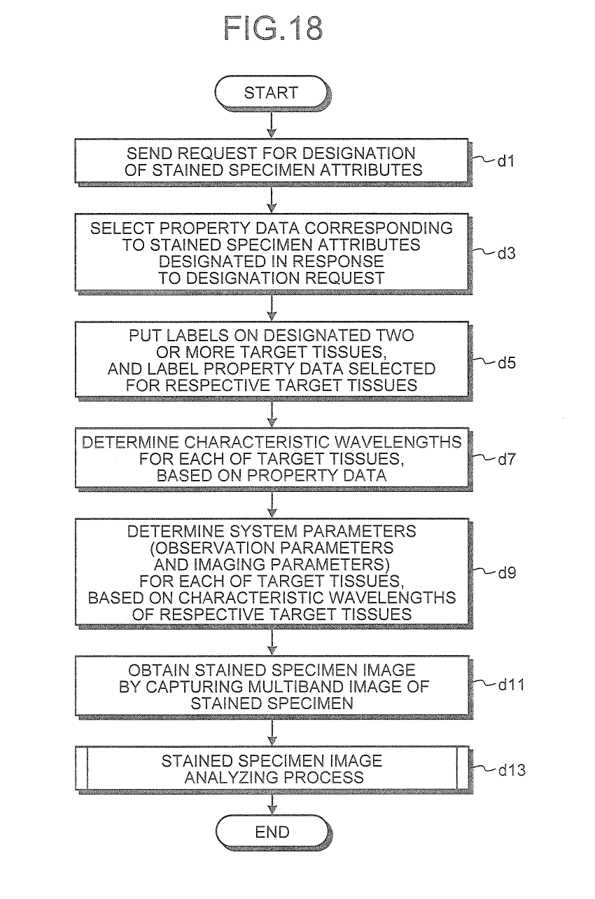

FIG. 18 is a flowchart showing the procedures in the process to be performed by the observation system control unit 5b of the second embodiment. The process described below is realized by the respective components of the observation system control unit 5b operating in accordance with the observation system control program 551b stored in the storage unit 55b.

First, the stained specimen attribute designating unit 541b performs a process to display a stained specimen attribute designating screen on the display unit 52 and issue a request for designation of stained specimen attributes, and receives an operation performed by a user to designate stained specimen attributes and a magnification through the operating unit 51 (step d1).

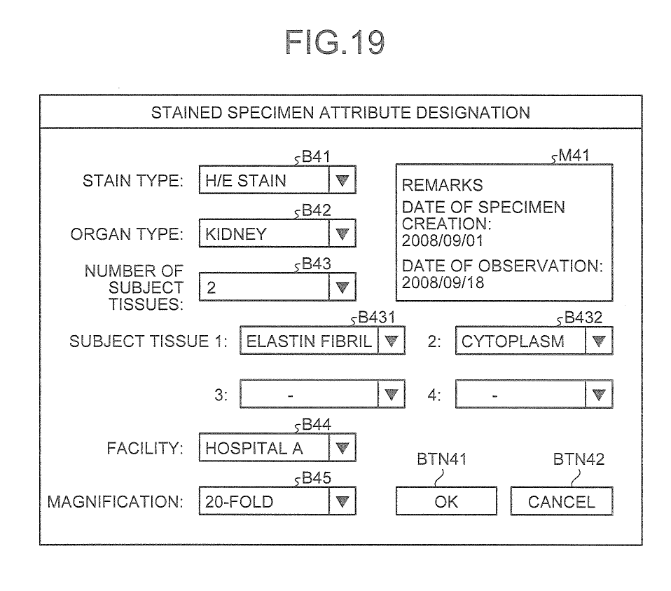

FIG. 19 shows an example of the stained specimen attribute designating screen of the second embodiment. Spin boxes B41, B42, and B44 for designating the attribute values of the attribute items of a stain type, an organ, and a facility, are provided on the stained specimen attribute designating screen shown in FIG. 19. Also, a spin box B43 for designating the number of target tissues (the target tissue number), spin boxes B431 and B432 for designating the target tissues in the number designated through the spin box B43 independently of one another, and the likes are provided on the stained specimen attribute designating screen. Further, a spin box B45 for designating a magnification, an OK button BTN41 for entering an operation at each of the spin boxes, a cancel button BTN42 for canceling an operation, a remarks column M41, and the likes are arranged on the stained specimen attribute designating screen. In the second embodiment, the user designates the number of tissues to be designated as the target tissues, and designates target tissues in the designated number through the stained specimen attribute designating screen. In FIG. 19, four target tissues can be designated at a maximum, but the number of target tissues to be designated is not specifically limited.

Once the attribute values of the stained specimen attributes are designated, the property data labeling unit 546b refers to the property data storage unit 7, and selects one or more sets of property data in accordance with the stained specimen attributes designated in response to the designation request from the stained specimen attribute designating unit 541b (step d3), as shown in FIG. 18. The selection of the property data can be performed in the same manner as in the first embodiment.

The property data labeling unit 546b then assigns sequential numbers and labels to the designated two or more target tissues, and puts labels on the property data selected for the respective target tissues (step d5). More specifically, the property data labeling unit 546b puts labels Lₙ assigned to the target tissues (n=1, 2, 3, . . . , the number of target tissues) on the property data selected in accordance with the target tissues. For example, as shown in FIG. 19, “elastin fibril” is selected as the first target tissue 1 at the spin box B431, and “cytoplasm” is designated as the second target tissue 2 at the spin box B432. In this case, the label L₁ is put on the property data selected based on “elastin fibril”, and the label L₂ is put on the property data selected based on “cytoplasm”.

Based on the property data selected at step d3, the property data analyzing unit 543b determines the characteristic wavelengths of the target tissues (step d7). The characteristic wavelengths can be determined in the same manner as in the first embodiment. However, characteristic wavelengths are determined for each of the target tissues. The determined characteristic wavelengths and the labels Lₙ associated with the corresponding target tissues are stored into the storage unit 55b.

Based on the characteristic wavelengths determined at step d7, the system environment setting unit 544b sets system parameters (observation parameters and imaging parameters) (step d9). The system parameters can be set in the same manner as in the first embodiment. However, system parameters are set for each of the target tissues. As a result, a selected bandwidth (a selected wavelength width) for the tunable filter is set in accordance with the characteristic wavelengths determined for the respective target tissues. The system parameters associated with the labels Lₙ representing the respective target tissues are stored into the storage unit 55b.

The system environment setting unit 544b then outputs the system parameters to the stained specimen observing unit 31 and the stained specimen image capturing unit 33 of the observing unit 3, and issues operation instructions. As a result, the observing unit 3 operates in accordance with the system parameters set by the system environment setting unit 544b, and acquires a stained specimen image by capturing a multiband image of the observed image of the stained specimen (step d11).

The stained specimen image analyzing unit 547b then performs a stained specimen image analyzing process, and performs image processing on the stained specimen image to extract the regions showing the target tissues in the stained specimen image (step d13). More specifically, the stained specimen image analyzing unit 547b extracts the regions showing the target tissues, based on the stained specimen image obtained at the characteristic wavelength common to the respective target tissues and the stained specimen images obtained at different characteristic wavelengths.

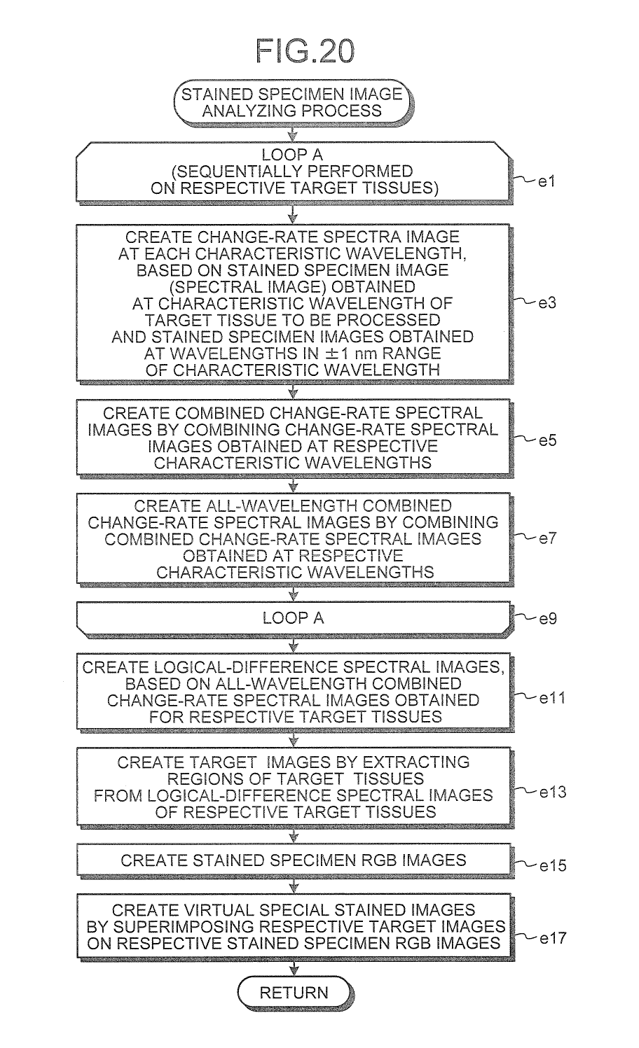

FIG. 20 is a flowchart showing the specific procedures in the stained specimen image analyzing process. As shown in FIG. 20, in the stained specimen image analyzing process, the stained specimen image analyzing unit 547b sequentially performs processing on the target tissues, and carries out the procedures of loop A on each of the target tissues (steps e1 to e9).

In the loop A, the stained specimen image analyzing unit 547b first creates a change-rate spectral image at each characteristic wavelength, based on the characteristic wavelength of a target tissue to be processed and stained specimen images (spectral images) at wavelengths in the ±1-nanometer range of the characteristic wavelength (step e3). The change-rate spectral image can be created in the same manner as in the first embodiment.

The stained specimen image analyzing unit 547b then combines the change-rate spectral images obtained at the respective characteristic wavelengths, to create a combined change-rate spectral image (step e5). The combined change-rate spectral image can be created in the same manner as in the first embodiment. The stained specimen image analyzing unit 547b then combines the combined change-rate spectral images obtained at the respective characteristic wavelengths, to create an all-wavelength combined change-rate spectral image (step e7).

For example, a case where the two target tissues of “elastin fibril” and “cytoplasm” are designated as described above, and labels L₁ and L₂ are put on the respective target tissues is now explained. Here, the characteristic wavelength determined with respect to the target tissue “elastin fibril” having the label L₁ assigned thereto is represented by Λ1ₙ (n=1, 2, 3, . . . ), and the characteristic wavelength determined with respect to the target tissue “cytoplasm” having the label L₂ assigned thereto represented by Λ2ₙ (n=1, 2, 3, . . . ). Based on the stained specimen image (the spectral image) obtained at the characteristic wavelength Λ1ₙ (n=1, 2, 3, . . . ) of the target tissue “elastin fibril” labeled as L₁ and the stained specimen images (the spectral images) obtained at the characteristic wavelengths Λ1ₙ±1 (n=1, 2, 3, . . . ) in the ±1-nanometer range of the characteristic wavelength, change-rate spectral images are created. Based on the change-rate spectral images, combined change-rate spectral images are created, and an all-wavelength combined change-rate spectral image is obtained. Likewise, based on the stained specimen image (the spectral image) obtained at the characteristic wavelength Λ2ₙ (n=1, 2, 3, . . . ) of the target tissue “cytoplasm” labeled as L₂ and the stained specimen images (the spectral images) obtained at the characteristic wavelengths Λ2ₙ±1 (n=1, 2, 3, . . . ) in the ±1-nanometer range of the characteristic wavelength, change-rate spectral images are created. Based on the change-rate spectral images, combined change-rate spectral images are created, and an all-wavelength combined change-rate spectral image is obtained.

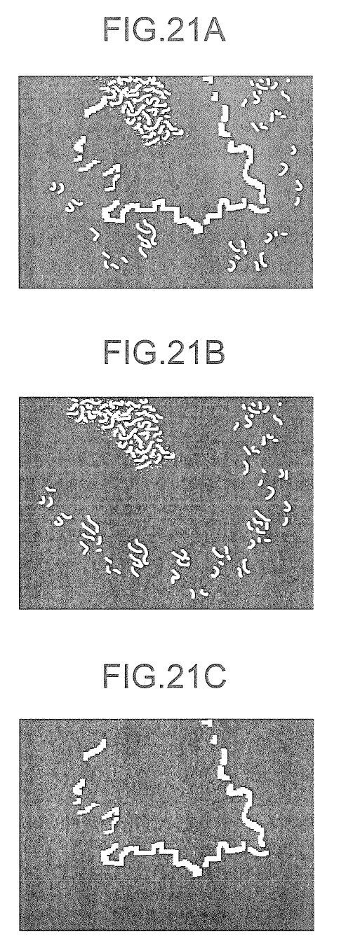

As shown in FIG. 20, the stained specimen image analyzing unit 547b then creates logical-difference spectral images, based on the all-wavelength combined change-rate spectral images obtained for the respective target tissues (step e11). FIGS. 21A to 21C illustrate the procedures for creating logical-difference spectral images. FIG. 21A shows an example of an all-wavelength combined change-rate spectral image obtained with respect to the target tissue “elastin fibril” labeled as L₁. FIG. 21B shows an example of an all-wavelength combined change-rate spectral image obtained with respect to the target tissue “cytoplasm” labeled as L₂. FIG. 21C shows an example of a logical-difference spectral image obtained by combining the all-wavelength combined change-rate spectral image of FIG. 21A and the all-wavelength combined change-rate spectral image of FIG. 21B.

In this example, the stained specimen image analyzing unit 547b forms a logical-difference spectral image from the respective pixels in the all-wavelength combined change-rate spectral image obtained with respect to the target tissue “elastin fibril” labeled as L₁, with the pixel values of pixels equal to or higher than a predetermined threshold value T in the all-wavelength combined change-rate spectral image obtained with respect to the target tissue “cytoplasm” labeled as L₂ being “0 (zero)”, for example. As for the all-wavelength combined change-rate spectral image obtained with respect to the target tissue “cytoplasm” labeled as L₂, a logical-difference spectral image is created in the same manner as above. By creating the logical-difference spectral images, the characteristics shared with the all-wavelength combined change-rate spectral images of the other target tissues are eliminated, and the characteristics of each target tissue can be reproduced with higher precision. Each of the logical-difference spectral images is obtained as an image in which the pixels with high inter-wavelength change rates that do not overlap with the other target tissues are emphasized.

The stained specimen image analyzing unit 547b then extracts the regions of the target tissues from the created logical-difference spectral images of the target tissues (step e13). For example, the stained specimen image analyzing unit 547b arbitrarily performs known image processing in combination, such as smoothing, binarizing, edge extracting, and morphological processing (expanding and contracting), on the logical-difference spectral images in the same manner as in the first embodiment. By doing so, the stained specimen image analyzing unit 547b extracts the regions of the target tissues. After that, the stained specimen image analyzing unit 547b creates stained specimen RGB images in the same manner as in the first embodiment (step e15), and creates virtual special stained images by superimposing the respective target images on the respective stained specimen RGB images (step e17). For example, the virtual special stained image obtained by superimposing the target image about “elastin fibril” on the corresponding stained specimen RGB image is obtained as an image in which the specimen is stained with the special staining dye to stain “elastin fibrils”. Accordingly, the regions of “elastin fibrils” in the stained specimen image can be discriminated with high visibility. As for “cytoplasm”, a virtual special stained image is obtained in the same manner as above, and the region of “cytoplasm” in the stained specimen image can be discriminated with high visibility.

As described above, in accordance with the second embodiment, the same advantages as those of the first embodiment can be achieved, and logical-difference spectral images discriminating the regions of the target tissues from the other regions can be created by extracting the regions showing the respective target tissues from the stained specimen images independently of one another, even if two or more target tissues are designated. By virtue of the logical-difference spectral images, the regions of the respective target tissues can be discriminated from one another and discriminated from the other tissues with high visibility.

Next, a third embodiment is described as an image processing device that captures a multiband image of a stained specimen as a subject that is H/E-stained, and estimates the dye amount at each point in the stained specimen (each sample point), based on the captured multiband image.

In the third embodiment, a subject to be observed is an H/E-stained specimen, as described above. Therefore, the dyes staining a stained specimen are the dye H and the dye E. In an actual stained specimen, however, tissues such as red blood cells that have absorbing components in an unstained state exist as well as the absorbing components of those staining dyes. For example, red blood cells have a peculiar color even in an unstained state, and the color is viewed as the color of the red blood cells after the H/E staining. In the following, the staining dyes are classified into the three kinds: the dye H, the dye E, and the color of the red blood cells (hereinafter referred to as the “dye R”).

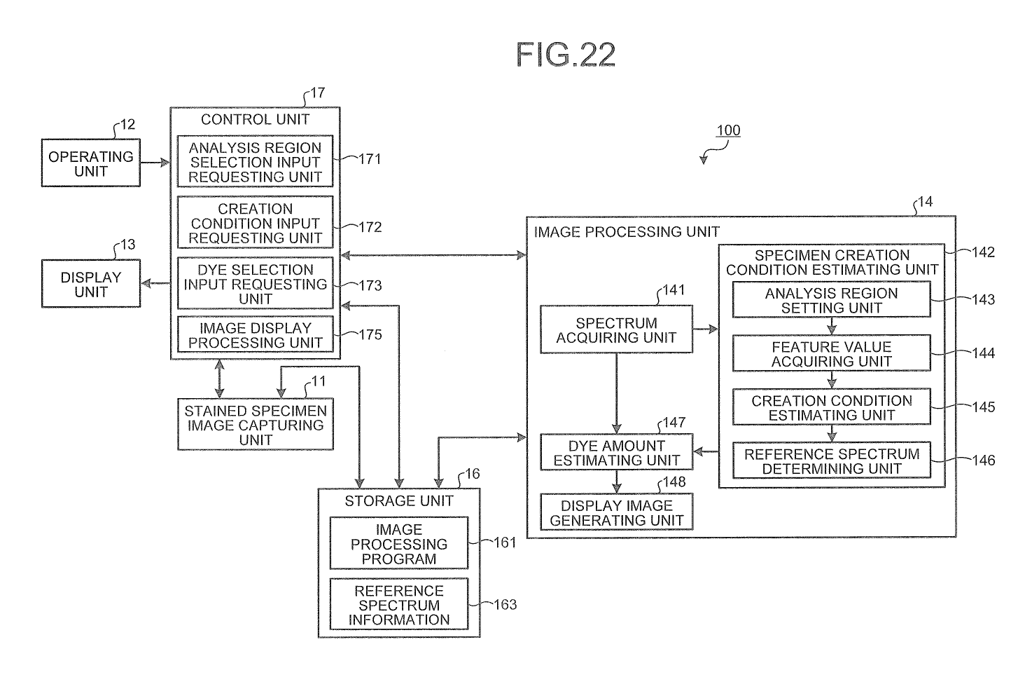

FIG. 22 is a block diagram showing the functional structure of an image processing device 100 in accordance with the third embodiment. The image processing device 100 of the third embodiment includes a stained specimen image capturing unit 11 that captures a stained specimen image, an operating unit 12, a display unit 13, an image processing unit 14, a storage unit 16, and a control unit 17 that controls the respective components of the device. The structure minus the stained specimen image capturing unit 11 can be realized with the use of a general-purpose computer such as a workstation or a personal computer.

The stained specimen image capturing unit 11 is formed with a multiband camera that captures multiband images of each stained specimen to be observed, and has the same structure as the stained specimen image capturing unit 33 of the first embodiment. In the third embodiment, a stained specimen to be observed (hereinafter referred to as the “observation stained specimen”) is the target to be imaged.

The stained specimen image capturing unit 11 is connected to an optical microscope that can transparently observe stained specimens. The optical microscope has the same structure as the stained specimen observing unit 31 of the first embodiment. The stained specimen image capturing unit 11 projects an observed image of a stained specimen to be observed by the optical microscope onto the imaging element of a two-dimensional CCD camera via a tunable filter, and obtains stained specimen images by capturing multiband images. More specifically, a tunable filter that can select bandwidths each having an arbitrary width of 1 nm or greater (hereinafter referred to as a “selected wavelength width”) is used, and observed images of the stained specimen are captured while bandwidths are sequentially selected for each predetermined selected wavelength width. In this manner, stained specimen images are obtained as multiband images.

The pixel values in each stained specimen image obtained by the stained specimen image capturing unit 11 are equivalent to the light intensities in the bandwidth selected by the tunable filter, and the pixel values of the bandwidth selected for the respective sample points in the stained specimen are obtained. The respective samples points in the stained specimen are the points in the stained specimen corresponding to the respective pixels in the projected imaging element. In the following, the respective sample points in the stained specimen correspond to the respective pixel positions in stained specimen images.

The operating unit 12 is realized by a keyboard, a mouse, a touch panel, various switches, and the likes. The operating unit 12 outputs operation signals to the control unit 17 in accordance with operation inputs. The display unit 13 is realized by a display device such as a flat panel display like a LCD or an EL display, or a CRT display, for example. The display unit 13 displays various kinds of screens in accordance with display signals that are supplied from the control unit 17.

The image processing unit 14 includes a spectrum acquiring unit 141 as a spectral property acquiring unit, a specimen creation condition estimating unit 142 as a creation condition acquiring unit, a dye amount estimating unit 147, and a display image generating unit 148.

The spectrum acquiring unit 141 acquires the spectrum at each position of the pixels forming a stained specimen image obtained by the stained specimen image capturing unit 11 capturing a multiband image of an observation stained specimen (hereinafter referred to as an “observation stained specimen image”).

The specimen creation condition estimating unit 142 performs an operation to estimate the conditions for creation of an observation stained specimen. The specimen creation condition estimating unit 142 includes an analysis region setting unit 143, a feature value acquiring unit 144, a creation condition estimating unit 145, and a reference spectrum determining unit 146 as a dye spectral property determining unit.

The analysis region setting unit 143 sets an analysis region in an observation stained specimen image in accordance with a user operation that is input through the operating unit 12 in response to a selection input request issued from an analysis region selection input requesting unit 171. The feature value acquiring unit 144 acquires the feature value of the analysis region that is set by the analysis region setting unit 143. The creation condition estimating unit 145 estimates the conditions for the creation of the observation stained specimen, based on the feature value of the analysis region. Based on the creation conditions estimated by the creation condition estimating unit 145, the reference spectrum determining unit 146 selects one reference spectrum for each of the staining dyes (the dye H, the dye E, and the dye R) from the reference spectrums stored in reference spectrum information 163, and determines an optimum dye spectral property value for each staining dye (the optimum dye spectral property value will be hereinafter referred to as the “optimum reference spectrum”).

Based on the spectrum acquired by the spectrum acquiring unit 141 with respect to each position of the pixels in the observation stained specimen, the dye amount estimating unit 147 estimates the dye amounts in the observation stained specimen, using the optimum reference spectrums of the dye H, the dye E, and the dye R, which are determined by the reference spectrum determining unit 146. The display image generating unit 148 generates an image (a display image) of the observation stained specimen to be displayed.

The storage unit 16 is realized by an IC memory such as a ROM like a rewritable flash memory or a RAM, a hard disk that is built in the device or is connected to the device via a data communication terminal, an information storage medium such as a CD-ROM and a device for reading the information storage medium, or the like. The storage unit 16 temporarily or permanently stores the program for causing the image processing device 100 to operate to realize the various functions of the image processing device 100, and the data and the likes to be used in execution of the program. For example, the storage unit 16 stores an image processing program 161 for estimating the dye amount at each sample position in the observation stained specimen. The storage unit 16 also stores the reference spectrum information 163.

The reference spectrum information 163 stores the data that is obtained beforehand with respect to the reference spectrums of the respective staining dyes (the dye H, the dye E, and the dye R). The reference spectrum information 163 stores combinations of the reference spectrums of the dye H and the dye E in various stained states. The reference spectrums of the staining dyes of the dye H and the dye E in various stained states are acquired from each single stained specimen of the dye H and the dye E under various creation conditions, for example. The creation conditions include the staining time required for staining the observation stained specimen, the thickness of the specimen, and the pH of the medical substance used for the staining, which are the causes of a change in a stained state. Also, the variance σ²_{base} is calculated beforehand with respect to each of the reference spectrums, and is also stored.

The method of acquiring the reference spectrums of the dye H and the dye E is now described. For example, several sets of creation conditions for acquiring combinations of reference spectrums (in the third embodiment, the three combinations among the staining time, the pH of the medical substance used, and the specimen thickness) are defined in advance. For each of the sets of creation conditions, a single stained specimen stained only with the dye H in accordance with the corresponding creation conditions (hereinafter referred to as the “H single stained specimen”) is created, and a single stained specimen stained only with the dye E in accordance with the corresponding creation conditions (hereinafter referred to as the “E single stained specimen”) is created.

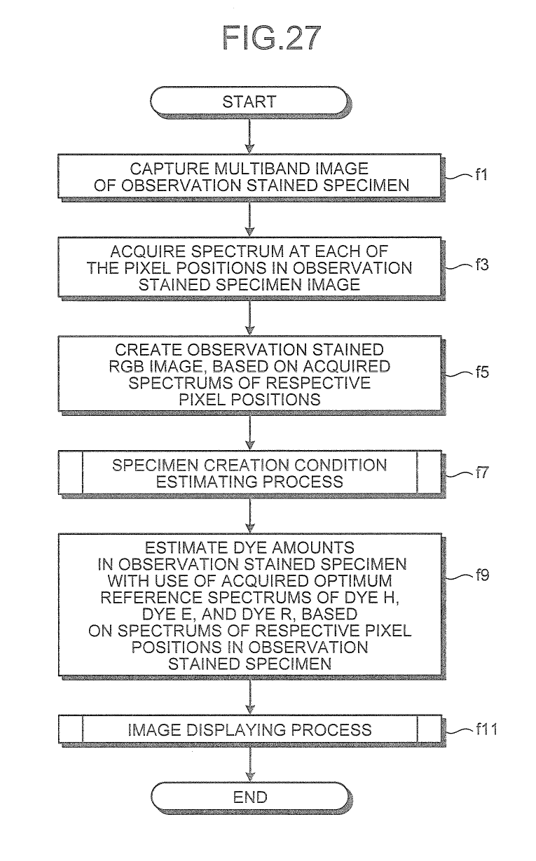

The stained specimen image capturing unit 11 captures a multiband image of the H single stained specimen under each set of the acquired creation conditions, for example. After that, the spectrums of the respective H single stained specimens are sequentially estimated. For example, the spectral transmittance t(x, λ) at each sample point in the H single stained specimens to be processed is calculated based on multiband images of the H single stained specimens, in the same manner as in the later described process to be performed by the spectrum acquiring unit 141 at step f3 of FIG. 27. The spectral transmittance t(x, λ) is then converted into spectral absorbance a(x, λ). The sample points subjected to the sampling may be arbitrary positions in the H single stained specimens to be processed, but the sampling should preferably be performed on the pixels indicating a typical color distribution of the dye H. The average spectral absorbance a(x, λ) at the sample points is calculated, and is set as the reference spectrum of the dye H under the conditions for creation of the processed H single stained specimens. The same procedures are carried out for the dye E, and the reference spectrum under each set of creation conditions is acquired. The respective combinations of the reference spectrums of the dye H and the dye E having the same creation conditions are associated with the respective sets of creation conditions, and are set in the reference spectrum information 163.

The reference spectrum information 163 also stores the reference spectrum of dye R acquired in the following manner, regardless of creation conditions. An unstained specimen is prepared, and a multiband image is captured. Based on the multiband image, the spectral transmittance t(x, λ) at each of the sample points in the unstained specimen is calculated and is converted into the spectral absorbance a(x, λ). The sample points subjected to the sampling are the regions of red blood cells. The average spectral absorbance a(x, λ) at the sample points is then calculated, and is set as the reference spectrum of the dye R.

The method of acquiring the reference spectrums of the respective staining dyes is not limited to the above. For example, the reference spectrums may be acquired by measuring the spectrums of the respective dyes (the dye H, the dye E, and the dye R) in stained states corresponding to the respective sets of creation conditions defined in advance, with the use of a measuring device such as a spectroscope.

The storage unit 16 also stores the creation condition determining parameter distribution (not shown) of the creation condition determining parameters Adj that are used in the process to estimate the creation conditions when the creation condition estimating unit 145 creates an observation stained specimen. The creation condition determining parameters Adj are determined for each combination of the reference spectrums of the dye H and the dye E having the same creation conditions stored beforehand in the reference spectrum information 163, and the creation condition determining parameter distribution is created based on the creation condition determining parameters Adj of each set of the determined creation conditions.

As described later, the analyzed sites are nuclei in the third embodiment. The dye H stains the nuclei among the tissues in each specimen. Therefore, the spectrums of the regions of the nuclei in each stained specimen are characterized mainly by the reference spectrum of the dye H. In this example, the combinations of the reference spectrums of the dye H and the dye E having the same creation conditions are sequentially subjected to a determining process. The shape of the reference spectrum graph showing the combinations of the reference spectrums of the dye H and the dye E to be subjected to the determining process is analyzed to extract the reference spectrum characteristics of the dye H with respect to the dye E (hereinafter referred to as the “H reference characteristics”). After that, based on the extracted H reference characteristics, the creation condition determining parameters Adj with respect to the combination to be subjected to the determining process (or with respect to the creation conditions corresponding to the combination to be subjected to the determining process) are determined.

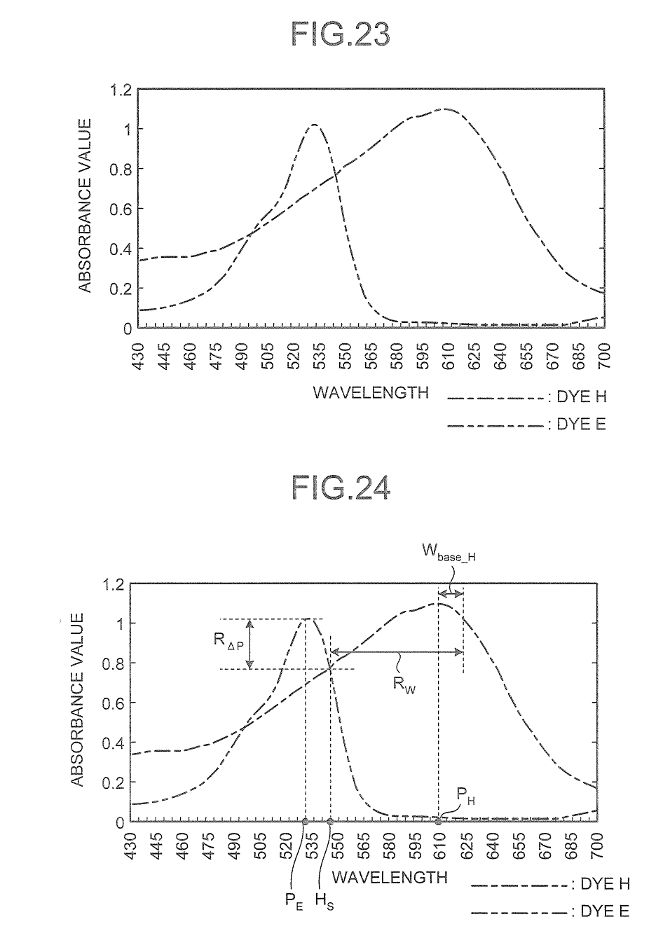

FIG. 23 shows the reference spectrum graphs of the dye H and the dye E as a combination having the same creation conditions. In the reference spectrum graphs, the abscissa axis indicates the wavelength, and the ordinate axis indicates the absorbance value. In this manner, the reference spectrum values at each wavelength are plotted. In FIG. 23, the reference spectrum graph of the dye H is represented by a chain line, and the reference spectrum graph of the dye E is represented by a two-dot chain line.

Referring now to FIG. 24, the method of determining the creation condition determining parameters Adj with respect to the combination of the reference spectrums of the dye H and the dye E shown in FIG. 23 is described. First, as shown in FIG. 24, the peak wavelength P_{E} at which the reference spectrum value of the dye E becomes largest is detected from the reference spectrum graph of the dye E. The wavelength H_{S} at which the reference spectrum graph of the dye H and the reference spectrum graph of the dye E cross each other on the longer wavelength side of the detected peak wavelength P_{E} is acquired. The wavelength H_{S} is acquired by determining an approximate expression of the reference spectrum value of the dye H at each wavelength (hereinafter referred to as the “H spectrum approximate expression”) and an approximate expression of the reference spectrum value of the dye E at each wavelength (hereinafter referred to as the “E spectrum approximate expression”), and determining the intersection point of those approximate expressions with each other in a bandwidth on the longer wavelength side of the peak wavelength P_{E}.

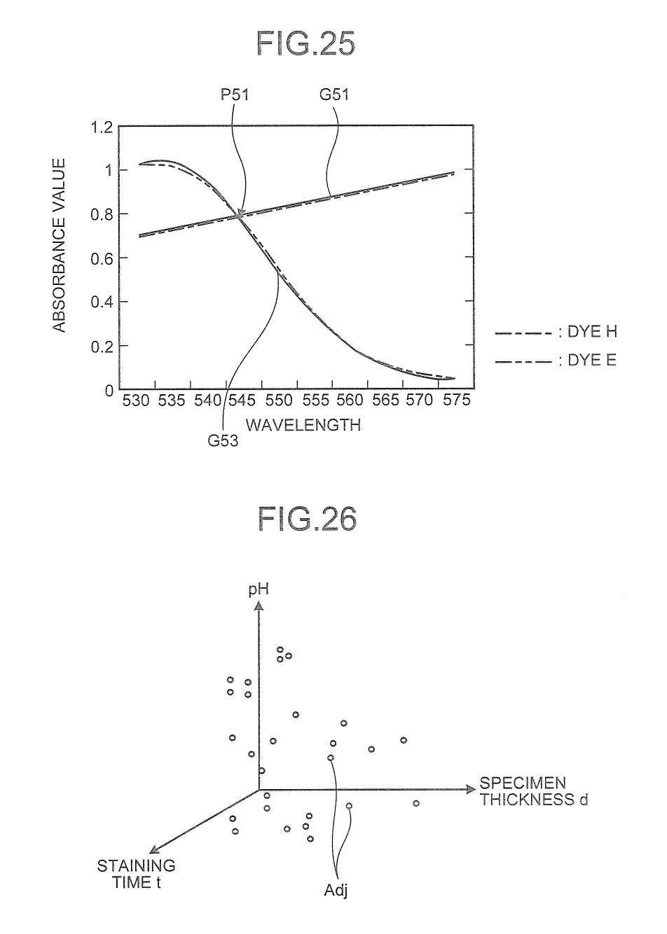

FIG. 25 shows partial reference spectrum graphs of the reference spectrum graphs of the dye H and the dye E to be subjected to the determining process in a predetermined bandwidth on the longer wavelength side of the peak wavelength P_{E}. In FIG. 25, a graph G51 of the H spectrum approximate expression and a graph G53 of the E spectrum approximate expression are also shown. As can be seen from FIG. 25, the intersection point P51 of the graph G51 and the graph G53 on the longer wavelength side of the peak wavelength P_{E} of the reference spectrum of the dye E is calculated. The wavelength of the calculated intersection point P51 is then acquired as the wavelength H_{S} at which the reference spectrum graphs of the dye H and the dye E cross each other, as shown in FIG. 24.

The peak wavelength P_{H} at which the reference spectrum value of the dye H becomes largest on the longer wavelength side of the acquired wavelength H_{S} is then detected, as shown in FIG. 24.

With an error due to the variance σ²_{base}_{_{—}}_{H} of the reference spectrum of the dye H of the combination to be subjected to the determining process being taken into consideration, a predetermined dispersion wavelength width W_{base}_{_{—}}_{H} on the longer wavelength side of the peak wavelength P_{H} is set according to the following equation (12) based on the standard deviation σ_{base}_{_{—}}_{H}. In the following equation (12), └ ┘ represents a floor function.

W_{base}_{_{—}}_{H}=step×└σ_{base}_{_{—}}_{H}/step┘ (12)

Based on the dispersion wavelength width W_{base}_{_{—}}_{H}, and the wavelength H_{S} and the peak wavelength P_{H} acquired and detected as described above, the first H reference characteristics R_{W} are calculated, as shown in FIG. 24. The wavelength interval representing the H reference characteristics R_{W} is expressed by the following equation (13):

R_{W}=(P_{H}+W_{base}_{_{—}}_{H})−H_{S} (13)

Also, the inter-wavelength change (the difference) between the reference spectrum value a(H_{S}) at the wavelength H_{S} and the reference spectrum value a(P_{E}) at the peak wavelength P_{E} is calculated as the second H reference characteristics R_{ΔP}, as shown in FIG. 24. The H reference characteristics R_{ΔP} is expressed by the following equation (14):

RΔP=a(PE)−a(HS) (14)

After that, the creation condition determining parameters Adj with respect to the combination to be subjected to the determining process are calculated with the use of the values of the H reference characteristics R_{W} and R_{ΔP}, according to the following equation (15). In the following equation (15), k is a coefficient that is an arbitrary value.

$${Adj}_{H} = k \frac{{R}_{Δ P}}{{R}_{w}} \qquad ( 15 )$$

The coefficient k may also be defined based on the H spectrum approximate expression and the E spectrum approximate expression obtained to calculate the wavelength H_{S}. For example, the inter-wavelength change rate η between the wavelength H_{S} and the peak wavelength P_{E} is calculated based on those approximate expressions, and k may be defined according to the following equation (16), using the change rate η:

k=1−η (16)

Through the above procedures, the creation condition determining parameters Adj are determined with respect to each combination of the reference spectrums of the dye H and the dye E under the respective sets of creation conditions stored in the reference spectrum information 163. The creation condition determining parameter distribution is then created. FIG. 26 shows an example of the creation condition determining parameter distribution. As shown in FIG. 26, the creation condition determining parameter distribution indicates the distribution of the creation condition determining parameters Adj in a creation condition space, with the axes being the staining time, the specimen thickness, and the hydrogen ion concentration index (pH), which are the creation conditions.

Referring back to FIG. 22, the control unit 17 is realized by hardware such as a CPU. The control unit 17 sends instructions and transfers data to the respective components of the image processing device 100, according to operation signals input from the operating unit 12, image data input from the stained specimen image capturing unit 11, and the program or data stored in the storage unit 16. By doing so, the control unit 17 collectively controls the operations of the entire image processing device 100.

The control unit 17 includes the analysis region selection input requesting unit 171, a creation condition input requesting unit 172, a dye selection input requesting unit 173 as a dye selecting unit, and an image display processing unit 175. The analysis region selection input requesting unit 171 issues a request for an input of a possible region to be analyzed (a possible analysis region). The analysis region selection input requesting unit 171 then selects a possible analysis region in accordance with a user operation that is input through the operating unit 12 by a pathologist or a clinical laboratory technologist, for example. The creation condition input requesting unit 172 issues a request for an input of corrections on the creation conditions estimated by the creation condition estimating unit 145, and receives user operations through the operating unit 12. The dye selection input requesting unit 173 issues a request for an input of a selection of dyes to be displayed, and receives user operations through the operating unit 12. The image display processing unit 175 causes the display unit 13 to display a display image or the like of an observation stained specimen, for example.

FIG. 27 is a flowchart showing the procedures in a process to be performed by the image processing device 100 of the third embodiment. The process described below is realized by the respective components of the image processing device 100 operating in accordance with the image processing program 161 stored in the storage unit 16.

In the third embodiment, the control unit 17 first controls the process of the stained specimen image capturing unit 11, to sequentially capture multiband images of observation stained specimens (step f1), as shown in FIG. 27. The image data about the stained specimen images of the observation stained specimens is stored into the storage unit 16.

The spectrum acquiring unit 141 then acquires the spectrum at each of the pixel positions in the observation stained specimen images (step f3). For example, the spectrum acquiring unit 141 estimates the spectrums at the samples points in each observation stained specimen corresponding to the pixels of the corresponding observation stained specimen image. In this manner, the spectrum acquiring unit 141 acquires the spectrum at each pixel position.

Here, the procedures for estimating spectrums are described in detail. The spectral transmittance t(x, λ) at each sample point in a stained specimen is obtained by dividing the pixel value I(x, λ) of an arbitrary pixel position (x) represented by a position vector x of a stained specimen image as a multiband image by the pixel value I₀(x, λ) of the corresponding pixel position (x) in a multiband image of the background (illuminating light), according to the following equation (1), which has been provided above:

$$t ( x , λ ) = \frac{I ( x , λ )}{{I}_{0} ( x , λ )} \qquad ( 1 )$$

In reality, the wavelength λ is measured only discretely. Therefore, the spectral transmittance t(x, λ) is expressed as an M-dimensional vector, as shown in the following equation (17) where M represents the number of sample points in the wavelength direction. In the equation (17), [ ]^{t} represents a transposed matrix.

t(x,λ)=[t(x,λ₁)t(x,λ₂) . . . t(x,λ_{M})]^{t} (17)

The obtained spectral transmittance t(x, λ) can be converted into the spectral absorbance a(x, λ), according to the following equation (18). Hereinafter, the spectral absorbance will be hereinafter referred to simply as the “absorbance”.

a(x,λ)=−log(t(x,λ)) (18)

In the third embodiment, the spectrum acquiring unit 141 calculates the spectral transmittance t(x, λ) according to the equation (17), and converts the spectral transmittance t(x, λ) into the absorbance a(x, λ) according to the equation (18). The spectrum acquiring unit 141 performs this process for all the pixels in each observation stained specimen image, and acquires the absorbance a(x, λ) as the spectrum at each pixel position (x). The data about the spectrum (the absorbance a(x, λ)) at each pixel position (x) in the obtained observation stained specimen images is stored together with the data about the spectral transmittance t(x, λ) at each pixel position (x) calculated during the acquiring process, into the storage unit 16.

After that, the spectrum acquiring unit 141 creates an observation stained specimen RGB image (hereinafter referred to as an “observation stained RGB image”), based on the spectrums at the respective pixel positions in the obtained observation specimen images (step f5), as shown in FIG. 27. The image data about the created observation stained RGB image is stored into the storage unit 16, and is displayed on the display unit 13 for the user, as needed.

More specifically, the spectrum acquiring unit 141 converts the spectral transmittance calculated during the process to acquire the spectrum at each pixel position in the observation stained specimen image, into a RGB value. The spectrum acquiring unit 141 then creates the observation stained RGB image. Where the spectral transmittance at an arbitrary pixel position (x) in the observation stained specimen image is represented by T(x), the RGB value G_{RGB}(x) is expressed by the above equations (10) and (11).

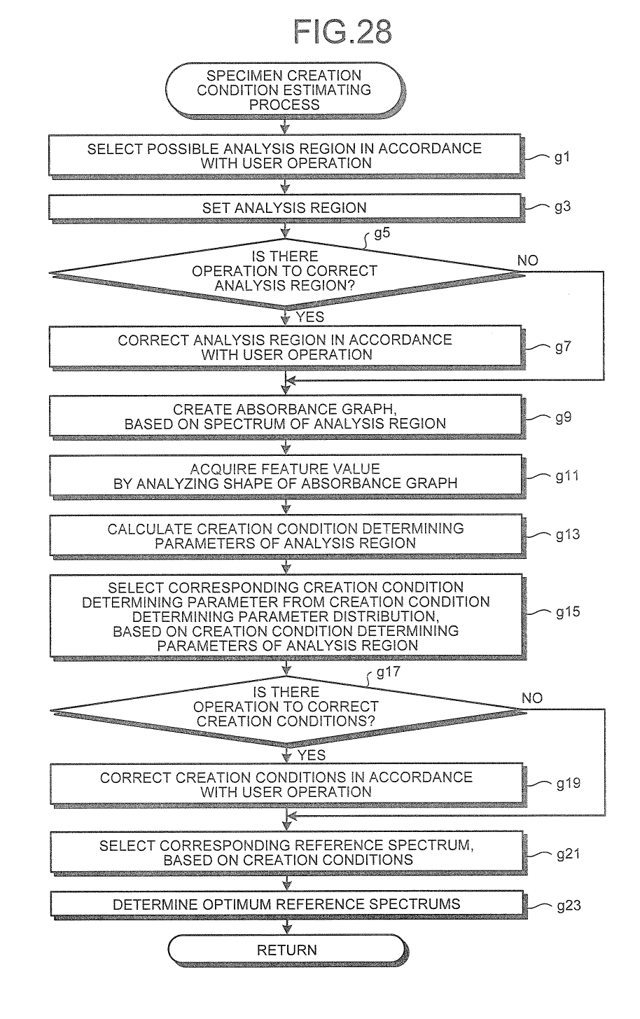

As shown in FIG. 27, the process then moves on to a specimen creation condition estimating process (step f7). FIG. 28 is a flowchart showing the specific procedures in the specimen creation condition estimating process.

As shown in FIG. 28, in the specimen creation condition estimating process, the analysis region selection input requesting unit 171 first receives an operation to select a possible analysis region from the user, and selects a possible analysis region (step g1). For example, the analysis region selection input requesting unit 171 causes the display unit 13 to display an analysis region selecting screen, and issues a request for an input of a possible analysis region selection to the user. The analysis region selection input requesting unit 171 then notifies the analysis region setting unit 143 of the selection information about the possible analysis region that is input by the user in response to the selection input request.

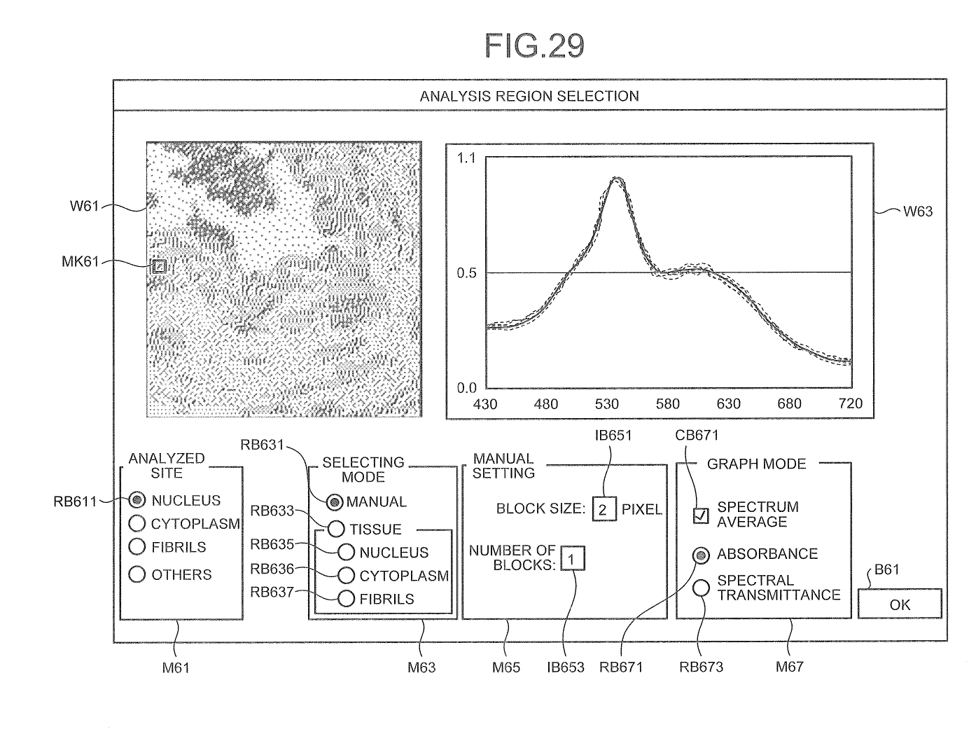

FIG. 29 shows an example of the analysis region selecting screen. As shown in FIG. 29, the analysis region selecting screen includes an observation stained image display portion W61. The observation stained image display portion W61 displays the observation stained RGB image created at step f5 of FIG. 27. The analysis region selecting screen also includes an analysis site menu M61, a selection mode menu M63, a manual setting menu M65, and a graph mode menu M67. Further, an OK button B61 for entering an operation is provided on the analysis region selecting screen.

The analysis site menu M61 is designed to designate a site (a tissue) to be shown in the region selected as a possible analysis region. In the analysis site menu M61, radio buttons are arranged, so that one of “nucleus”, “cytoplasm”, “fibrils”, and “others” can be selected.

In the selection mode menu M63, radio buttons RB631 and RB633 are arranged, so that either “manual” or “tissue” can be selected as a selection mode for a possible analysis region. Here, “manual” represents a selection mode in which a possible analysis region is manually selected in accordance with a user operation. For example, a seized region designated by the user on the observation stained image display portion W61 is selected as a possible analysis region. The “tissue” mode is a selection mode in which the region of the tissue designated by the user is identified through image processing, and is then selected as a possible analysis region. In the example illustrated in FIG. 29, one of the tissues, “nucleus”, “cytoplasm”, and “fibrils”, can be designated through radio buttons RB635 to RB637.

In the manual setting menu M65, settings related to the “manual” mode as one of the selection modes are performed. For example, an input box IB651 for inputting a block size and an input box IB653 for inputting the number of blocks are arranged in the manual setting menu M65. A desired value can be set in each of the input boxes. The block size is the size of the seized region designated on the observation stained image display portion W61. In a case where “2” is input to the input box IB651, for example, the size of each one seized region is 2×2 pixels, as shown in FIG. 29. It is possible to designate two or more seized regions, and the number of seized regions is equivalent to the number of blocks. The user inputs a desired block number (“1” in FIG. 29) to the input box IB653.

In a case where the selection mode is the “manual” mode, a seized region is designated on the observation stained image display portion W61, and graphs of the spectrums acquired with respect to the corresponding pixel positions are displayed on a graph display portion W63. In the graph mode menu M67, settings related to the graph display on the graph display portion W63 are performed. For example, a check box CB671 for causing the graph display portion W63 to display an average spectrum graph about the seized region designated on the observation stained image display portion W61 is provided in the graph mode menu M67. In a case where the check box CB671 is not ticked, the spectrum graph about each position of the pixels in the seized region is displayed. For example, in a case where the input value of the input box IB651 in the manual setting menu M65 is “2”, the seized region is formed with four pixels, and spectrum graphs showing the spectrums acquired at the respective wavelengths with respect to the four pixel positions are displayed. In a case where the check box CB671 is ticked, on the other hand, an average spectrum graph showing the average value of the spectrums at each wavelength is displayed as well as the spectrum graphs about the positions of the pixels in the seized region. For example, the graph display portion W63 shown in FIG. 29 displays the spectrum graphs of the respective pixel positions indicated by dotted lines, and the average spectrum graph indicated by a solid line.

Radio buttons RB671 and RB673 are also provided in the graph mode menu M67, so that absorbance graph or spectral transmittance graph can be selected as the type of spectrum graph to be displayed on the graph display portion W63. When the absorbance is selected through the radio button RB671, the graph of the absorbance as the spectrums acquired about the respective pixel positions in the seized region is displayed. When the spectral transmittance is selected through the radio button RB673, on the other hand, the graph of the spectral transmittance calculated during the process to acquire the absorbance is displayed.

For example, in the procedures to be carried out when the “manual” mode is selected as the selection mode to select a possible analysis region, the user first clicks a desired position on the observation stained image display portion W61, using the mouse of the operating unit 12. In this manner, the user designates a seized region. At this point, a marker MK61 indicating the seized region is displayed at the designated (or clicked) position on the observation stained image display portion W61. The graph display portion W63 also displays the graph of the spectrum at each pixel position in the seized region. The designated seized region can be moved by dragging and dropping the marker MK61 on the observation stained image display portion W61. With this arrangement, the user can designate a seized region while checking the spectrums on the graph display portion W63. In a case where a value of “2” or greater is input as the number of blocks, a new seized region can be designated by clicking a position on the observation stained image display portion W61. To enter an operation, the OK button B61 is clicked.

When an operation is entered in the above manner, the analysis region selection input requesting unit 171 selects the designated seized region (the pixel position of the marker MK61 on the observation stained image display portion W61) as a possible analysis region in the procedure of step g1. At this point, the analysis region selection input requesting unit 171 notifies the analysis region setting unit 143 of the image processing unit 14 of the selection information about the possible reference region. Here, the selection information about the possible analysis region contains the pixel positions of the possible analysis region.

In a case where the “tissue” mode is selected as the selection mode in the selection mode menu M63 on the analysis region selecting screen shown in FIG. 29, the pixel position showing the tissue designated by the user selecting one of the radio buttons RB635 to RB637 is extracted with the use of teacher data, and a possible analysis region is selected. The teacher data is created by measuring the typical spectral property patterns and color information about the respective tissues in advance. Image processing is then performed on the observation stained specimen image or the observation stained RGB image, so that the user can extract the region of the designated tissue.

After a possible analysis region is selected, the analysis region setting unit 143 sets an analysis region (step g3), as shown in FIG. 28. For example, based on the selection information about the possible analysis region notified from the analysis region selection input requesting unit 171, the analysis region setting unit 143 searches for the pixels having similar pixel values to the possible analysis region in the observation stained RGB image, and sets an analysis region.

In the specific procedures, the analysis region setting unit 143 first maps the pixel values of the observation stained RGB image in a RB color space. If the possible analysis region is formed with two or more pixel positions, the average value of the mapped points of the respective pixels forming the possible analysis region (the average value of the coordinate values of the pixels of the possible analysis region in the RB color space), and sets the average value as the representative point of the possible analysis region.

The analysis region setting unit 143 then calculates the distance Dist between the mapped point of the possible analysis region (or the representative point of the possible analysis region) and the mapped point of a pixel to be processed, with the pixels outside the possible analysis region being the subjects to be sequentially processed. The distance Dist obtained here is set as the similarity with respect to the pixel as the subject to be processed. Where the mapped point (the coordinate values in the RG color space) of the possible analysis region (or the representative point of the possible analysis region) is represented by S(R, B), and the mapped point of a subject pixel (xᵢ, yᵢ) (i=1, 2, . . . , n) is represented by s(rᵢ, bᵢ), the distance Dist between s(rᵢ, bᵢ) and S(R, B) is expressed by the following equation (19). In the equation (19), n represents the number of pixels outside the possible analysis region to be processed.

Dist=\sqrt{(R−rᵢ)²+(B−bᵢ)²} (19)

The analysis region setting unit 143 then performs threshold processing on the similarity of each of the pixels outside the possible analysis region, and extracts the pixels having high similarity (or pixels having similarity levels equal to or higher than a predetermined threshold value). The analysis region setting unit 143 sets an analysis region that is a region formed with the extracted pixels and the pixels of the possible analysis region. The threshold value STh used in the threshold processing is set based on the pixel values in the possible analysis region in the observation stained RGB image. For example, in a case where the possible analysis region is formed with two or more pixel positions, the variance V(S) of the mapped point of each pixel (the coordinate values in the RB color space) is determined, and the threshold value STh is set according to the following equation (20). In the equation (20), k is a coefficient that can be arbitrarily set.

STh=S(R,B)+k\sqrt{V(S)} (20)

The method of calculating similarity is not limited to the above method, and may be arbitrarily selected and used. For example, the similarity in luminance value, the similarity in color distribution, or the similarity in spectrum may be calculated. Here, only one of those similarities may be calculated, or a collective similarity may be calculated by combining those similarities.

The analysis region that is set in the above manner is displayed on the display unit 13 and is shown to the user for confirmation. For example, the analysis region selection input requesting unit 171 causes the display unit 13 to display an analysis region confirming screen. At this point, the analysis region selection input requesting unit 171 also notifies the user of a request for an input of a correction on the analysis region.

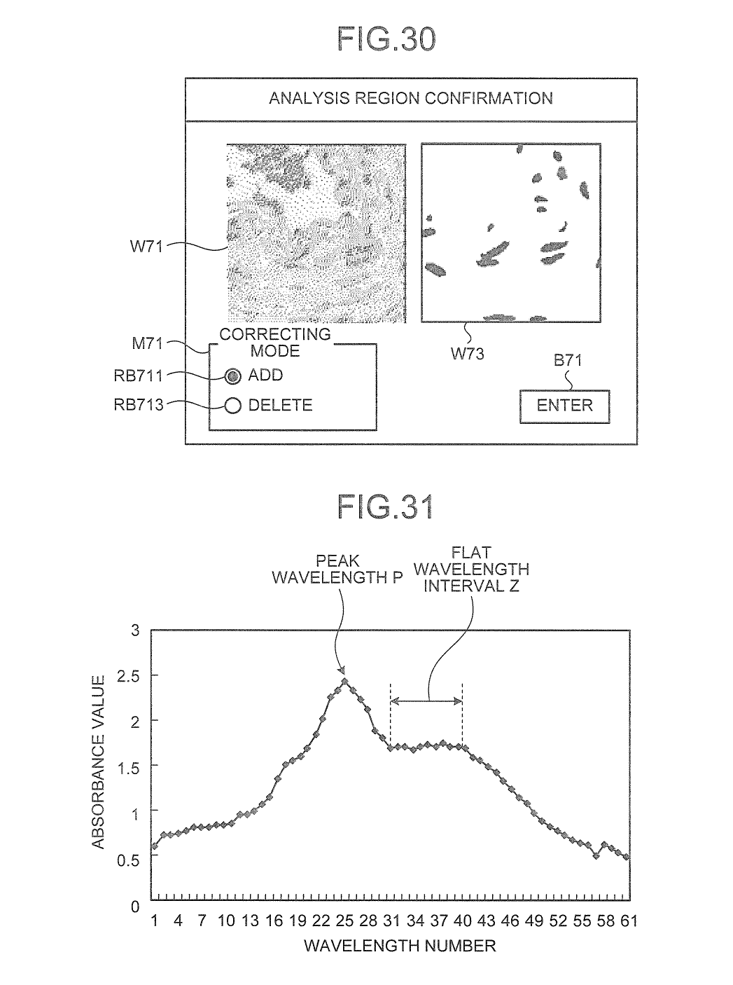

FIG. 30 shows an example of the analysis region confirming screen. As shown in FIG. 30, the analysis region confirming screen includes an observation stained image display portion W71 and an analysis region display portion W73. An observation stained RGB image is displayed on the observation stained image display portion W71. An analysis region identifying image that identifies the analysis region in the observation stained RGB image is displayed on the analysis region display portion W73. For example, the values of the pixels outside the analysis region are replaced with a predetermined color (such as white), so that an image not showing the pixels outside the analysis region is displayed.

This analysis region confirming screen includes a correction mode menu M71, so that corrections can be made when the set analysis region is too large or too small and is determined to be insufficient. Radio buttons RB711 and RB713 are arranged in the correction mode menu M71, so that either “add” or “delete” can be selected as a correction mode for the analysis region. Further, an enter button B71 for entering an operation is provided on the analysis region confirming screen.

When the user determines that there is a portion missing from the analysis region, based on the analysis region identifying image displayed on the analysis region display portion W73, the user selects the radio button RB711, and clicks the position of the pixel (an additional pixel) to be added to the analysis region on the observation stained image display portion W71. When the user determines that the analysis region is too large, based on the analysis region identifying image displayed on the analysis region display portion W73, the user selects the radio button RB713, and clicks the position of the pixel (an unnecessary pixel) to be removed from the analysis region on the observation stained image display portion W71. To enter an operation, the user clicks the enter button B71.

After a correction is input in response to the request for an input of a correction on the analysis region as described above (“Yes” at step g5 of FIG. 28), the analysis region selection input requesting unit 171 notifies the analysis region setting unit 143 of correction information. The correction information contains the information about the position of a pixel designated as an additional pixel, the position of a pixel designated as an unnecessary pixel, or the like. The analysis region setting unit 143 corrects the analysis region in accordance with the correction information (step g7).

In a case where the correction information contains information about an additional pixel, for example, the analysis region setting unit 143 extracts pixels that are similar to the additional pixel and are linked to the additional pixel, based on the pixel values of the observation stained RGB image. Threshold processing is sequentially performed on the luminance values of the pixels, starting from the pixel adjacent to the additional pixel. The threshold value is set based on the luminance value of the additional pixel, for example. The pixels that are similar in luminance value to the additional pixel and are linked to the additional pixel are extracted. The analysis region setting unit 143 adds the extracted pixels to the analysis region. If the correction information contains information about an unnecessary pixel, the analysis region setting unit 143 extracts pixels that are similar to the unnecessary pixel and are linked to the unnecessary pixel, based on the pixel values of the observation stained RGB image. Threshold processing is sequentially performed on the luminance values of the pixels, starting from the pixel adjacent to the unnecessary pixel, for example. The threshold value is set based on the luminance value of the unnecessary pixel. The pixels that are similar in luminance value to the unnecessary pixel and are linked to the unnecessary pixel are extracted. The analysis region setting unit 143 removes the extracted pixels from the analysis region.

At last, the analysis region setting unit 143 puts an analysis region label according to the analysis site on the pixel position of each pixel in the analysis region that is set and corrected in the above described manner. In a case where the site designated in the analysis site menu M61 shown in FIG. 29 is “nucleus”, an analysis region label Obj_N is put on the pixel positions of the analysis region. Likewise, if the designated site is “cytoplasm”, an analysis region label Obj_C is provided. If the designated site is “fibrils”, an analysis region label Obj_F is provided. If the designated site is “others”, an analysis region label Obj_O is provided.

Here, the analysis region should preferably be a region of a major tissue such as a nucleus, cytoplasm, or fibrils included in an observation stained specimen. In other words, the seized region designated by the user through the analysis region selecting screen shown in FIG. 29 should preferably be a region of one of those major tissues. In the following, the third embodiment is described as an example case where the user designates a seized region that is a region showing a nucleus on the observation stained image display portion W61 of FIG. 29, and the user designates “nucleus” through the radio button RB611 in the analysis site menu M61.

The feature value acquiring unit 144 then acquires the feature value about the set analysis region (the pixel positions labeled with an analysis region label in the observation stained specimen image). For example, the feature value acquiring unit 144 creates a graph of the spectrum (the absorbance) at each wavelength obtained by the spectrum acquiring unit 141 with respect to each of the pixels forming the analysis region, and analyzes the shape of the absorbance graph, to acquire the feature value.

As shown in FIG. 28, the feature value acquiring unit 144 first creates an absorbance graph, based on the spectrums acquired with respect to the pixels in the analysis region (step g9). Here, each pixel in the analysis region is represented by i (i=1, 2, 3, . . . , n), and the number of spectral wavelengths is represented by D. Where the spectrum at λ_{d} of each pixel i is represented by aᵢ(λ_{d}) (d=1, 2, 3, . . . , D), the absorbance vector A(λ) is expressed by the following equation (21):

$$A ( λ ) = [ \begin{matrix}{a}_{1} ( {λ}_{1} ) \\ {a}_{2} ( {λ}_{1} ) \\ ⋮ \\ {a}_{n} ( {λ}_{1} )\end{matrix} \begin{matrix}{a}_{1} ( {λ}_{2} ) \\ {a}_{2} ( {λ}_{2} ) \\ \\ {a}_{n} ( {λ}_{2} )\end{matrix} \begin{matrix} \\ \\ ⋱ \\ \end{matrix} \begin{matrix}⋯ {a}_{1} ( {λ}_{D} ) \\ … {a}_{2} ( {λ}_{D} ) \\ ⋮ \\ ⋯ {a}_{n} ( {λ}_{D} )\end{matrix} ] \qquad ( 21 )$$

The average absorbance vector Ā(λ) is expressed by the following equation (22), provided

$$\overline{A} ( λ ) = ⌊ \begin{matrix}\overline{a} ( {λ}_{1} ) & \overline{a} ( {λ}_{2} )\end{matrix} \begin{matrix}⋯ & \overline{a} ( {λ}_{D} )\end{matrix} ⌋ \\ where \overline{a} ( {λ}_{d} ) = \frac{1}{n} {\sum }_{i = 1}^{i = n} {a}_{i} ( {λ}_{d} ) \cdot \qquad ( 22 )$$

At step g9 of FIG. 28, the feature value acquiring unit 144 turns the average absorbance vector Ā(λ) into a graph, and creates an absorbance graph. At this point, the feature value acquiring unit 144 also calculates the variance σ²_{Obj}_{_{—}}_{N}. FIG. 31 shows an example of the absorbance graph. As shown in FIG. 31, the feature value acquiring unit 144 plots the calculated value of the average absorbance vector Ā(λ) at each wavelength, with the abscissa axis indicating the wavelength (the wavelength number), the ordinate axis indicating the absorbance value. In this manner, the feature value acquiring unit 144 creates the absorbance graph.

Referring back to FIG. 28, the feature value acquiring unit 144 analyzes the shape of the absorbance graph, to acquire the feature value (step g11). As described above, the nucleus stained with the dye H is the analyzed site in the third embodiment, and the spectrum of the region of the nucleus is characterized mainly by the reference spectrum of the dye H. More specifically, the spectrum of the analysis region characteristically has the absorbance value reducing on the longer wavelength side, due to the influence of the reference spectrum of the dye H (as illustrated in FIG. 31, for example). The amount of the reduction in the absorbance value can be assumed to be correlated with the stained state of the observation stained specimen.

Therefore, based on the absorbance graph created from the spectrum of the analysis region, the feature value acquiring unit 144 of the third embodiment calculates one piece of the feature value that is a wavelength interval Z in which the inter-wavelength absorbance change is small, and the absorbance graph is flat in a long bandwidth, as shown in FIG. 31. The wavelength interval Z will be hereinafter referred to as the “flat wavelength interval Z”. In addition to the flat wavelength interval Z, the feature value acquiring unit 144 calculates a peak change rate ΔP as another set of feature value. The feature value acquiring unit 144 sets the peak change rate ΔP as the difference between the absorbance value at the peak wavelength P and the average value of the absorbance values in the flat wavelength interval Z, for example.

In the specific procedures for calculating the flat wavelength interval Z, the wavelength at which the absorbance value becomes largest is detected as the peak wavelength P from the absorbance graph. Alternatively, the bandwidth in which the peak wavelength P appears may be learned beforehand for each of the tissues set as analyzed sites such as nucleus, cytoplasm, and fibrils. In this case, the peak wavelength P is detected by referring to the absorbance value in the bandwidth learned beforehand with respect to the designated analysis site. With this arrangement, there is no need to search the entire absorbance graph for the peak wavelength P.

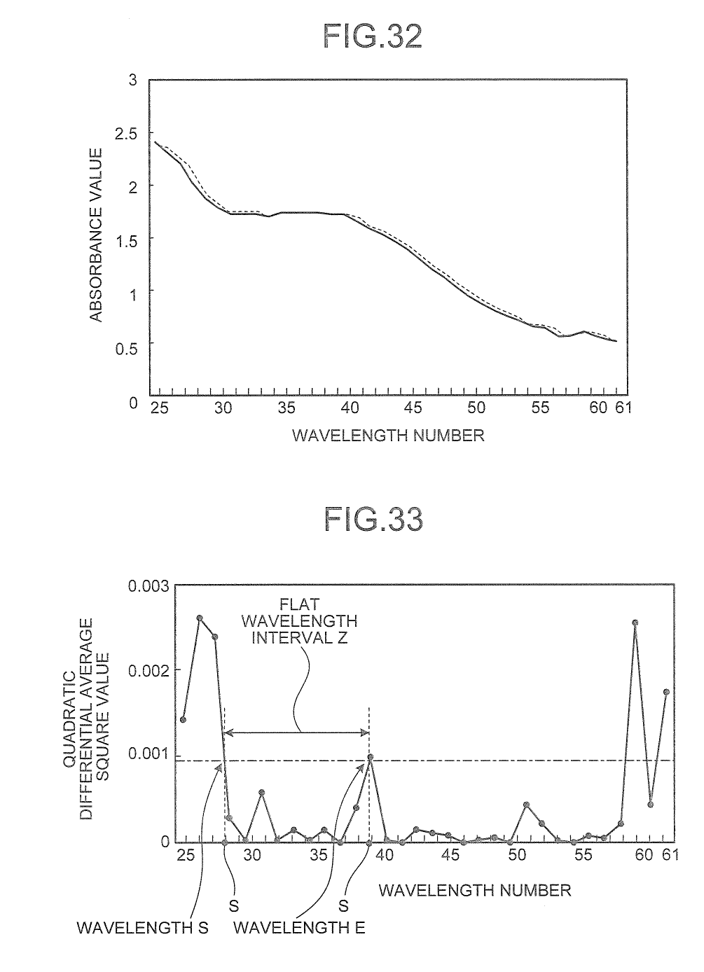

The average value of the absorbance values at two successive wavelengths in the bandwidth between the detected peak wavelength P and the maximum wavelength D (the P-D bandwidth) is calculated to create an average graph. FIG. 32 shows an example of the average graph created from the absorbance graph shown in FIG. 31. FIG. 32 also shows the absorption graph in the P-D bandwidth indicated by a dotted line, as well as the average graph indicated by a solid line.

To emphasize the wavelength change, the quadratic differential L(i) of the absorbance is calculated according to the following equation (23), and the inter-wavelength average L̅(i) of the quadratic differential L(i) (hereinafter referred to as the “quadratic differential average”) is calculated according to the following equation (24):

L(i)=(a(i+2)−a(i+1)−(a(i+1)−a(i))) (i=P, P+2, P+3 . . . D) (23)

L̅(i)=L(i)+L(i+1)/2 (i=P, P+2, P+3 . . . D) (24)

Further, to eliminate the influence in the changing direction, the square of the quadratic differential average L̅(i) is calculated. Here, the average absorbance vector Ā(λ) contains an error due to its variance σ²_{Obj}_{_{—}}_{N}. Therefore, with the error being taken into consideration, the subject wavelength to be the subject when the flat wavelength interval Z is calculated is restricted. For example, based on the standard deviation σ_{Obj}_{_{—}}_{N} of the variance σ²_{Obj}_{_{—}}_{N} calculated with respect to the average absorbance vector Ā(λ), the dispersion wavelength width W_{Obj}_{_{—}}_{N} is calculated according to the following equation (25). In the equation (25), “step” represents the wavelength interval in the observation stained specimen image (the selected wavelength width of the tunable filter used to capture the observation stained specimen image by the stained specimen image capturing unit 11).

W_{Obj}_{_{—}}_{N}=step×└σ_{Obj}_{_{—}}_{N}/step┘ (25)

The wavelength P+W_{Obj}_{_{—}}_{N} obtained by taking into account the dispersion wavelength width W_{Obj}_{_{—}}_{N} calculated with respect to the peak wavelength P is set as the subject wavelength, and the square L̅(i)² (i=P+W_{Obj}_{_{—}}_{N}, P+W_{Obj}_{_{—}}_{N}+2, P+W_{Obj}_{_{—}}_{N}+3, . . . , P+W_{Obj}_{_{—}}_{N}+D) of the quadratic differential average L̅(i) is calculated.

FIG. 33 shows a quadratic differential square graph showing the quadratic differential average square L̅(i)². Based on the quadratic differential square graph, the feature value acquiring unit 144 detects the wavelength S that first becomes equal to or lower than a predetermined threshold value. The feature value acquiring unit 144 also detects the wavelength E that becomes equal to or lower than the predetermined threshold value immediately after the wavelength S. For example, the feature value acquiring unit 144 detects the wavelength S and the wavelength E, using the threshold value indicated by a dot-and-dash line in FIG. 33. Based on the detected wavelengths S and E, the wavelength interval between the wavelength S and the wavelength E-1 is set as the flat wavelength interval Z.

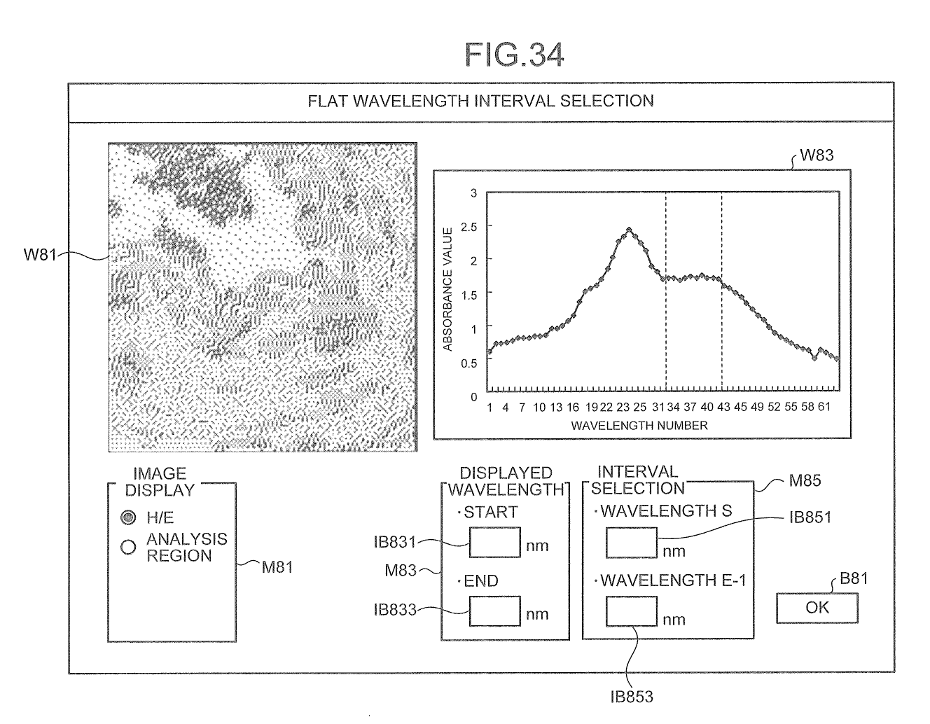

The method of calculating the flat wavelength interval Z is not limited to the above. For example, the flat wavelength interval Z may be selected in accordance with a user operation. FIG. 34 shows an example of a flat wavelength interval selecting screen. As shown in FIG. 34, the flat wavelength interval selecting screen includes an image display portion W81 that displays the observation stained RGB image or the analysis region image. One of the two kinds of images can be selected through an image display menu M81. When “HE” is selected in the image display menu M81, the observation stained RGB image is displayed on the image display portion W81. When “analysis region” is selected, on the other hand, the analysis region image discriminably showing the analysis region in the observation stained RGB image is displayed on the image display portion W81. For example, the values of the pixels outside the analysis region are replaced with a predetermined color (such as white), so that an image not showing the pixels outside the analysis region is displayed.

The flat wavelength interval selecting screen also includes a graph display portion W83, and displays the absorbance graph created at step g9 of FIG. 28. The wavelengths of the absorbance graph to be displayed on the graph display portion W83 can be arbitrarily selected through a displayed wavelength menu M83. For example, the user inputs a value on the shorter wavelength side of the wavelength range to be displayed into an input box IB831 in the displayed wavelength menu M83, and inputs a value on the longer wavelength side into an input box IB833. Instead of the absorbance graph, the average graph (see FIG. 32) created from the absorbance graph may be displayed on the graph display portion W83.

The user then inputs the desired wavelength S into an input box IB851 in an interval selection menu M85, and inputs the desired wavelength E-1 into an input box IB853, while looking at the absorbance graph displayed on the graph display portion W83. In this manner, the wavelength interval between the wavelength S input to the input box IB851 and the wavelength E-1 input to the input box IB853 is selected as the flat wavelength interval Z. Since the values are input to the input boxes IB851 and IB853 as described above, the currently selected flat wavelength interval Z is indicated by dotted lines on the graph display portion W83, as shown in FIG. 34. Accordingly, the currently selected flat wavelength interval Z is discriminated in the absorbance graph.

In the specific procedures for calculating the peak change rate ΔP, the absorbance value average ā_{flat} in the flat wavelength interval Z is calculated. The absorbance value average ā_{flat} is expressed by the following equation (26), with the absorbance value at each wavelength in the flat wavelength interval Z being a(λᵢ) (i=S, S+1, . . . , E). In the equation (26), “step” represents the wavelength interval in the observation stained specimen image.

$${\overline{a}}_{flat} = \frac{1}{( E - S \text{)/step}} {\sum }_{i = S}^{E} a ( {λ}_{i} ) \qquad ( 26 )$$

Based on the calculated absorbance value average ā_{flat} in the flat wavelength interval Z, the peak change rate ΔP is calculated according to the following equation (27). In the equation (27), a(P) represents the absorbance value at the peak wavelength P.

ΔP=a(P)−ā_{flat} (27)

The feature value about the flat wavelength interval Z and the peak change rate ΔP calculated by the feature value acquiring unit 144 in the above manner are stored into the storage unit 16.

After the flat wavelength interval Z and the peak change rate ΔP are calculated as the feature value about the analysis region, the creation condition estimating unit 145 estimates the conditions for creation of the observation stained specimen, based on the flat wavelength interval Z and the peak change rate ΔP. In the third embodiment, the staining time required for staining the observation stained specimen, the pH of the medical substance used for the staining, and the specimen thickness are estimated as the creation conditions. Here, the creation conditions are estimated with the use of the creation condition determining parameter distribution of the creation condition determining parameters Adj that are determined beforehand and stored in the storage unit 16 as described above.

In the third embodiment, the analyzed site is a nucleus, and the spectrum of the region of the nucleus is characterized by the reference spectrum of the dye H, as described above. Therefore, the flat wavelength interval Z and the peak change rate ΔP acquired as the feature value by the feature value acquiring unit 144 are assumed to be correlated with the H reference characteristics R_{W} and R_{ΔP} depending on the stained state of the observation stained specimen. As described above, the creation condition determining parameters Adj determined beforehand are obtained by dividing the H reference characteristics R_{ΔP} by the H reference characteristics R_{W}, as indicated by the equation (20). Therefore, as shown in FIG. 28, the creation condition estimating unit 145 as the creation condition parameter calculating unit first calculates the creation condition determining parameter Adj_{A} of the analysis region according to the following equation (28) (step g13).

$${Adj}_{A} = \frac{Δ P}{Z} \qquad ( 28 )$$

The creation condition estimating unit 145 then estimates the conditions for creating the observation stained specimen by selecting the creation condition determining parameter Adj matching the calculated creation condition determining parameter Adj_{A} of the analysis region from the creation condition determining parameter distribution (step g15). If there is a creation condition determining parameter Adj that matches the creation condition determining parameter Adj_{A} of the analysis region, the creation condition determining parameter Adj is selected, and its creation conditions are estimated as the conditions for creating the observation stained specimen. If there is not a matching creation condition determining parameter Adj, a creation condition determining parameter Adj having a similar value to the creation condition determining parameter Adj_{A} of the analysis region is selected, and its creation conditions are estimated as the conditions for creating the observation stained specimen. More specifically, the creation condition determining parameter Adj having the smallest absolute difference value with respect to the creation condition determining parameter Adj_{A} of the analysis region is selected as the similar creation condition determining parameter Adj. There might be a case where two or more creation condition determining parameters Adj have the smallest absolute difference value. In such a case, the conditions for creation of the observation stained specimen are estimated based on the two or more creation condition determining parameters Adj (two or more sets of conditions for creating the observation stained specimen are estimated).

At the above described step g15, the creation condition determining parameter Adj having the smallest absolute difference value with respect to the creation condition determining parameter Adj_{A} of the analysis region is selected as the similar creation condition determining parameter Adj. Alternatively, threshold processing using a predetermined threshold value may be performed on the absolute difference values, and a creation condition determining parameters Adj having an absolute difference value smaller than the threshold value may be selected as the similar creation condition determining parameter Adj. If two or more creation condition determining parameters Adj are selected here, two or more sets of conditions for creating the observation stained specimen may be estimated based on each of the selected creation condition determining parameters Adj.

Since the creation condition determining parameters Adj of the same value might be set for different sets of creation conditions, there might be a case where two or more creation condition determining parameters Adj match the creation condition determining parameter Adj_{A} of the analysis region. In such a case, two or more sets of conditions for creating the observation stained specimen are estimated based on the two or more creation condition determining parameters Adj.

The conditions for creation of the observation stained specimen estimated in the above manner are displayed on the display unit 13 and is shown to the user for confirmation. For example, the creation condition input requesting unit 172 causes the display unit 13 to display a creation condition correcting screen. At this point, the creation condition input requesting unit 172 also notifies the user of a request for an input of a correction on the creation conditions.

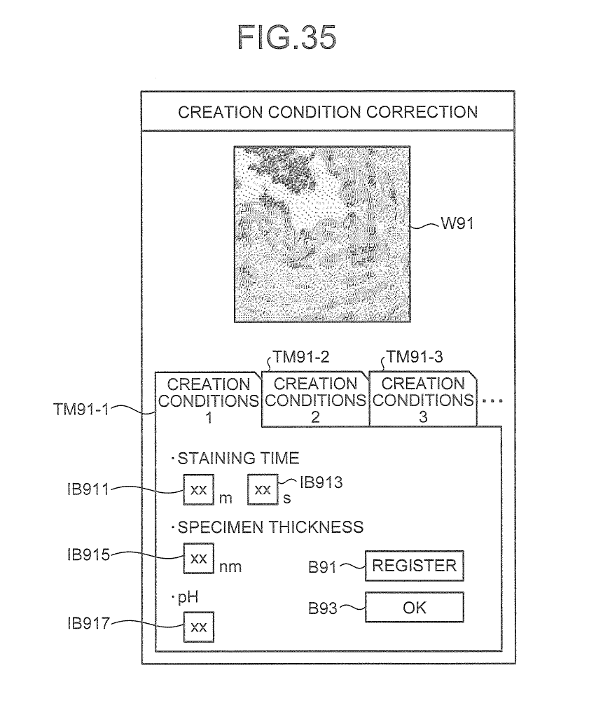

FIG. 35 shows an example of the creation condition correcting screen. As shown in FIG. 35, the creation condition correcting screen includes an observation stained image display portion W91. This observation stained image display portion W91 displays an observation stained RGB image. The creation condition correcting screen also includes creation condition display tabs TM91 (TM91-1, TM91-2, TM91-3, . . . ). When two or more creation condition determining parameters Adj are selected at step g15, and two or more sets of conditions for the creation of the observation stained specimen are estimated, each set of creation conditions can be selected and displayed through the creation condition display tabs TM91. Each of the creation condition display tabs TM91 displays the estimated values of the staining time, the specimen thickness, and the pH in a correctable manner. For example, the estimated staining time can be corrected by changing the numerical values in input boxes IB911 and IB913. Likewise, the estimated specimen thickness can be corrected by changing the numeric value in an input box IB915, and the estimated pH can be corrected by changing the numeric value in an input box IB917. Further, a registration button B91 for registering a correction by entering an operation at the corresponding creation condition display tab TM91, and an OK button B93 for ending a correction input are provided on the creation condition correcting screen.

After a correcting operation is input in response to the request for an input for a correction on the creation conditions as described above (“Yes” at step g17 of FIG. 28), the creation condition input requesting unit 172 notifies the creation condition estimating unit 145 of the correction information. Here, the correction information contains the values of the corrected staining time, the corrected specimen thickness, and the corrected pH. The creation condition estimating unit 145 then corrects the estimated creation conditions in accordance with the correction information (step g19). The conditions for the creation of the observation stained specimen estimated and corrected in the above described manner are then stored into the storage unit 16.

If the registration button B91 on the creation condition correcting screen is clicked at this point, an combination of the respective values of the creation conditions input to the input boxes IB911 and IB913 of the selected creation condition display tab TM91 and the creation condition determining parameter Adj_{A} of the analysis region is added as new creation condition determining parameters Adj to the creation condition determining parameter distribution. For example, the optimum reference spectrum of each of the staining dyes is determined through the later described procedures carried out by the reference spectrum determining unit 146 to determine the optimum reference spectrums, and the determined optimum reference spectrums are stored into the storage unit 16. In addition to that, the combination of the respective values of the creation conditions and the creation condition determining parameter Adj_{A} of the analysis region is associated with the determined optimum reference spectrums, and is then added to the creation condition determining parameter distribution stored in the storage unit 16, thereby updating the creation condition determining parameter distribution.

The reference spectrum determining unit 146 then selects the corresponding reference spectrums of the dye H, the dye E, and the dye R from the reference spectrum information 163 in accordance with the observation stained specimen creation conditions estimated and corrected by the creation condition estimating unit 145 (step g21), and determines the selected reference spectrums as the optimum reference spectrums to be used to estimate the dye amounts in the observation stained specimen (step g23).

When the observation stained specimen creation conditions are the values estimated by the creation condition estimating unit 145 (when the observation stained specimen creation conditions have not been corrected through a user operation), the reference spectrum determining unit 146 reads and selects the reference spectrums of the dye H and the dye E associated with the creation conditions, and the reference spectrum of the dye R from the reference spectrum information 163. The reference spectrum determining unit 146 then determines the selected reference spectrums to be the optimum reference spectrums.

In a case where the observation stained specimen creation conditions have been corrected through a user operation, the reference spectrum determining unit 146 selects and then corrects the reference spectrums stored in the reference spectrum information 163 in accordance with the corrected creation conditions, and determines the optimum reference spectrums.

The procedures for determining the optimum reference spectrums in this case are now described. First, the reference spectrum determining unit 146 selects the creation condition determining parameters Adj having the shortest distance in the creation condition determining parameter distribution, based on the corrected creation conditions: the staining time t, the specimen thickness d, and the hydrogen-ion exponent (pH) p. The reference spectrum determining unit 146 then obtains the staining time t₀, the specimen thickness d₀, and the hydrogen-ion exponent (pH) p₀ corresponding to the selected creation condition determining parameters Adj.

The reference spectrum determining unit 146 then compares the staining time t₀ with the staining time t, the specimen thickness d₀ with the specimen thickness d, and the hydrogen-ion exponent (pH) p₀ with the hydrogen-ion exponent (pH) p, to extract the creation conditions that minimize the differences. In accordance with the extracted creation conditions, the reference spectrum determining unit 146 creates a correction matrix. For example, where the difference between the specimen thickness d₀ and the specimen thickness d is smallest, the reference spectrum determining unit 146 creates a correction matrix according to the following equation (29).

M_{d}_{₀}=T_{d}_{₀}P_{d}_{₀} (29)

Here, T_{d}_{₀} is a transformation matrix of the staining time with the specimen thickness d₀, and is expressed by the following equation (30). Also, P_{d}_{₀} is a transformation matrix of the pH with the specimen thickness d₀, and is expressed by the following equation (31).

T_{d}_{₀}=[τ_{H}(λ),τ_{E}(λ),τ_{R}(λ)] (30)

P_{d}_{₀}=[p_{H}(λ),p_{E}(λ),p_{R}(λ)] (31)

The transformation matrix expressed by the equation (30) defines the variation of the reference spectrum observed in a case where the staining time is varied while the specimen thickness is fixed at d₀. This transformation matrix can be realized by functions that approximate the variation of the reference spectrum of the respective staining dyes (the dye H, the dye E, and the dye R) in accordance with the variation of the staining time with respect to the pre-measured specimen thickness d₀. More specifically, transformation matrixes for two or more specimen thicknesses are prepared, and the transformation matrix suitable for the value of the specimen thickness d₀ is selected and used. Likewise, the transformation matrix expressed by the equation (31) defines the variation of the reference spectrum observed in a case where the pH is varied while the specimen thickness is fixed at d₀. This transformation matrix can be realized by functions that approximate the variations of the reference spectrums of the respective staining dyes (the dye H, the dye E, and the dye R) in accordance with the variation of the pH with respect to the pre-measured specimen thickness d₀.

Transformation matrixes that define the variations of the reference spectrums in a case where the specimen thickness and the pH are varied while the staining time is fixed, and transformation matrixes that define the variations of the reference spectrums in a case where the staining time and the specimen thickness are varied while the pH is fixed are also prepared. Suitable transformation matrixes among those transformation matrixes are used in accordance with the creation conditions that minimize the differences. However, transformation matrixes are not limited to the above. For example, transformation matrixes may be formed by modeling the variations of the reference spectrums of the respective staining dyes with the variation of the staining time and the variation of the pH, while the specimen thickness is fixed. Likewise, transformation matrixes may be formed by modeling the variations of the reference spectrums of the respective staining dyes with the variation of the specimen thickness and the variation of the pH, while the staining time is fixed.

After correcting the reference spectrums of the respective staining dyes associated with the staining time t₀, the specimen thickness d₀, and the hydrogen-ion exponent (pH) p₀ with the use of the correction matrix, the reference spectrum determining unit 146 determines the corrected reference spectrums to be the optimum reference spectrums. The process then returns to step f7 of FIG. 27, and moves on to step f9.

At step f9, based on the spectrums (the absorbance a(x, λ) obtained with respect to the respective pixel positions in the observation stained specimen image, the dye amount estimating unit 147 estimates the dye amounts in the observation stained specimen with the use of the optimum reference spectrums determined for the respective staining dyes through the specimen creation condition estimating process of step f7.

As described above with the equation (2), the spectral transmittance t(x, λ) is calculated according to Lambert-Beer's law. The spectral transmittance t(x, λ) can also be converted into the absorbance a(x, λ) according to the equation (18). In the third embodiment, the dye amounts are also estimated by applying those equations. In other words, according to Lambert-Beer's law, the absorbance a(x, λ) at each of the sample points in the observation stained specimen corresponding to the pixels (x, y) in the observation stained specimen image is expressed by the following equation (32). Here, the optimum reference spectrum determined for the dye H is used as the reference spectrum k_{H} of the dye H, the optimum reference spectrum determined for the dye E is used as the reference spectrum k_{E} of the dye E, and the optimum reference spectrum determined for the dye R is used as the reference spectrum k_{R} of the dye R.

a(x,λ)=k_{H}(λ)d_{H}(x)+k_{E}(λ)d_{E}(x)+k_{R}(λ)d_{R}(x) (32)

The dye amounts of the dye H, the dye E, and the dye R at the respective sample points in the observation stained specimen corresponding to the respective pixels (x, y) can be estimated (calculated) by performing a multiple regression analysis according to the method described in the conventional art through the equation (3). The data about the estimated dye amounts is stored into the storage unit 16.

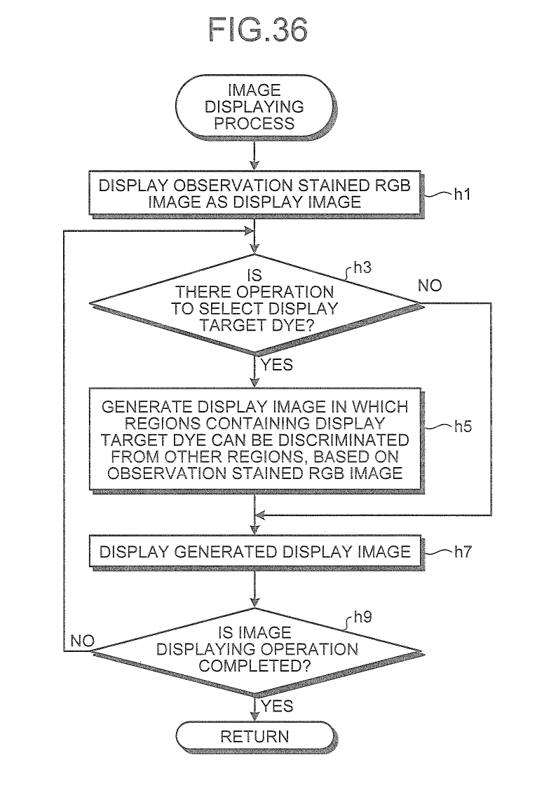

After the dye amounts are estimated as described above, the process moves on to an image displaying process (step f11), as shown in FIG. 27. In this image displaying process, an image (a display image) for displaying the observation stained specimen is generated based on the dye amounts estimated at step f9, and the image is displayed on the display unit 13. FIG. 36 is a flowchart showing the specific procedures in the image displaying process in accordance with the third embodiment.

In the image displaying process, the image display processing unit 175 first causes the display unit 13 to display the RGB image of the observation stained specimen (the observation stained RGB image) generated at step f5 of FIG. 27 (step h1).

The dye selection input requesting unit 173 causes the display unit 13 to display a notification of a request for an input of a selection of a dye to be displayed. While there is not an input of a selection of a dye to be displayed in response to the notification of the selection input request, and the dye to be displayed is not selected (“No” at step h3), the process moves on to step h9.

When a selection of a dye to be displayed is input from the user (“Yes” at step h3), the display image generating unit 148 generates a display image that discriminably shows the regions stained with the display target dye (the positions of pixels containing the display target dye), based on the observation stained RGB image (step h5). For example, based on the dye amounts at the respective sample points in the observation stained specimen estimated with respect to the respective pixels in the observation stained specimen image at step f9 of FIG. 27, the display image generating unit 148 selects the positions of pixels containing the display target dye (the positions at which the dye amount of the display target dye is not “0”), and determines the selected pixel positions to be the display target dye stained regions. When the dye H is selected as the display target dye, the dye-H-containing pixel positions at which the dye amount of the dye H is not “0” are selected, and are set as the display target dye stained regions. Based on the observation stained RGB image, the display image generating unit 148 then generates a display image in which the pixels in the display target dye stained regions can be discriminated from the other pixels.

The image display processing unit 175 then causes the display unit 13 to display the display image generated at step h5 (step h7), and the process moves on to step h9. Here, the already displayed image may be replaced with the display image generated at step h7, or the two images may be displayed next to each other.

At step h9, a check is made to determine whether the image displaying process is completed. If the image displaying process is not completed (“No” at step h9), the process returns to step h3, and an operation to select a display target dye is received. For example, when an operation to end the image displaying process is input from the user, the image displaying process is determined to be completed (“Yes” at step h9). The process then returns to step f11 of FIG. 27, and comes to an end.

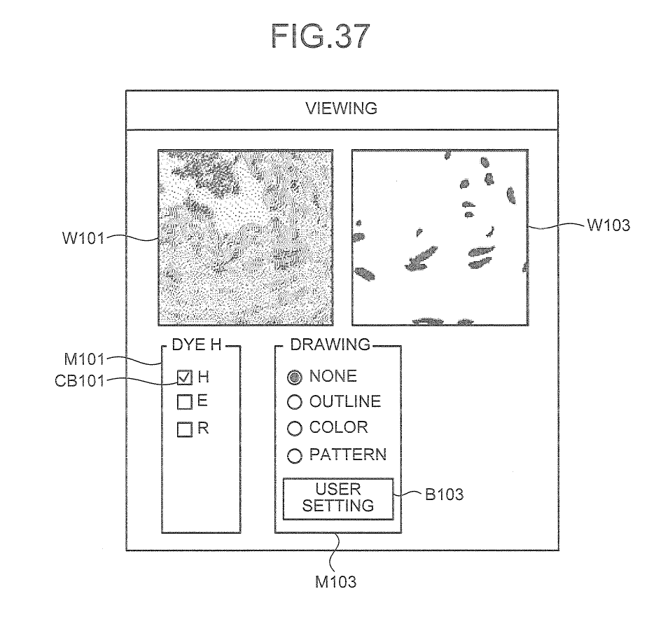

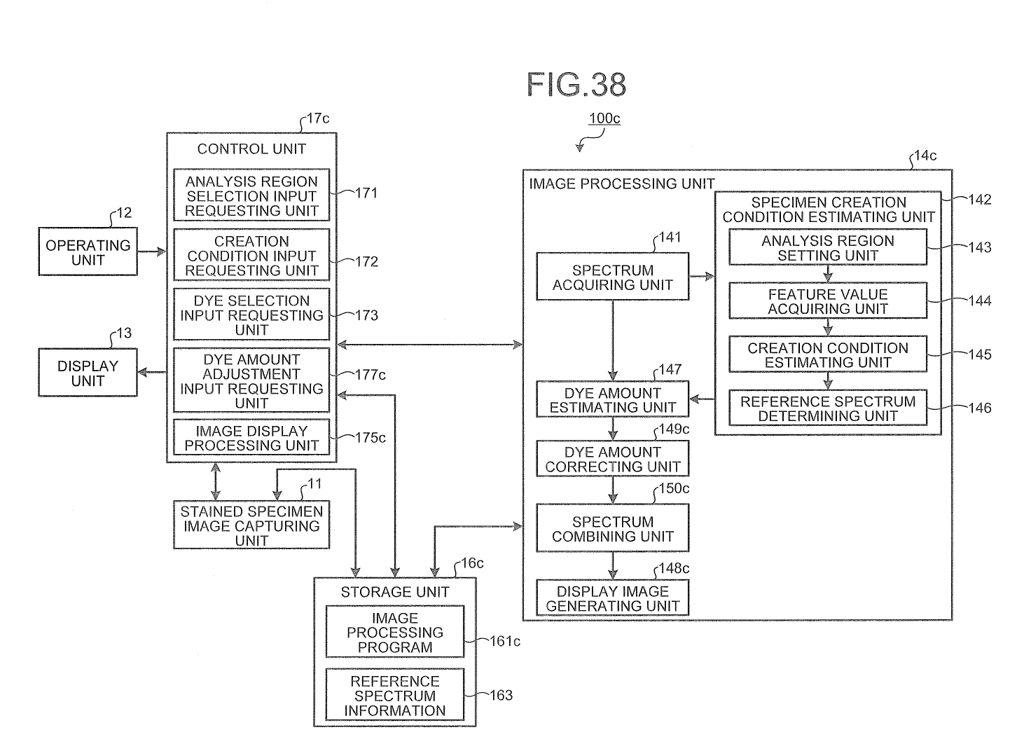

An example operation to be performed by the user to view a display image is now described. FIG. 37 shows an example of a display image viewing screen in accordance with the third embodiment. The viewing screen shown in FIG. 37 includes two image display portions W101 and W103. The viewing screen also includes a dye selecting menu M101 for selecting a display target dye, so that each staining dye can be selected as a display target dye independently of the others. In FIG. 37, the dye H is selected as the display target dye through a check box CB101.

The image display portion W101 in the left side in FIG. 37 displays an observation stained RGB image, for example. The image display portion W103 in the right side in FIG. 37 displays a display target dye discriminating image in which the display target dye stained regions can be discriminated from the other regions, for example. The display target dye discriminating image is an example of the display image generated at step h5 of FIG. 36, and is an image that shows the display target dye stained regions but does not show the other regions. In the display target dye discriminating image in FIG. 37, the display target dye stained regions formed with respect to the dye H in the observation stained RGB image are shown, and the other pixels are not shown. In the internal process in this case, the display image generating unit 148 sets the display target dye stained regions, based on the display target dye selected in the dye selecting menu M101. The display image generating unit 148 then generates the display target dye discriminating image by replacing the pixels outside the display target dye stained regions with a predetermined color (such as white).

The viewing screen further includes a drawing menu M103 for designating a drawing mode of the display target dye discriminating image displayed on the image display portion W103. In the example illustrated in FIG. 37, radio buttons are provided, so that one of “none”, “outline”, “color”, and “pattern” can be selected as the drawing mode. When “none” is selected in the drawing menu M103 as shown in FIG. 37, the display target dye discriminating image is displayed on the image display portion W103 as it is. When “outline” is selected, the display target dye stained regions of each display target dye are outlined in the display target dye discriminating image. When “color” is selected, the display target dye stained regions of each display target dye are shown in a predetermined drawing color in the display target dye discriminating image. A drawing color is set for each display target dye in advance. When “pattern” is selected, the display target dye stained regions of each display target dye are shown in a predetermined shaded pattern in the display target dye discriminating image. A shaded pattern is set for each display target dye in advance. For example, in a case where two or more display target dyes are selected in the dye selecting menu M101, the display target dye stained regions of each of the selected display target dyes can be discriminated by selecting “color” or “pattern” in the drawing menu M103. Further, a user setting button B103 is provided in the drawing menu M103. By clicking the user setting button B103, the color or shaded pattern to be assigned to each display target dye, or the discriminated display items presented in the drawing menu M103 can be edited.

The discrimination display method is not limited to the above. For example, the color shade may be varied stepwise in accordance with the values of the dye amount at the respective pixel positions containing the display target dye.

As described above, in accordance with the third embodiment, the observation stained specimen creation conditions can be estimated. The reference spectrums that match the estimated creation conditions are selected from the combinations of the reference spectrums of the respective staining dyes stored in the reference spectrum information 163, and the selected reference spectrums can be set as the optimum reference spectrums of the respective staining dyes. Based on the spectrums obtained with respect to the pixels in the observation stained specimen image, the dye amounts of the staining dyes at the sample points in the observation stained specimen can be estimated with the use of the set optimum reference spectrums of the respective staining dyes. Accordingly, with the use of the optimum reference spectrums of the staining dyes that match the observation stained specimen creation conditions, it is possible to accurately estimate the dye amounts in the stained specimen to be observed. Also, the user does not need to record the observation stained specimen creation conditions. In this manner, it is possible to save the user the trouble of recording.

Also, the pixel positions in the observation stained specimen image containing the display target dye selected by the user based on the estimated dye amounts of the respective staining dyes are selected. Accordingly, it is possible to generate a display image in which the regions stained with the display target dye in the observation stained specimen (or the pixel positions containing the display target dye) can be discriminated from the other regions. In this manner, an image that shows the inside of the observation stained specimen with high visibility can be presented to the user. With this arrangement, the viewing efficiency of the user can be increased. Selecting a desired staining dye, the user can observe, with high visibility, the regions of the desired staining dye independently of or in combination with other regions in the observation stained specimen.

In the above described third embodiment, the creation condition estimating unit 145 estimates the observation stained specimen creation conditions. However, the creation conditions may not be estimated. For example, the specimen creation condition estimating process to be performed at step f7 of FIG. 27 may be replaced with a process to acquire the creation conditions used to create the observation stained specimen in accordance with a user operation.

In such a case, the creation condition input requesting unit 172 causes the display unit 13 to display a creation condition input screen that is the same as the creation condition correcting screen shown in FIG. 35, and notifies the user of a request for an input of the creation conditions used to create the observation stained specimen. The creation condition input requesting unit 172 then obtains the creation conditions input by the user in response to the input request notification, and sets the obtained creation conditions as the observation stained specimen creation conditions. Based on the observation stained specimen creation conditions obtained by the creation condition input requesting unit 172 through a user operation, the reference spectrum determining unit 146 selects the corresponding creation condition determining parameters Adj from the creation condition determining parameter distribution. The reference spectrum determining unit 146 then reads the reference spectrum of the selected creation condition determining parameters Adj from the reference spectrum information 163, and determines the read reference spectrums to be the optimum reference spectrums of the respective staining dyes to be used to estimate the dye amounts. If there are creation conditions that match the obtained creation conditions, the reference spectrum determining unit 146 determines the corresponding reference spectrums of the respective staining dyes to be the optimum reference spectrums. If there are no creation conditions that match the obtained creation conditions, the reference spectrum determining unit 146 selects the reference spectrums of the respective staining dyes through the same procedures as those of step g21 and g23 of FIG. 28, and corrects the selected reference spectrums to set the optimum reference spectrums of the respective staining dyes.

FIG. 38 is a block diagram showing the functional structure of an image processing device 100c in accordance with a fourth embodiment. In FIG. 38, the same components as those of the image processing device 100 of the third embodiment are denoted by the same reference numerals as those used in the third embodiment.

As shown in FIG. 38, the image processing device 100c of the fourth embodiment includes a stained specimen image capturing unit 11, an operating unit 12, a display unit 13, an image processing unit 14c, a storage unit 16c, and a control unit 17c.

The image processing unit 14c includes the spectrum acquiring unit 141, the specimen creation condition estimating unit 142, the dye amount estimating unit 147, a dye amount correcting unit 149c, a spectrum combining unit 150c as a spectral property combining unit, and a display image generating unit 148c. The dye amount correcting unit 149c corrects the dye amounts of the dye H, dye E, and the dye R that are estimated by the dye amount estimating unit 147, in accordance with user operations that are input through the operating unit 12 in response to an adjustment input request issued from a dye amount adjustment input requesting unit 177c. The spectrum combining unit 150c generates spectral transmittance t(x, λ), based on the dye amounts of the dye H, the dye E, and the dye R that are corrected by the dye amount correcting unit 149c.

The storage unit 16c stores an image processing program 161c for estimating and correcting the dye amounts at each sample position in the observation stained specimen, and the reference spectrum information 163.

The control unit 17c includes the analysis region selection input requesting unit 171, the creation condition input requesting unit 172, the dye selection input requesting unit 173 as a dye designating unit, the dye amount adjustment input requesting unit 177c, and an image display processing unit 175c as a display processing unit. The dye amount adjustment input requesting unit 177c issues a request for an input of dye amount adjustment, and receives an operation to adjust the dye amounts from the user via the operating unit 12.

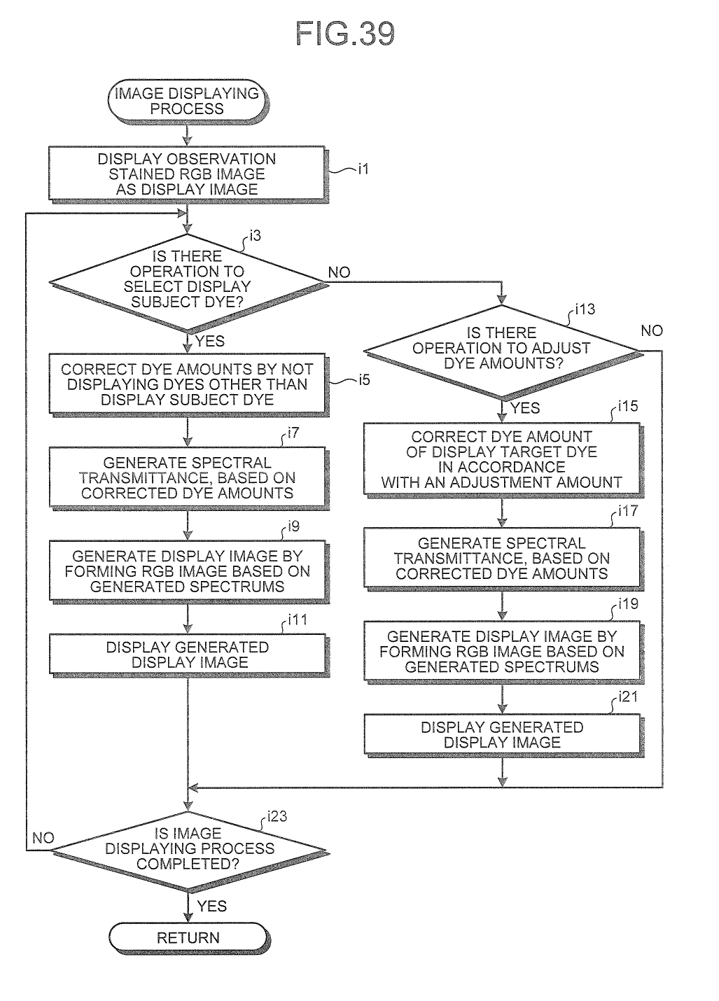

The image processing device 100c of the fourth embodiment performs the image displaying process shown in FIG. 39, instead of the image displaying process performed at step f11 in the process of the third embodiment shown in FIG. 27. The process to be performed by the image processing device 100c can be realized by the respective components of the image processing device 100c in accordance with the image processing program 161c stored in the storage unit 16c.

In the image displaying process, the image display processing unit 175c first causes the display unit 13 to display the observation stained RGB image generated at step f5 of FIG. 27 as in the third embodiment, as shown in FIG. 39 (step i1).

The dye selection input requesting unit 173 then causes the display unit 13 to display a notification of a request for a display target dye selection input. When an operation to select a display target dye is input in response to the notification of the section input request (“Yes” at step i3), the dye amount correcting unit 149c corrects the dye amounts, not showing the dyes other than the display target dye (step i5). For example, among the dye amounts estimated with respect to the pixels in the observation stained specimen image at step f9 of FIG. 27 as described in the third embodiment, all the dye amounts of the dyes other than the display target dye are replaced with “0”, to perform the correction.

The spectrum combining unit 150c then generates the spectrum transmittance t(x, λ), based on the corrected dye amounts of the dye H, the dye E, and the dye R (step i7). For example, according to the following equation (33), the spectrum combining unit 150c newly generates the spectral transmittance t(x, λ) at each pixel position (x) with the use of the optimum reference spectrums determined with respect to the respective staining dyes in the specimen creation condition estimating process of FIG. 28 as described in the third embodiment.

−log t(x,λ)=k_{H}(λ)d_{H}(x)+k_{E}(λ)d_{E}(x)+k_{R}(λ)d_{R}(x) (33)

The display image generating unit 148c then converts the newly generated spectral transmittance t(x, λ) of each pixel position (x) into an RGB value, and generates a display image by forming an RGB image (step i9). The spectral transmittance t(x, λ) is converted into an RGB value in the same manner as in the procedure of step f5 of FIG. 27, using the equations (12) and (13), as described in the third embodiment. The RGB image formed here is an image that shows only the staining state of the display target dye (or visually presents only the dye amounts of the display target dye).

The image display processing unit 175c then causes the display unit 13 to display the display image generated at step i9 (step i11). The process then moves on to step i23. At this point, the already displayed image may be replaced with the display image generated at step i9, or the two images may be displayed next to each other.

While the display image is displayed as described above, an operation to adjust the dye amount of the display target dye is received. For example, the dye amount adjustment input requesting unit 177c causes the display unit 13 to display a notification of a request for a dye amount adjustment input. When an operation to adjust the dye amounts is input in response to the adjustment input request (“Yes” at step i13), the dye amount adjustment input requesting unit 177c notifies the dye amount correcting unit 149c of the input adjustment amount.

The dye amount correcting unit 149c then corrects the dye amount of the display target dye in accordance with the adjustment amount notified from the dye amount adjustment input requesting unit 177c (step i15). After that, based on the corrected dye amounts of the dye H, the dye F, and the dye R, the spectrum combining unit 150c newly generates the spectral transmittance t(x, λ) according to the equation (30) in the same manner as in the procedure of step i7 (step i17). The display image generating unit 148c then converts the newly generated spectral transmittance t(x, λ) of each pixel position into an RGB value according to the equations (12) and (13) in the same manner as in the procedure of step i9, and generates a display image by forming an RGB image (step i19).

The image display processing unit 175c then causes the display unit 13 to display the display image generated at step 119 (step i21). The process then moves on to step i23. At this point, the already displayed image may be replaced with the display image generated at step i19, or the two images may be displayed next to each other.

At step i23, a check is made to determine whether the image displaying process is completed. If the image displaying process is not completed (“No” at step i23), the process returns to step i3, and an operation to select a display target dye is received. For example, when an operation to end the image displaying process is input from the user, the image displaying process is determined to be completed (“Yes” at step 123).

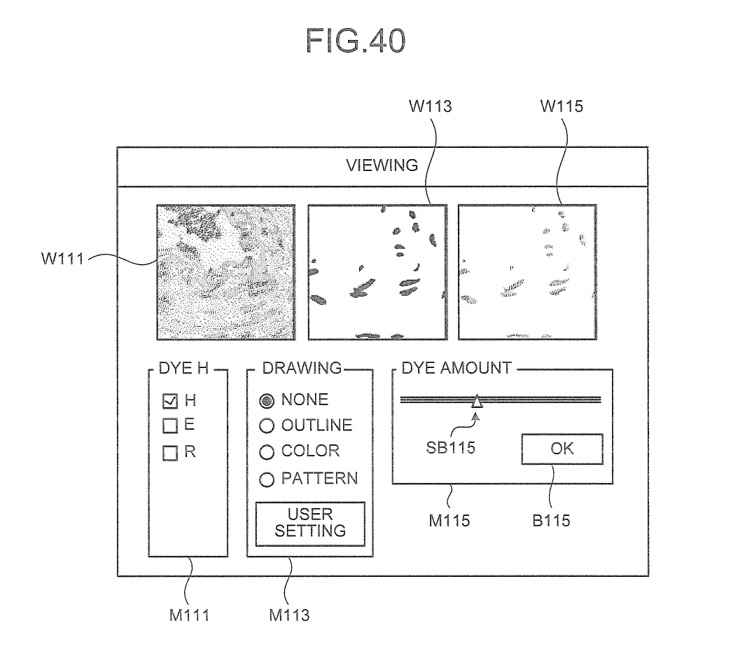

An example operation to be performed by the user to view a display image is now described. FIG. 40 shows an example of a display image viewing screen in accordance with the fourth embodiment. The viewing screen shown in FIG. 40 includes three image display portions W111, W113, and W115. The viewing screen also includes a dye selecting menu M111 for selecting a display target dye, and a drawing menu M113 for designating a drawing mode of display target dye stained images to be displayed in the image display portions W113 and W115.

The image display portion W111 shown in the left side in FIG. 40 displays the observation stained RGB image, for example. The image display portions W113 and W115 shown in the center and the right side in FIG. 40 display the display target dye stained images that show only the dye amount of the display target dye. The display target dye stained images are equivalent to the display images generated through the procedures of step i9 and i19 of FIG. 39. In FIG. 40, images that only show the staining state of the dye H selected as the display target dye are displayed.

The viewing screen further includes a dye amount adjustment menu M115. A slider bar SB115 for adjusting the dye amount of the display target dye, an OK button B115 for entering an operation at the slider bar SB115, and the likes are provided in the dye amount adjustment menu M115. For example, while the display target dye stained images displayed on the image display portions W113 and W115 are viewed and diagnosed, the user handles the slider bar SB115 in the dye amount adjustment menu M115, to increase or reduce the display target dye in the staining state. In this manner, the user inputs an adjustment amount for the dye amount of the display target dye. In FIG. 40, the display target dye stained image displayed on the right-side image display portion W115 is an image formed by adjusting the dye amount of the dye H, with the slider bar SB115, to a smaller amount than in the display target dye stained image displayed on the center image display portion W113.

As described above, in accordance with the fourth embodiment, the same advantages as those of the third embodiment can be achieved, and the estimated dye amount of the display target dye can be corrected in accordance with an adjustment operation by the user. The spectrum of each pixel position can be generated based on the corrected dye amounts of the staining dyes, and a display image can be generated by forming an RGB image. Alternatively, the dye amounts of the dyes other than the display target dye are corrected to zero, so as to generate a display image that visually shows only the dye amount of the display target dye. Accordingly, an image that shows the inside of the observation stained specimen with high visibility can be presented to the user by adjusting the staining state of each of the staining dyes. By selecting a desired staining dye to adjust the dye amount, eliminating staining dyes unnecessary to observe and evaluate, and the like, the staining state of each staining dye can be independently adjusted so as to observe with high visibility for the user. Therefore, it is possible to improve evaluation accuracy.

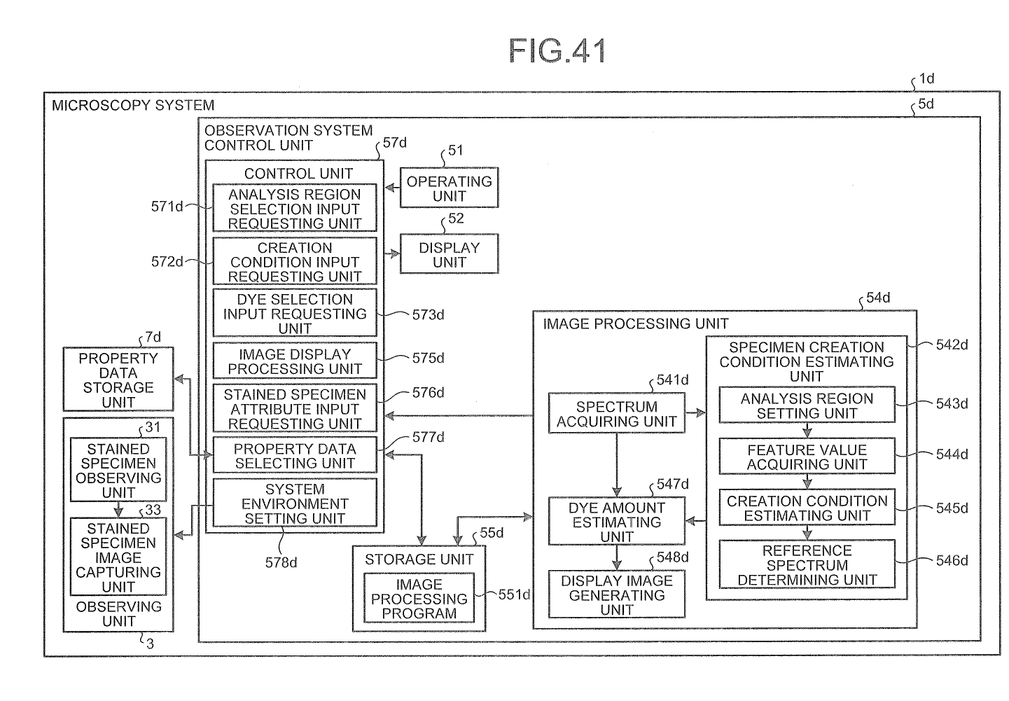

In a fifth embodiment, the image processing device 100 of the third embodiment is applied to the microscopy system 1 illustrated in FIG. 1. FIG. 41 is a block diagram showing the functional structure of a microscopy system 1d in accordance with the fifth embodiment. In FIG. 41, the same components as those of the first embodiment are denoted by the same reference numerals as those used in the first embodiment. As shown in FIG. 41, the microscopy system 1d of the fifth embodiment includes the observing unit 3, an observation system control unit 5d, and a property data storage unit 7d.

The observation system control unit 5d includes the operating unit 51, the display unit 52, an image processing unit 54d, a storage unit 55d, and a control unit 57d. The microscopy system 1d of the fifth embodiment is based on the structure of the image processing device 100 of the third embodiment. The image processing unit 54d includes a spectrum acquiring unit 541d, a specimen creation condition estimating unit 542d, a dye amount estimating unit 547d, and a display image generating unit 548d. The specimen creation condition estimating unit 542d includes an analysis region setting unit 543d, a feature value acquiring unit 544d, a creation condition estimating unit 545d, and a reference spectrum determining unit 546d.

The control unit 57d includes an analysis region selection input requesting unit 571d, a creation condition input requesting unit 572d, a dye selection input requesting unit 573d, an image display processing unit 575d, a stained specimen attribute input requesting unit 576d, a property data selecting unit 577d, and a system environment setting unit 578d.

The components 541d to 548d of the image processing unit 54d, and the analysis region selection input requesting unit 571d, the creation condition input requesting unit 572d, the dye selection input requesting unit 573d, and the image display processing unit 575d of the control unit 57d perform the same processes as those performed by the components of the third embodiment with the same names as above components. Although the third embodiment is applied to the fifth embodiment, the image processing unit 54d and the control unit 57d may be based on a modification of the third embodiment or the structure of the fourth embodiment.

In the control unit 57d, the stained specimen attribute input requesting unit 576d designates the attribute values indicated by the attributes of the observation stained specimen, in accordance with a user operation. Here, the attributes of the observation stained specimen (the stained specimen attributes) are formed with the four attribute items: stain type, organ, target tissue, and facility. The stained specimen attribute input requesting unit 576d designates the attribute values of the four attribute items related to the observation stained specimen, in accordance with a user operation. In the fifth embodiment, the user not only designates the stained specimen attributes of the observation stained specimen, but also designates the magnification of the microscope (the stained specimen observing unit 31) when viewing the observation stained specimen.

The property data selecting unit 577d selects one or more sets of property data from the property data stored in the property data storage unit 7d, based on the stained specimen attributes designated by the stained specimen attribute input requesting unit 576d.

The system environment setting unit 578d sets the system parameters for setting the operating environment (the system environment) of the observing unit 3. For example, the system environment setting unit 578d sets the system parameters that are the observation parameters for setting the operating environment of the stained specimen observing unit 31, and the imaging parameters for setting the operating environment of the stained specimen image capturing unit 33.

The storage unit 55d stores a program for causing the observation system control unit 5d to operate to realize the various functions of the observation system control unit 5d, the data and the likes to be used during execution of the program, and an image processing program 551d for estimating the dye amount at the sample positions in the observation stained specimen.

The property data storage unit 7d stores the property data corresponding to the attribute values of the respective attribute items of the stained specimen attributes. The property data storage unit 7d is realized by a database device connected to the observation system control unit 5d via a network, for example. The property data storage unit 7d is situated in a place separated from the observation system control unit 5d, and stores and manages the property data. Alternatively, the property data may be stored in the storage unit 55d of the observation system control unit 5d.

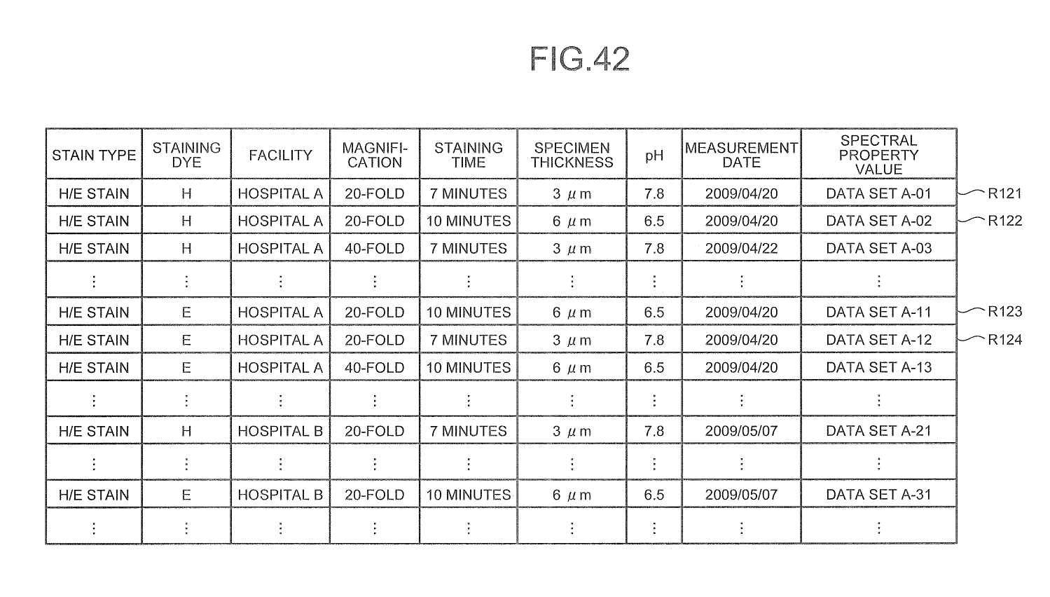

FIG. 42 shows an example data structure of the property data stored in the property data storage unit 7d. FIG. 42 is a list of the property data associated with the stain type that is one of the attribute items in the property data storage unit 7d. The property data storage unit 7d of the fifth embodiment also stores a list of the property data about the facility as in the first embodiment shown in FIG. 5, as well as the list of the property data about the stain type shown in FIG. 42.

As shown in FIG. 42, in the property data about the stain types, the staining dyes and the facilities as attribute items, the magnifications as observation parameters, the staining times, the specimen thicknesses, and the pH as the creation conditions, the measurement dates, and the spectral property values are stored and associated with the respective attribute values. The spectral property values (data sets A-01 to A-03, A-11 to A-13, A-21, A-31, and the like) associated with the stain types are the spectral property values (the spectrum data) that are measured beforehand with respect to the staining dyes of the corresponding stain types. The spectral property values associated with the stain types are the spectral property values that are measured in the corresponding facilities (the medical facilities where stained specimens (single stained specimens) to be subjected to measurement of the spectral property values are collected) on the corresponding measurement dates, with the conditions being the corresponding magnifications, viewing times, specimen thicknesses, and pH. Here, the spectral property values are equivalent to the reference spectrums explained in the third embodiment, and may be set as the spectral absorbance, for example. Alternatively, spectral property values such as spectral transmittance or spectral reflectance may be used.

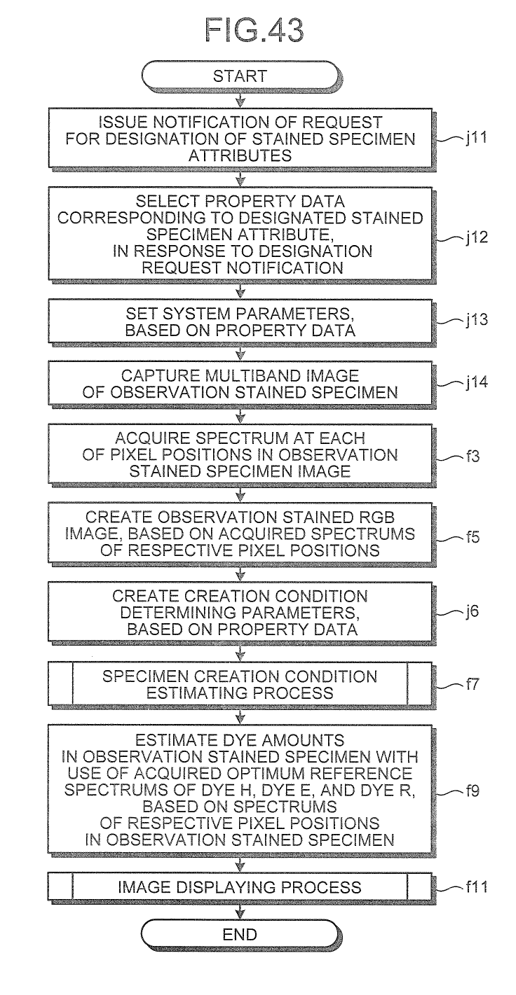

FIG. 43 is a flowchart showing the procedures in the process to be performed by the observation system control unit 5d of the fifth embodiment. In FIG. 43, the same procedures as those of the third embodiment are denoted by the same reference numerals as those used in the third embodiment.

As shown in FIG. 43, the stained specimen attribute input requesting unit 576d causes the display unit 52 to display a stained specimen attribute designating screen, and issues a request for designation of stained specimen attributes. The stained specimen attribute input requesting unit 576d then receives an operation from the user to designate stained specimen attributes and a magnification through the operating unit 51 (step j11). The procedure of step j11 can be carried out in the same manner as in step a6 of the first embodiment shown in FIG. 6. For example, the stained specimen attribute designating screen shown in FIG. 7 is displayed on the display unit 52, and a stain type, an organ, a target tissue, a facility, a magnification, and the likes are designated.

At step j11, a designating process from the user is received to set the stain type as “H/E stain”, the organ as “kidney”, the target tissue as “elastin fibrils”, the facility as “hospital A”, and the magnification as “20-fold”, for example. In this case, the procedures after step j11 of FIG. 43 are as follows.

After the attribute values of the stained specimen attributes are designated, the property data selecting unit 577d selects one or more sets of property data corresponding to the attribute values of the designated stained specimen attributes from the property data storage unit 7d, as shown in FIG. 43 (step j12). More specifically, under the above mentioned conditions, the property data selecting unit 577d selects the records R121 to R124 in which the stain type is “H/E stain”, the facility is “hospital A”, and the magnification is “20-fold”, from the property data about the stain type shown in FIG. 42. The property data selecting unit 577d then acquires the data sets A-01, A-02, A-11, and A-12 of the corresponding property values. The property data selecting unit 577d also selects the record R75 in which the facility is “hospital A”, the stain type is “H/E stain”, the organ is “kidney”, and the magnification is “20-fold”, from the property data about the facility shown in FIG. 5. The property data selecting unit 577d then acquires the data sets C-01, C-11, and C-21 of the corresponding system spectral properties.

Based on the property data selected at step j12, the system environment setting unit 578d sets the system parameters (the observation parameters and the imaging parameters) (step j13). The imaging parameters are values related to the operation of the multiband camera. The system environment setting unit 578d notifies the stained specimen image capturing unit 33 of the values of the set imaging parameters, and instructs the stained specimen image capturing unit 33 to operate. In response to the operation instruction from the system environment setting unit 578d, the stained specimen image capturing unit 33 drives the multiband camera by setting the gain, the exposure time, and the bandwidth (the selected wavelength width) to be selected by the tunable filter, in accordance with the supplied imaging parameters.

In the fifth embodiment, the system environment setting unit 578d sets the selected bandwidth (the selected wavelength width) of the tunable filter as one of the imaging parameters. For example, the selected wavelength width in a bandwidth in the vicinity (for example, in the ±5-nanometer range) of the wavelength H_{S} described with reference to FIG. 3 is set at 1 nm, which is the smallest wavelength width that can be selected by the tunable filter. More specifically, based on the acquired data sets A-01, A-02, A-11, and A-12 of spectral property values, the system environment setting unit 578d combines the spectral property values of the data sets A-01 and A-11 having the same creation conditions, to determine the wavelength H_{S}. Likewise, the system environment setting unit 578d determines the wavelength H_{S} by combining the data sets A-02 and A-12 having the same creation conditions. The selected wavelength width in the bandwidth in the vicinity of the wavelength H_{S} determined for each combination is set at 1 nm, for example. The selected wavelength width in each of the bandwidths outside the ±5-nanometer range of the wavelength H_{S} is set at the initial value (such as 5 nm). In accordance with the selected wavelength width set for each bandwidth, the stained specimen image capturing unit 33 sequentially selects the bandwidths to be selected by the tunable filter, and captures an observation stained specimen image in each of the selected bandwidth.

The system environment setting unit 578d also sets the exposure time as the second one of the imaging parameters. For example, using the data set of white image signal values selected at step j12 (the data set C-01 under the example conditions), the system environment setting unit 578d adjusts the exposure time so that the largest value of the white image signal values has a predetermined luminance value. The system environment setting unit 578d then sets the adjusted exposure time as the exposure time in the bandwidths outside the ±5-nanometer range of the wavelength H_{S}. As for the exposure time in the bandwidths within the ±5-nanometer range of the wavelength H_{S}, the system environment setting unit 578d first issues operation instructions to the stained specimen observing unit 31 and the stained specimen image capturing unit 33, and acquires white image signal values at the designated magnification. Using the acquired white image signal values, the system environment setting unit 578d calculates the exposure time at each of the measured wavelengths. By doing so, the system environment setting unit 578d can set the exposure time in accordance with the environment at the time of observation (at the time of capturing a stained specimen image) in the vicinity of the wavelength H_{S}.

In the above example, the two imaging parameters that are the bandwidth to be selected by the tunable filter (the selected wavelength width) and the exposure time are set. However, imaging parameters concerning the values other than those settings may be set as needed.

Meanwhile, the observation parameters are the values related to operations of the microscope. The system environment setting unit 578d notifies the stained specimen observing unit 31 of the set values of the observation parameters, and issues an operation instruction to the stained specimen observing unit 31. In response to the operation instruction from the system environment setting unit 578d, the stained specimen observing unit 31 adjusts the components of the microscope when observing an observation stained specimen, by performing switching of the magnification of the objective lens, control of the modulated light of the light source depending on the switched magnification, switching of optical elements, moving of the electromotive stage, and the likes, in accordance with the supplied observation parameters.

In the fifth embodiment, the system environment setting unit 578d sets one of the observation parameters that is the value of the magnification designated in response to the notification at step j11. Not only the magnification but also the values of the focal position, the aperture of the microscope, and the likes can be set as the observation parameters.

After that, the system environment setting unit 578d sequentially outputs the selected wavelength width and the exposure time in the corresponding bandwidth to the stained specimen image capturing unit 33, and also outputs the value of the magnification set as an observation parameter to the stained specimen observing unit 31. In this manner, an optimum operating environment (system environment) of the observing unit 3 can be automatically set for each specimen to be observed. As a result, the observing unit 3 operates in accordance with the system parameters set by the system environment setting unit 578d, and acquires an observation stained specimen image by capturing a multiband image of the observation stained specimen at each of the selected wavelength widths (step j14).

The spectrum acquiring unit 541d of the image processing unit 54d then acquires the spectrum at each pixel position in the observation stained specimen images (step f3). More specifically, the spectrum acquiring unit 541d estimates the spectrums at the samples points in each observation stained specimen corresponding to the pixels of the corresponding observation stained specimen image in the same manner as the third embodiment. In this manner, the spectrum acquiring unit 541d acquires the spectrum at each pixel position.

The spectrum acquiring unit 541d then creates an observation stained RGB image, based on the spectrums at the respective pixel positions in the obtained observation specimen images (step f5). The procedure of step f5 is the same as the procedure of step f5 of the third embodiment shown in FIG. 27. In the fifth embodiment, however, the spectrum acquiring unit 541d uses the property data selected at step j12, to calculate the system matrix H of the equation (12). More specifically, in the equation (13) expressing the system matrix H, the data set C-21 of camera spectral properties selected as the spectral sensitivity properties S of the camera is used. Also, the data set C-11 of illuminating light spectral property values selected as the spectral emittance properties E of illuminating light is used. With this arrangement, the observation stained RGB image can be generated with the use of the values of the camera spectral sensitivity properties S and the illuminating light spectral emittance properties E suitable in the designated settings.

Based on the property data selected at step j12, the specimen creation condition estimating unit 542d creates the creation condition determining parameter distribution to be used in the specimen creation condition estimating process (step j6). More specifically, under the example conditions, the specimen creation condition estimating unit 542d creates the creation condition determining parameter distribution, based on the creation condition determining parameters Adj defined by the data sets A-01, A-02, A-11, and A-12 of spectral property values.

As described in the third embodiment, the creation condition determining parameters Adj are determined for each combination of reference spectrums of the dye H and the dye E having the same creation conditions. Under the example conditions, the data set A-01 and the data set A-11 have the same creation conditions, as shown in FIG. 42. Also, the data set A-02 and the data set A-12 have the same creation conditions. Accordingly, those data sets are combined. Based on the creation condition determining parameters Adj defined by the spectral property values of the data sets A-01 and A-11 and the creation condition determining parameters Adj defined by the spectral property values of the data sets A-02 and A-12, the creation condition determining parameter distribution is created.

The method of determining the creation condition determining parameters Adj and the method of creating the creation condition determining parameter distribution are the same as those in the third embodiment. The creation condition determining parameters Adj may be determined beforehand and then stored into the property data storage unit 7d or the storage unit 55d. In such a case, the creation condition determining parameters Adj are determined beforehand for each combination of spectral property values having the same conditions stored as data sets in the property data storage unit 7d. At step j6, the creation condition determining parameters Adj corresponding to the selected property data are distributed in a creation condition space, so as to form the creation condition determining parameter distribution. Alternatively, the creation condition determining parameter distribution may also be created beforehand. In such a case, the creation condition determining parameter distribution is created beforehand by distributing all the creation condition determining parameters Adj determined as above in a creation condition space, and only the creation condition determining parameters Adj corresponding to the selected property data are referred to in the creation condition determining parameter distribution.

After the creation condition determining parameter distribution is created as above, the process moves on to the specimen creation condition estimating process (step f7), and the same process as that in the third embodiment (see FIG. 28) is performed to acquire the optimum reference spectrum of each of the staining dye. In the procedure equivalent to the procedure of step g15 of FIG. 28, however, the creation condition determining parameters Adj are selected from the creation condition determining parameter distribution set at step j6 of FIG. 43 in the specimen creation condition estimating process in the fifth embodiment.

Based on the spectrum (the absorbance a(x, λ)) acquired with respect to each pixel position in the observation stained specimen image at step f3, the dye amount estimating unit 547d estimates the dye amounts in the observation stained specimen, using the optimum reference spectrums determined for the staining dyes in the specimen creation condition estimating process of step f7 (step f9). After that, the process moves on to the image displaying process (step f11), and the same process as that of the third embodiment is performed.

As described above, in accordance with the fifth embodiment, the property data determined in accordance with the attribute values indicating the attributes of the specimen is stored for each of the attribute values, so that the property data corresponding to the attribute values and the likes of the observation stained specimen can be selected. The creation condition determining parameters Adj are selected with the use of the selected property data, and the creation conditions of the observation stained specimen are then estimated. In this manner, the optimum reference spectrums of the respective staining dyes can be determined. Accordingly, the dye amounts in each observation stained specimen can be estimated with higher precision.

In each of the above described embodiments, a stained specimen subjected to H/E staining is the subject to be observed. Since a stained specimen subjected to H/E staining is the subject, the dye amounts of the dye H, the dye E, and the dye R are estimated. However, the present invention may also be applied to specimens stained with other staining dyes, and the dye amounts of the other staining dyes can be estimated. Further, the color inherent to each specimen can be treated like the dye R in each of the above described embodiments.

According to the present invention, the property data determined in accordance with the attribute values representing the attributes of a specimen is stored for each of the attribute values, so that the property data corresponding to the attribute values of the specimen to be observed can be selected. Based on the selected property data, the system parameters for setting the operating environment of the observing unit to observe the subject specimen can be set. Accordingly, an optimum system environment for acquiring the features of the specimen to be observed can be automatically set.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A microscopy system, comprising:
an observing unit that observes a specimen with a microscope;
an observation system control unit that controls an operation of the observing unit; and
a property data storage unit that stores property data that is determined in accordance with attribute values representing attributes of the specimen, the property data being associated with each of the attribute values, wherein
the observation system control unit comprises
a specimen attribute designating unit that designates the attribute values of the specimen to be observed;
a property data selecting unit that selects at least one set of property data in accordance with the attribute values designated by the specimen attribute designating unit, from the property data stored in the property data storage unit; and
a system environment setting unit that sets system parameters for setting an operating environment of the observing unit at the time of observation of the specimen to be observed, based on the property data selected by the property data selecting unit.

2. The microscopy system according to claim 1, further comprising:
a property data analyzing unit that analyzes the property data selected by the property data selecting unit,
wherein the system environment setting unit sets the operating environment of the observing unit, based on a result of the analysis performed by the property data analyzing unit.

3. The microscopy system according to claim 1, wherein
the observing unit comprises
a specimen observing unit that is formed with the microscope; and
a specimen image capturing unit that captures an image of the specimen, and
the system environment setting unit sets the system parameters that include an observation parameter for setting an operating environment of the specimen observing unit and/or an imaging parameter for setting an operating environment of the specimen image capturing unit.

4. The microscopy system according to claim 3, wherein
the specimen image capturing unit includes a multiband camera that is capable of selecting at least a wavelength or at least a bandwidth for image capturing, and
the system environment setting unit sets the wavelength or the bandwidth for image capturing as the imaging parameter.

5. The microscopy system according to claim 4, wherein
the property data includes spectral property information that is measured beforehand with respect to each of the attribute values,
the property data analyzing unit determines a characteristic wavelength with respect to the specimen to be observed, based on the spectral property information in the selected property data, and
the system environment setting unit sets the wavelength or the bandwidth for image capturing, based on the characteristic wavelength.

6. The microscopy system according to claim 5, wherein the system environment setting unit sets an exposure time of the multiband camera as the imaging parameter, based on the wavelength or the bandwidth for image capturing.

7. The microscopy system according to claim 3, wherein
the property data includes at least one of a magnification, a focal position, and an aperture that are set beforehand with respect to each of the attribute values, and
the system environment setting unit sets at least one of the magnification, the focal position, and the aperture of the microscope as the observation parameter, based on the selected property data.

8. The microscopy system according to claim 3, wherein the observation system control unit comprises a target extracting unit that extracts a region of interest from the specimen image captured by the specimen image capturing unit, in accordance with the system parameters set by the system environment setting unit.

9. The microscopy system according to claim 8, wherein the target extracting unit causes a display unit to display an image in which the region of interest is discriminated from other regions in the specimen image.

10. The microscopy system according to claim 8, wherein
the specimen is a body tissue specimen stained with a predetermined dye, and
the attributes related to the specimen include at least one of the following attribute items: a type of staining performed on the body tissue specimen, an organ from which the body tissue specimen is collected, a target tissue in the body tissue specimen, and a facility where the body tissue specimen is stained.

11. The microscopy system according to claim 10, wherein the target extracting unit extracts the region of interest that is a region showing the target tissue designated as an attribute value of the specimen to be observed by the specimen attribute designating unit, and creates a virtual special stained image that discriminates the region showing the target tissues from other regions in the specimen image.

12. The microscopy system according to claim 10, wherein
the specimen attribute designating unit designates two or more tissues as the target tissue, and
the target extracting unit extracts the region of interest that includes regions showing the two or more target tissues designated by the specimen attribute designating unit, and creates the virtual special stained image that selectively shows one of the regions of the two or more target tissues in the specimen image.

13. The microscopy system according to claim 3, wherein
the specimen image capturing unit obtains the specimen image by capturing an image of the specimen stained with a predetermined dye,
the property data storage unit stores a plurality of dye spectral property values in different stained states of the dye, the dye spectral property values being measured beforehand, and
the observation system control unit comprises
a spectral property acquiring unit that acquires spectral property values at sample points in the specimen, based on pixel values of pixels forming the specimen image, the samples points being corresponding to the pixels;
a creation condition acquiring unit that acquires creation conditions of the specimen;
a dye spectral property determining unit that selects a dye spectral property value corresponding to the creation conditions of the specimen from the dye spectral property values stored in the property data storage unit, and determines an optimum dye spectral property value of the dye; and
a dye amount estimating unit that estimates a dye amount of the dye at the sample points in the specimen with the use of the optimum dye spectral property value of the dye, based on the spectral property values obtained by the spectral property acquiring unit.

14. The microscopy system according to claim 13, wherein
the property data storage unit stores the plurality of dye spectral property values in different stained states of the dye, the dye spectral property values being measured beforehand with respect to each of the attribute values, and
the system environment setting unit sets the system parameters, based on the selected system spectral property values.

15. The microscopy system according to claim 13, wherein
the property data storage unit stores system spectral property values that are measured beforehand with respect to each of the attribute values,
the property data selecting unit selects the system spectral property values based on the designated attribute values, and
the system environment setting unit sets the system parameters based on the selected system spectral property values.

16. The microscopy system according to claim 15, wherein
the creation condition acquiring unit comprises a creation condition estimating unit that estimates creation conditions used to create the specimen, based on the spectral property values acquired by the spectral property acquiring unit, and
the creation condition acquiring unit acquires the creation conditions of the specimen that are the creation conditions estimated by the creation condition estimating unit.

17. The microscopy system according to claim 15, wherein
the creation condition acquiring unit comprises a creation condition input requesting unit that requests an input of creation conditions used to create the specimen, and
the creation condition acquiring unit acquires the creation conditions of the specimen that are creation conditions input in response to the request from the creation condition input requesting unit.

18. The microscopy system according to claim 16, wherein
the creation condition estimating unit comprises
an analysis region setting unit that sets a predetermined analysis region in the specimen image; and
a feature value acquiring unit that acquires feature value about the analysis region, based on the spectral property values acquired by the spectral property acquiring unit with respect to pixels forming the analysis region, and
the creation condition estimating unit estimates the creation condition used to create the specimen, based on the feature value.

19. The microscopy system according to claim 18, wherein the analysis region is a region of a nucleus in the specimen shown in the specimen image.

20. The microscopy system according to claim 18, wherein
the spectral property acquiring unit acquires the spectral property values with respect to each predetermined wavelength or each predetermined bandwidth, and
the feature value acquiring unit creates a spectral property graph indicating the spectral property values of the pixels in the analysis region at each of the predetermined wavelengths or in each of the predetermined bandwidths, and analyzes a graph shape of the spectral property graph, to calculate the feature value.

21. The microscopy system according to claim 20, wherein the feature value acquiring unit calculates the feature value that includes at least one of
a flat wavelength interval in which the graph shape of the spectral property graph is flat, and
a difference between an average spectral property value in the flat wavelength interval and a spectral property value at a peak wavelength in the spectral property graph.

22. The microscopy system according to claim 15, wherein
the property data storage unit stores the dye spectral property values in the different stained state of the dye, the dye spectral property values being dye spectral property values with respect to each of the creation conditions acquired from a plurality of single stained specimen having different creation conditions, the single stained specimens being stained with the dye independently of one another, and
the dye spectral property determining unit selects the corresponding dye spectral property value from the dye spectral property values of each of the creation conditions stored in the property data storage unit, based on the creation conditions of the specimen.

23. The microscopy system according to claim 22, wherein
the creation condition estimating unit refers to a creation condition determining parameter distribution formed by distributing creation condition determining parameters with respect to the respective dye spectral property values of the creation conditions in a predetermined creation condition space that is defined by two or more creation conditions, and selects the creation condition determining parameter corresponding to the creation condition determining parameter about the analysis region, to estimate the creation conditions used to create the specimen.

24. The microscopy system according to claim 15, wherein, when the creation conditions of the specimen match the creation conditions of one of the dye spectral property values stored in the property data storage unit, the dye spectral property determining unit determines the dye spectral property value corresponding to the matching creation conditions to be an optimum dye spectral property value of the dye.

25. The microscopy system according to claim 15, wherein, when the creation conditions of the specimen do not match the creation conditions of any one of the dye spectral property values stored in the property data storage unit, the dye spectral property determining unit selects a dye spectral property value that is the most similar to the creation conditions of the specimen, and determines an optimum dye spectral property value by correcting the selected dye spectral property value in accordance with a difference between the creation conditions of the dye spectral property value and the creation conditions of the specimen.

26. The microscopy system according to claim 15, further comprising:
a dye selecting unit that designates a dye to be displayed as a display target dye;
a display image generating unit that generates a display image in which pixel positions containing the display target dye are discriminated from other pixel positions in the stained image, based on the dye amount of the dye estimated by the dye amount estimating unit with respect to each sample point in the specimen; and
a display processing unit that causes a display unit to display the display image.

27. The microscopy system according to claim 15, further comprising:
a dye amount correcting unit that corrects the dye amount of the dye estimated by the dye amount estimating unit with respect to each sample point in the specimen;
a spectral property generating unit that generates spectral property values, based on the dye amount of the dye corrected by the dye amount correcting unit;
a display image generating unit that forms an RGB image based on the spectral property values generated by the spectral property generating unit, and generates a display image that shows a stained state with the corrected dye amount of the dye; and
a display processing unit that causes a display unit to display the display image.

28. The microscopy system according to claim 27, further comprising a dye selecting unit that designates a dye to be displayed as a display target dye,
wherein the dye amount correcting unit corrects the dye amount of the display target dye.

29. The microscopy system according to claim 27, further comprising:
a dye selecting unit that designates a dye to be displayed as a display target dye,
wherein the dye amount correcting unit corrects the dye amounts of dyes other than the display target dye to zero, and
the display image generating unit generates the display image that does not show the dyes other than the display target dye.
